(19) United States
(12) Patent Application Publication
(10) Pub. No.: US 2006/0191401 A1
(43) Pub. Date: Aug. 31, 2006

(54) Automatic musical instrument, automatic music performing method and automatic music performing program

(76) Inventors: Hiromu Ueshima, Shiga (JP); Akihiro Inaba, Shiga (JP)

Correspondence Address: OSHA LIANG L.L.P., 1221 MCKINNEY STREET, SUITE 2800, HOUSTON, TX, 77010, US

(21) Appl. No.: 10/546,459

(22) PCT Filed: Apr. 9, 2004
(86) PCT No.: PCT/JP04/05131

§ 371 Date: Aug. 19, 2005

(30) Foreign Application Priority Data
Apr. 14, 2003 (JP) 2003-108552

(51) Int. Cl. G10H 3/06

(52) U.S. Cl. 84/724

(57) ABSTRACT

When the sliding direction of a sliding operation piece (40) is changed while the sliding speed thereof exceeds a threshold value, a trigger is generated to start sound output. The termination process of the sound output started in response to the latest trigger is invoked when the sliding speed of the sliding operation piece (40) falls below a threshold value, while, when a new trigger is generated, the termination process of the sound output started in response to the previous trigger is invoked.

### TECHNICAL FIELD

The present invention is related to an automatic musical instrument and the related techniques thereof for automatically performing music in response to triggers generated by external operation.

### BACKGROUND ART

So far, many references on electric musical instruments of the plucked string family have been available. For example, Jpn. unexamined patent publication No. 9-212162 (Patent Publication 1) is an example of such references. In what follows, the electric bow instrument as described in this Patent Publication 1 will be briefly explained.

In the case of this conventional electric musical instrument, while determining a pitch by selectively pressing one of a number of switches provided on the neck of the instrument main body, the performer operates an instrument operation piece corresponding to a violin bow for outputting musical tones in accordance with the pitch as determined to enjoy performance. In other words, this is substantially manual performance. A similar electric bow instrument is described in Jpn. unexamined patent publication No. 3-48891 (Patent Publication 2).

On the other hand, in the case of the conventional electric musical instrument disclosed in Jpn. unexamined patent publication No. 10-78778 (Patent Publication 3), when a performer pushes a switch located on the neck of the instrument body, musical note data constituting a musical piece is successively read out from a memory. Then, while pressing this switch, the performer can generate a musical tone, on the basis of the musical note data read out corresponding to this switch, by operating the instrument operation piece.

### DISCLOSURE OF INVENTION

However, when playing music with a classical musical instrument or one of the electric musical instruments described in Patent Publications 1 to 3, the performer performing the musical instrument must have some musical and physical skills to handle the musical instrument with correct pitches in appropriate tempo suitable for the playing musical piece.

Generally speaking, the musical performance is the act of producing music sound by controlling a musical instrument on the human initiative. In this case, the person can be said a musical performer. Accordingly, the person handling a classical musical instrument or one of the electric musical instruments described in Patent Publications 1 to 3 is a musical performer, and one who plays that musical instrument. Hence, as described above, it is difficult for average people with no particular musical knowledge and ability to play music at their will.

On the other hand, in the case of the known automatic performance performed by a computer, while very accurate performance is possible on the basis of the music data as given, all the performance becomes uniform and it is impossible to easily produce distinctive performance. This kind of such known automatic performance performed by a computer is rather comparable to simple playback of music. In this case, the person having the computer perform automatic performance is, so to speak, an operator.

It is an object of the present invention to provide an automatic musical instrument and the related techniques thereof with which an operator with no particular musical knowledge and skill can add dynamics with tempo rubato by intuitive operations to music, which is automatically performed by a computer, and therefore can enjoy individual automatic performance.

In accordance with a first aspect of the present invention, an automatic musical instrument for automatically performing music in response to triggers generated by external operation in accordance with music data for automatic performance, comprises: a main body; and a sliding operation piece that is operated to slidably move in contact with said main body, wherein said main body comprises: a speed measuring unit operable to measure the sliding speed of said sliding operation piece; a direction detecting unit operable to detect the sliding direction of said sliding operation piece; a trigger generating unit operable to generate a trigger for automatic performance in response to detecting change of the sliding direction of said sliding operation piece and the sliding speed of said sliding operation piece exceeding a first predetermined threshold value. a sound terminating unit operable to invoke a termination process of the sound output started in response to a latest trigger when the sliding speed of said sliding operation piece falls below a second predetermined threshold value, and invoke, when a trigger is generated anew, a termination process of the sound output started in response to a previous trigger; and a sound volume controlling unit operable to control the sound volume of the music as automatically performed in accordance with the sliding speed of said sliding operation piece.

In accordance with this configuration, the operator can generate a trigger and control the sound volume during automatic performance by intuitive operation, for example, by changing the sliding direction or the sliding speed of the sliding operation piece.

Because of this, while the automatic performance is performed by an automatic musical instrument (computer), an operator with no particular musical knowledge can enjoy individual automatic performance by adding variegated expression to the music which is automatically performed by the automatic musical instrument (computer).

Also, when the sliding speed of the sliding operation piece falls below the second predetermined threshold value, the termination process of the sound output of the latest trigger is invoked, while, when a trigger is generated anew, the termination process of the sound output of the previous trigger is invoked.

Accordingly, there is the following advantage as compared with the case where a trigger is generated whenever the sliding speed of the sliding operation piece exceeds the first predetermined threshold value while the sound output is terminated whenever the sliding speed of the sliding operation piece falls below the second predetermined threshold value.

If the operator quickly changes the sliding direction while moving the sliding operation piece at a large sliding speed, it may not be detected that the sliding speed falls below the second predetermined threshold value and therefore the termination process of sound output is not invoked, while the sliding speed detected just after the change exceeds the second predetermined threshold value. In this case, there is a shortcoming that the sound output started responsive to a single trigger is unintentionally continued. The above shortcoming results in a substantial problem because the operation of quickly changing the sliding direction while moving the sliding operation piece at a large sliding speed is often done.

The problem as described above can be avoided by handling the generation of a new trigger as a termination condition for terminating sound output started responsive to the previous trigger (in the case where the sliding speed exceeds the first predetermined threshold value and the sliding direction is changed after the previous trigger).

In this case, while the operator necessarily changes the sliding direction of the sliding operation piece, the change of the sliding direction can be perceived with ease and therefore it is recognized as an intuitive operation for the operator to change the sliding direction. Because of this, no restriction is imposed on the operation by the operator even if the change of the sliding direction is treated as a condition of detecting a trigger.

Furthermore, while a trigger is unintentionally generated for example by an involuntary small movement of a hand of the operator if a trigger is generated whenever the sliding direction of the sliding operation piece is changed, this shortcoming can be avoided by adding another trigger generation requirement that the sliding speed exceeds the first predetermined threshold value.

The termination process of sound output in this description does not mean that the sound output is stopped without delay, but does rather means that the sound output is gradually deadened. Accordingly, there is a predetermined time before the sound output is completely stopped after starting the termination process.

In the above automatic musical instrument, said main body further comprises: a light emitting unit located in a position, over which said sliding operation piece is passed, and operable to output a light beam; a first light receiving unit located in a position, over which said sliding operation piece is passed, and operable to receive the light beam as output from said light emitting unit; and a second light receiving unit located in a position, over which said sliding operation piece is passed, and operable to receive the light beam as output from said light emitting unit, wherein said sliding operation piece is formed with a light intensity modifying portion which is operable to modify the intensity of the light beam to be received by said light receiving units, said first light receiving unit and said second light receiving unit being arranged along the sliding direction of said sliding operation piece, wherein said speed measuring unit performs measurement of the sliding speed on the basis of the electronic signal that is output from at least one of said first light receiving unit and said second light receiving unit in accordance with the intensity of the light beam as modified by said light intensity modifying portion, and said direction detecting unit performs detection of the sliding direction on the basis of the electronic signals that are output from said first light receiving unit and said second light receiving unit in accordance with the intensity of the light beam as modified by said light intensity modifying portion.

In accordance with this configuration, it is easy to measure the sliding speed of the sliding operation piece and detect the sliding direction thereof.

In the above automatic musical instrument, the music as automatically performed includes two or more melodies while at least one of the melodies is controlled in response to triggers generated by said trigger generating unit.

In accordance with this configuration, the operator can take control of the music performance by changing the sliding speed and sliding direction of the sliding operation piece not only relating to a single melody but also relating to a plurality of melodies, while adding variegated expression to the plurality of melodies of the music which is automatically performed by the automatic musical instrument, and therefore he can furthermore enjoy individual automatic performance by the automatic musical instrument.

In the above automatic musical instrument, said main body further comprises: an image generation unit operable to generate an image signal indicative of the current state of the automatic performance and an operation guide, and provide the image signal to a television monitor which is separately provided from said main body, wherein the current state of automatic performance is indicated by the movement or color variation of an object, and the operation guide is indicated by the movement and color variation of an object.

By displaying the image indicative of the current state of automatic performance and the image indicative of an operation guide on a television monitor, the operator can therefore intuitively recognize the current state of the automatic performance and the operation guide, and can take control of the automatic performance with ease.

Also, it is possible to display the images indicative of the current state of the automatic performance and the image indicative of the operation guide only by connecting the main body with the television monitor.

Furthermore, it is possible to dispense with an image display unit in the main body for displaying these images and therefore realize an automatic musical instrument which is cheaper than that provided with an image display unit in the main body.

Still further, since these images are displayed on the s television monitor which is separately provided from the automatic musical instrument, the weight becomes lighter and therefore the operator can operate the sliding operation piece, while holding the automatic musical instrument, with ease as compared to the case where the automatic musical instrument is implemented with a built-in image display unit.

Still further, since these images are displayed on the television monitor which is separately provided from the automatic musical instrument, the operator can see these images, while holding the automatic musical instrument, with ease as compared to the case where the automatic musical instrument is implemented with a built-in image display unit. In the case where the operator holds the main body during sliding operation, it is difficult to maintain the visibility of these images if the main body is implemented with a built-in image display unit.

In the above automatic musical instrument, said main body further comprises a sound output channel control unit operable to set the sound output channel for sound output to be started in response to a new trigger to a channel differing from the sound output channel for sound output started in response to the previous trigger.

In accordance with this configuration, the sound output started in response to the previous trigger is not immediately terminated by starting the sound output in response to a new trigger, and therefore continuous automatic performance can be realized.

In the above automatic musical instrument, said main body further comprises a medium accepting unit operable to accept a medium in which are stored music data for automatic performance and image data for image generation.

In accordance with this configuration, it is possible to enjoy a variety of music titles only by changing the medium.

In the above automatic musical instrument, said main body further comprises: a contact portion whose cross section has a highest portion in a center position of said contact portion and downwardly extending therefrom toward the opposite ends thereof; and two guide elements located in upright positions distant a predetermined interval from each other with said contact portion inbetween, wherein said light emitting unit, said first light receiving unit and said second light receiving unit are provided in the vicinity and inner side of a surface of said contact portion to be in contact with said sliding operation piece.

In accordance with this configuration, since the sliding position of the sliding operation piece is limited by the two guides, the operator can have the sliding operation piece pass over the light emitting device, the first light receiving unit and the second light receiving unit without particular attention. Also, since the cross section of the contact portion has a highest portion in a center position of said contact portion and downwardly extending therefrom toward the opposite ends thereof the contact portion has a highest portion in the center position from which surfaces are downwardly extending toward the opposite sides thereof, the flexibility of the movement of the sliding operation piece can be increased, and therefore the operator can perform a variety of sliding operations.

In the above automatic musical instrument, said main body further comprises a first optical fiber with an one end located in the inner side of the surface of said contact portion and the other end located in the light receiving side of said first light receiving unit, and a second optical fiber with an one end located in the inner side of the surface of said contact portion and the other end located in the light receiving side of said second light receiving unit.

In accordance with this configuration, by adjusting the distance between one end of the first optical fiber and one end of the second optical fiber, it is possible to easily and accurately adjust the phase difference between the electronic signal output from the first light receiving unit and the electronic signal output from the second light receiving unit.

In the above automatic musical instrument, said sliding operation piece is formed with two spacers, on the bottom surface thereof, extending in parallel with each other in the longitudinal direction of said sliding operation piece, and wherein said light intensity modifying portion is formed on the bottom surface of said sliding operation piece and located between said two spacers.

In accordance with this configuration, since the sliding operation piece comes in contact with the contact portion only at the two spacers, the light intensity modifying portion shall not come in direct contact with the contact portion and therefore it is possible to prevent the degradation of the light intensity modifying portion.

In the above automatic musical instrument, said main body further comprises a connector to be connected with a cable including a first signal line for transmitting the electronic signal from the first light receiving unit of another automatic musical instrument and a second signal line for transmitting the electronic signal from the second light receiving unit of said another automatic musical instrument.

In accordance with this configuration, the speed measuring unit and the sliding direction detecting unit of the automatic musical instrument serving as a master can measure the sliding speed of the slave and detect the sliding direction of the slave on the basis of the two electronic signals received through the first signal line and the second signal line of the cable.

Also, the trigger generating unit of the automatic musical instrument serving as a master can generate a trigger for the automatic musical instrument serving as a slave when the sliding direction is changed in the slave side while the sliding speed exceeds the first predetermined threshold value in the slave side. Furthermore, the sound volume controlling unit of the automatic musical instrument serving as a master can control the sound volume of music in accordance with the sliding speed in the slave side.

As described above, the process of generating a trigger and the control of sound volume in the slave side are performed by the main body of the automatic musical instrument serving as a master. Because of this, there is no need for providing the speed measuring unit, the direction detecting unit, the trigger generating unit and the sound volume controlling unit in the slave side. As a result, it is possible to reduce the cost and the power consumption of the slave automatic musical instrument.

In the above automatic musical instrument, said main body further comprises a power voltage supplying unit operable to supply a power supply voltage to said main body and also to supply said main body of said another automatic musical instrument through the cable which further comprises a power supply line for supplying the power supply voltage.

In accordance with this configuration, a power supply voltage is supplied from the automatic musical instrument serving as a master to the automatic musical instrument serving as a slave, and therefore there is no need for providing a power supply in the slave side resulting in cost reduction in the slave side.

In accordance with a second aspect of the present invention, an automatic musical instrument for automatically performing music in response to triggers generated by external operation in accordance with music data for automatic performance, comprises: a main body; and a sliding operation piece that is operated to slidably move in contact with said main body, wherein said main body comprises: a speed measuring unit operable to measure the sliding speed of said sliding operation piece; a direction detecting unit operable to detect the sliding direction of said sliding operation piece; a trigger generating unit operable to generate a trigger for automatic performance in response to detecting change of the sliding direction of said sliding operation piece and the sliding speed of said sliding operation piece exceeding a first predetermined threshold value; and a sound terminating unit operable to invoke a termination process of the sound output started in response to a latest trigger when the sliding speed of said sliding operation piece falls below a second predetermined threshold value, and invoke, when a trigger is generated anew, a termination process of the sound output started in response to a previous trigger.

In accordance with a third aspect of the present invention, an automatic musical instrument for automatically performing music in response to triggers generated by external operation in accordance with music data for automatic performance, comprising: a main body; and a sliding operation piece that is operated to slidably move in contact with said main body, wherein said main body comprising: a trigger generating unit operable to generate a trigger for automatic performance in response to the sliding operation of said sliding operation piece; and an image generation unit operable to generate an image signal indicative of the current state of the automatic performance and an operation guide, and provide the image signal to a television monitor which is separately provided from said main body.

In accordance with a fourth aspect of the present invention, an automatic musical instrument for automatically performing music in response to triggers generated by external operation in accordance with music data for automatic performance, comprises: a main body; and a sliding operation piece that is operated to slidably move in contact with said main body, wherein said main body comprises: a trigger generating unit operable to generate a trigger for automatic performance in response to the operation of said sliding operation piece; and a sound output channel control unit operable to set the sound output channel for sound output to be started in response to a new trigger to a channel differing from the sound output channel for sound output started in response to the previous trigger.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a schematic diagram showing the overall configuration of the automatic-performance system in accordance with the embodiment 1 of the present invention.

FIG. 2(a) is a plan view showing the automatic musical instrument main body of FIG. 1.

FIG. 2(b) is a side view showing the automatic musical instrument main body of FIG. 1.

FIG. 3 is a bottom view showing the automatic musical instrument main body of FIG. 1.

FIG. 4 is an explanatory view for showing the range within which the operator can move the sliding operation piece of FIG. 1.

FIG. 5 is a cross sectional view showing the sliding saddle member as illustrated in FIG. 2(a) along A-A line.

FIG. 6(a) is a side view showing the sliding operation piece of FIG. 1, and FIG. 6(b) is a bottom view thereof.

FIG. 7 is an expanded view of a pair of the guides and the sliding saddle member as illustrated in FIG. 2(a).

FIG. 8 is a cross sectional view showing the sliding saddle member as illustrated in FIG. 7 along B-B line.

FIG. 9(a) is a side view showing another example of the sliding operation piece.

FIG. 9(b) is a bottom view showing the another example of the sliding operation piece.

FIG. 10 is a view showing the arrangement of the reflective optical sensor when the sliding operation piece as shown in FIG. 9(a) is used.

FIG. 11 is a cross sectional view showing the sliding saddle member as illustrated in FIG. 10 along C-C line.

FIG. 12 is a view showing an example of the operation style selection screen displayed on the television monitor of FIG. 1.

FIG. 13 is a view showing an example of the music title selection screen as displayed on the television monitor of FIG. 1.

FIG. 14 is a view showing an example of an operation guide screen as displayed on the television monitor of FIG. 1.

FIG. 15 is a view showing the electrical construction of the automatic musical instrument main body of FIG. 1.

FIG. 16 is a schematic representation of a program and data stored in the ROM of FIG. 15.

FIG. 17 is a block diagram of the high speed processor of FIG. 15.

FIG. 18 is a schematic diagram showing the relationship between the reflecting pattern of the sliding operation piece and the locations of the phototransistors of the detection unit of FIG. 15.

FIG. 19(a) is a diagram showing the pulse signals as output when the sliding operation piece of FIG. 1 is moved in the positive direction.

FIG. 19(b) is a diagram showing the pulse signals as output when the sliding operation piece of FIG. 1 is moved in the negative direction.

FIG. 20 shows the state transition of two pulse signals.

FIG. 21 is a partial block diagram showing the input/output control circuit of FIG. 17.

FIG. 22 is an explanatory view for showing another method of determining the sliding speed of the sliding operation piece of FIG. 1.

FIG. 23 is a circuit diagram showing the detection unit provided in the automatic musical instrument main body of FIG. 1.

FIG. 24 is an explanatory view for showing the musical score data for BGM as stored in the ROM of FIG. 16.

FIG. 25 is a view for explaining the musical score data for registering musical notation marks as stored in the ROM of FIG. 16.

FIG. 26 is a view for explaining the musical score data for outputting musical tones in response to triggers as stored in the ROM of FIG. 16.

FIG. 27 is a view for explaining an image object.

FIG. 28 is a flow chart showing an example of the overall process flow of the automatic musical instrument in accordance with the embodiment 1 of the present invention.

FIG. 29 is a flow chart showing the initial setting of the system in step S1 of FIG. 28.

FIG. 30 is a flowchart showing the procedure for handling a trigger in step S4 of FIG. 28.

FIG. 31 is a flowchart showing the procedure for controlling the sound volume in step S5 of FIG. 28.

FIG. 32 is a flowchart showing the procedure for setting a musical tone in step S6 of FIG. 28.

FIG. 33 is a flowchart showing the procedure for setting objects in step S7 of FIG. 28.

FIG. 34(a) is a view showing an example of the table of the time period Tns between the start code and the musical notation mark n in association with the respective musical notation mark n.

FIG. 34(b) is a view showing an example of the table of the deviation value of the synchronization value in association with the respective displacement Dif.

FIG. 35 is a flowchart showing the procedure of modifying the colors of musical notation marks in step S125 of FIG. 33.

FIG. 36 is a flowchart showing the procedure of controlling the display of the note length indication bar in step S126 of FIG. 33.

FIG. 37 is a flowchart showing the procedure of sound processing in step S10 of FIG. 28.

FIG. 38 is a flowchart showing the sound output process for BGM in step S200 of FIG. 37.

FIG. 39 is a flowchart showing the musical notation mark registration process in step S201 of FIG. 37.

FIG. 40 is a flow chart showing the process flow in the sound output as started in response to a trigger in step S202 of FIG. 37.

FIG. 41 is a flowchart showing the vibrato process in step S203 of FIG. 37.

FIG. 42(a) is a view for explaining the vibrate effects.

FIG. 42(b) is a view showing an example of the vibrate table containing the vibration displacements for performing the vibrate process.

FIG. 43 is a block diagram showing the sound processor of FIG. 17.

FIG. 44 is a block diagram showing the DAC block of FIG. 43.

FIG. 45 is a block diagram showing the graphic processor of FIG. 17.

FIG. 46 is a schematic diagram showing the overall configuration of the automatic performance system in accordance with the embodiment 2 of the present invention.

FIG. 47 (a) is a plan view showing the automatic musical instrument main body of FIG. 46.

FIG. 47(b) is a side view showing the automatic musical instrument main body of FIG. 46.

FIG. 48(a) is an expanded view showing the sliding saddle member as shown in FIG. 47(a).

FIG. 48(b) is a plan view showing the optical sensor unit as shown in FIG. 48(a).

FIG. 49 is a cross sectional view along C-C line of FIG. 48(a).

FIG. 50 is a cross sectional view along D-D line of FIG. 48(a).

FIG. 51 is a schematic diagram showing the relationship between the reflecting pattern of the sliding operation piece and the locations of the optical fibers of the optical sensor unit of FIG. 48(a).

FIG. 52 is a circuit diagram showing the detection unit provided in the automatic musical instrument main body of FIG. 46.

FIG. 53 is a flowchart showing the entire operation of the automatic musical instrument in accordance with the embodiment 2 of the present invention.

FIG. 54 is a flowchart showing the process flow in the initial setting of the system in step S500 of FIG. 53.

FIG. 55 is a flow chart showing the pulse count process in step S510 of FIG. 53.

FIG. 56 is a flow chart showing the procedure for handling a trigger in step S503 of FIG. 53.

FIG. 57 is a flowchart showing the procedure for controlling the sound volume in step S504 of FIG. 53.

FIG. 58 is a view showing an example of the operation guide screen in accordance with the embodiment 3.

FIG. 59(a) is a view for explaining the hard mode in accordance with the embodiment 3.

FIG. 59(b) is a view for explaining the standard mode in accordance with the embodiment 3.

FIG. 59(c) is a view for explaining the easy mode in accordance with the embodiment 3.

FIG. 60 is a flowchart showing the trigger generation area determination process in accordance with the automatic musical instrument of the embodiment 3.

FIG. 61 is a view showing an example of the operation guide screen in accordance with the embodiment 4 of the present invention.

FIG. 62 is a view showing another example of the operation guide screen in accordance with the embodiment 4 of the present invention.

FIG. 63 is a schematic diagram showing the overall configuration of the automatic-performance system in accordance with the embodiment 4 of the present invention.

FIG. 64 is a schematic diagram showing the inner structure of the cable of FIG. 63 with which are connected the automatic musical instrument main body (master) and the automatic musical instrument main body (slave).

FIG. 65 is a circuit diagram showing the power supply related circuit in each of the automatic musical instrument main body (master) and the automatic musical instrument main body (slave) of FIG. 63.

FIG. 66 is a view for explaining the transmission path of the pulse signals A and B and the on/off signals of the vibrato from the automatic musical instrument main body (slave) to the automatic musical instrument main body (master) of FIG. 63.

FIG. 67(a) is a side view showing a further example of the sliding operation piece of FIG. 1.

FIG. 67(b) is a bottom view of the sliding operation piece of FIG. 67(a).

FIG. 67(c) is an E-E cross sectional view of FIG. 67(a).

### BEST MODE FOR CARRYING OUT THE INVENTION

In what follows, the embodiment of the present invention will be explained in conjunction with the accompanying drawings. Meanwhile, similar elements are given similar references throughout the respective drawings.

### Embodiment 1

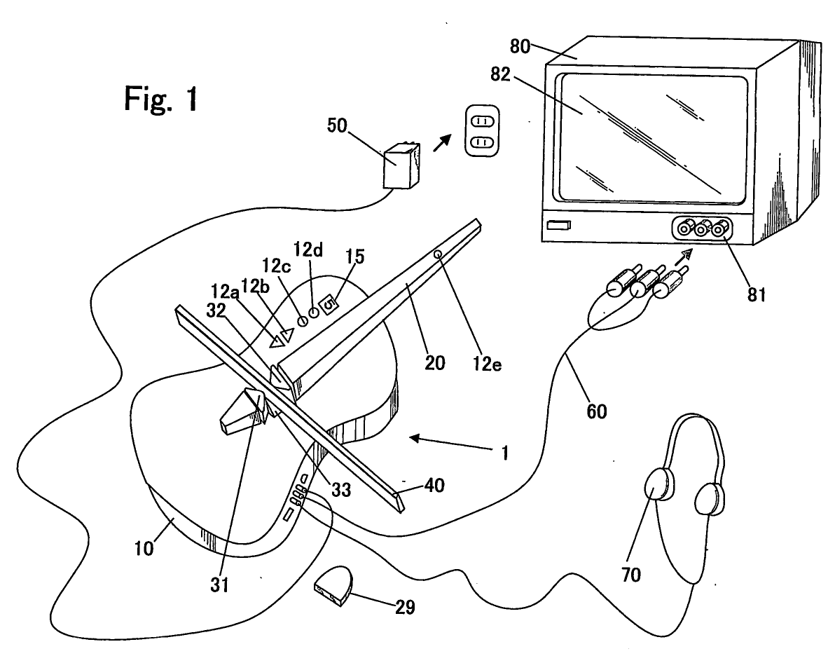

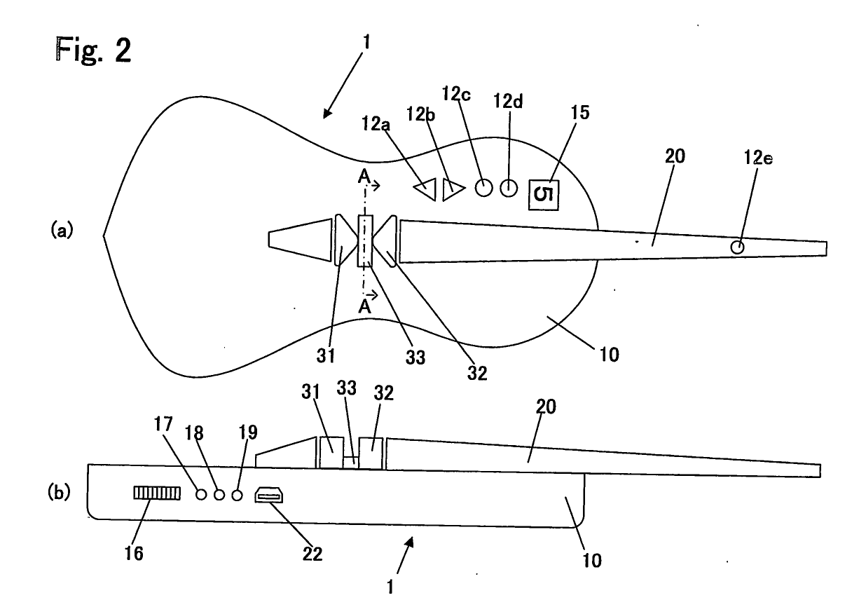

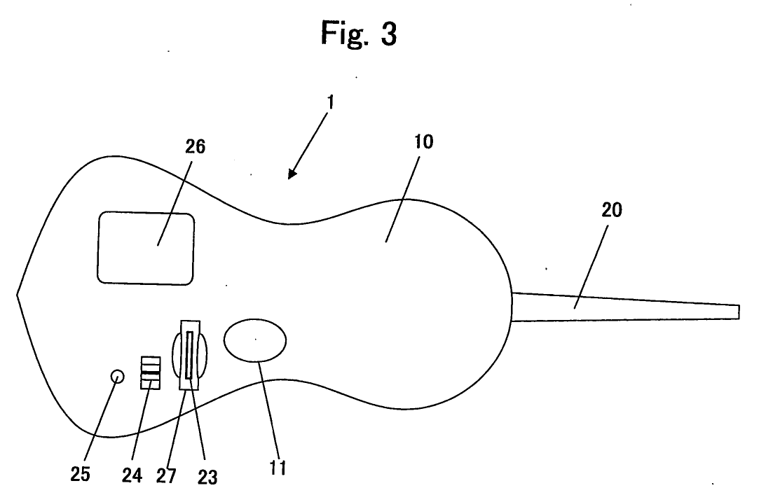

FIG. 1 is a schematic diagram showing the overall configuration of the automatic performance system in accordance with the embodiment 1 of the present invention. FIG. 2(a) is a plan view showing the automatic musical instrument main body 1 of FIG. 1. FIG. 2(b) is a side view showing the automatic musical instrument main body 1 of FIG. 1. FIG. 3 is a bottom view showing the automatic musical instrument main body 1 of FIG. 1. As illustrated in FIG. 1, this automatic performance system includes the automatic musical instrument main body 1, a sliding operation piece 40, and a television monitor 80. In this case, the automatic musical instrument main body 1 and the sliding operation piece 40 constitutes an automatic musical instrument.

The present embodiment is designed in the form of a violin as an exemplary design of the automatic musical instrument main body 1. Accordingly, in this case, the sliding operation piece 40 corresponds to a bow.

As illustrated in FIG. 2(a), the bout portion 10 of the automatic musical instrument main body 1 is provided with guides 31 and 32, a sliding saddle member 33, selection keys 12a and 12b, a cancel key 12c, a decision key 12d, and a display unit 15 on the principal surface thereof. Also, as illustrated in FIG. 2(b), the bout portion 10 is also provided with a volume dial 16, a headphone terminal 17, an AV terminal 18, a power terminal 19, and a connector 22 the side surface thereof. Furthermore, as illustrated in FIG. 3, the bout portion 10 is provided with a reset switch 25 for resetting the hardware, a power switch 24, a speaker unit 11, a battery box 26, and a cartridge insertion slot 27 on the bottom surface thereof. A cartridge socket 23 is provided behind this cartridge insertion slot 27.

A memory cartridge 29 containing a ROM (read only memory) as illustrated in FIG. 1 is inserted into the cartridge socket 23. Alternatively, the memory cartridge 29 to be inserted may contain an EEPROM (electrically erasable and programmable read only memory) instead. Incidentally, the memory contained in the memory cartridge 29 is not limited thereto.

Returning to FIG. 1, the surface of the neck 20 of the automatic musical instrument main body 1 is provided with a vibrato switch 12e for adding a vibrato effect to musical tones. Also, the television monitor 80 includes a screen 82 at the front side and an AV terminal 81 below the screen 82.

Then, the automatic musical instrument main body 1 and the television monitor 80 are connected to each other by an AV cable 60. More specifically speaking, the AV terminal 18 of the automatic musical instrument main body 1 and the AV terminal 81 of the television monitor 80 are connected to each other by the AV cable 60. On the other hand, a DC power voltage is applied to the automatic musical instrument main body 1 by an AC adaptor 50 through the power terminal 19. Alternatively, a battery cell (not shown in the figure) can be used to apply the DC power voltage in place of the AC adaptor 50. Also, it is possible to use the automatic musical instrument main body 1 with a headphone 70 connected thereto. In this case, the headphone 70 is connected to the headphone terminal 17.

Returning again to FIG. 2(a) and FIG. 2(b), the guide 31 and the guide 32 are located with the sliding saddle member 33 interposed therebetween. The guides 31 and 32 are formed as a pair of triangular prisms having opposite vertices which are rounded as seen in plan view. The sliding saddle member 33 has a higher center portion and lower opposite side portions as viewed in cross section (i.e., in the form of a ridge).

The operator can take control of the automatic performance of the automatic musical instrument by sliding the sliding operation piece 40 being in contact with the sliding saddle member 33. That is, the operator generates a trigger by operating the sliding operation piece 40. Musical tones are thereby output one by one in response to the generation of each trigger. The trigger is generated when the sliding direction of the sliding operation piece 40 is changed while the speed of the sliding operation piece 40 relative to the automatic musical instrument main body 1 (sliding speed) exceeds a predetermined threshold. Also, the sound volume of musical tones can be controlled in accordance with the sliding speed of the sliding operation piece 40.

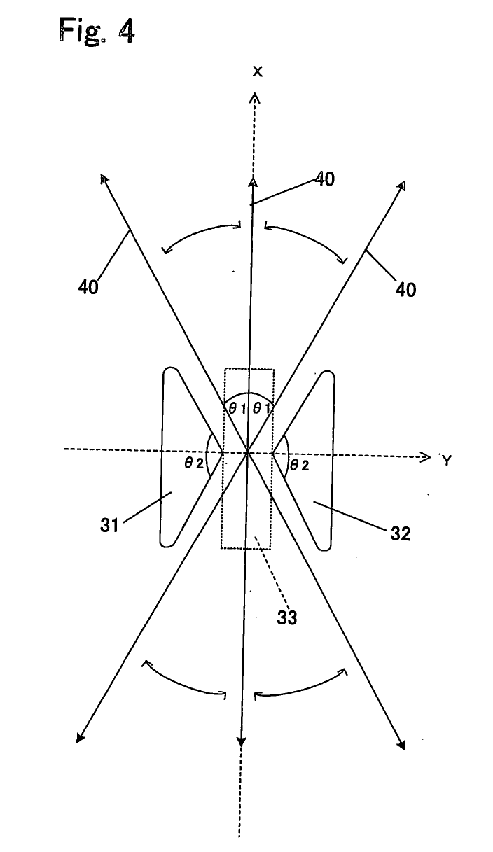

The following is an explanation of the degree of freedom of moving the sliding operation piece 40, which is a tool for generating such triggers. FIG. 4 is an explanatory view for showing the range within which the operator can move the sliding operation piece 40 of FIG. 1. FIG. 4 corresponds to FIG. 2(a) and shows the guides 31 and 32 in a plan view. In this case, the three-dimensional coordinates of XYZ are taken into consideration. Meanwhile, the z-axis is normal to the drawing sheet.

The operator can move the sliding operation piece 40 sliding on and being in contact with the sliding saddle member 33 in parallel to the XY plane. Also, the operator can rotate the sliding operation piece 40 around the z-axis by a maximum of an angle θ1 relative to the x-axis. This angle e1 is defined by the apex angle θ2 of the guides 31 and 32. Incidentally, the operator can rotate the sliding operation piece 40 around the z-axis, while sliding the sliding operation piece 40 in parallel with the XY plane, and vice versa.

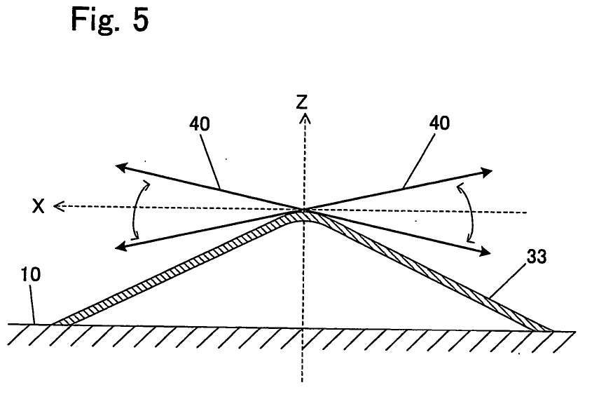

FIG. 5 is a cross sectional view showing the sliding saddle member 33 as illustrated in FIG. 2(a) along A-A line (the internal structure is omitted). The operator can move the sliding operation piece 40 sliding on and being in contact with the sliding saddle member 33 in parallel to the ZX plane (i.e., the three-dimensional coordinates same as in FIG. 4). Also, the operator can rotate the sliding operation piece 40 on the vertex of the sliding saddle member 33 as a fulcrum around the y-axis. However, the rotation angle is limited by the apex angle of the sliding saddle member 33. Meanwhile, the operator can rotate the sliding operation piece 40 with the vertex of the sliding saddle member 33 as a fulcrum around the y-axis, while sliding the sliding operation piece 40 in parallel with the ZX plane, and vice versa.

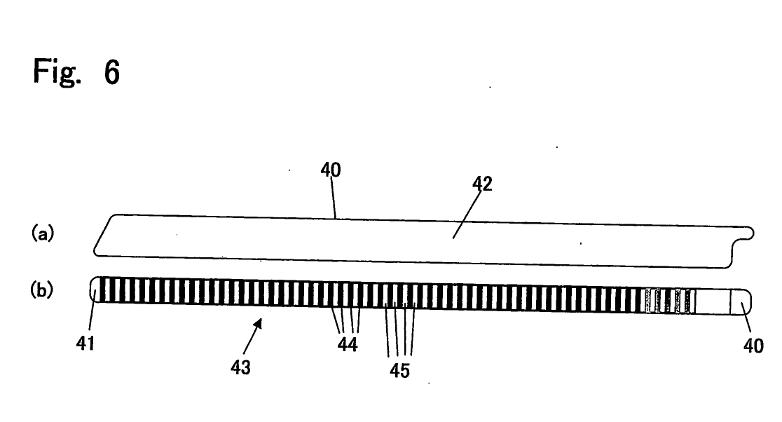

FIG. 6(a) is a side view showing the sliding operation piece 40 of FIG. 1, and FIG. 6(b) is a bottom view thereof. As illustrated in FIG. 6(b), the sliding operation piece 40 is formed with a reflecting pattern 43 in the bottom surface 41 thereof. This reflecting pattern 43 comprises light reflecting regions 45 and light absorbing regions 44 which are alternately arranged. The light reflecting region 45 reflects incident light while the light absorbing region 44 absorbs incident light. However, the light reflecting region 45 does not perfectly reflect the entirety of incident light while the light absorbing region 44 does not perfectly absorb the entirety of incident light. The operator slides the bottom surface 41 of this sliding operation piece 40 being in contact with the sliding saddle member 33.

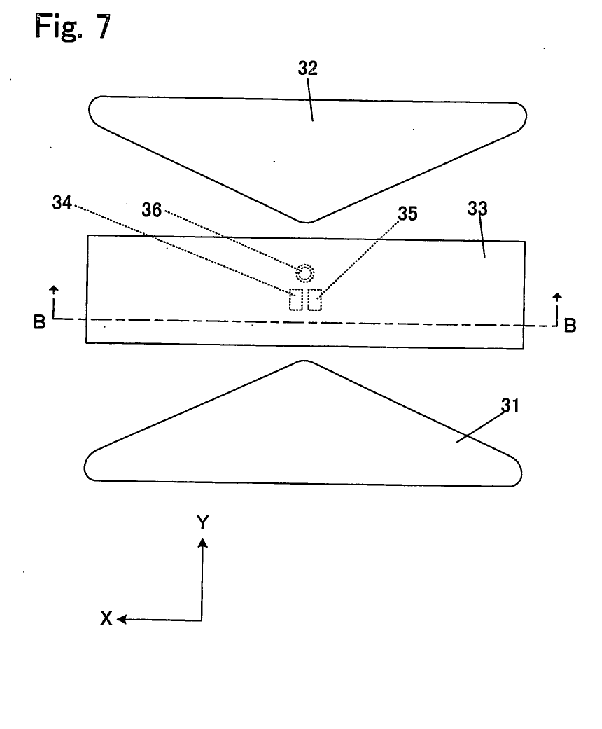

FIG. 7 is an expanded view of the guides 31 and 32 and the sliding saddle member 33 as illustrated in FIG. 2(a). As illustrated in FIG. 7, phototransistors 34 and 35 and a light emitting diode 36 is arranged inside the sliding saddle member 33. The phototransistor 34 and the phototransistor 35 are arranged adjacent to each other in the x-axis direction. Also, the light emitting diode 36 is located on the perpendicular line which is dropped in the y-axis direction and bisects the line connecting the phototransistor 34 and the phototransistor 35. This light emitting diode 36 serves to generate infrared rays. On the other hand, the sliding saddle member 33 functions also as an infrared filter capable of only passing infrared light in order that the phototransistors 34 and 35 can only detect the infrared rays output from the light emitting diode 36. Meanwhile, the phototransistors 34 and 35 and the light emitting diode 36 function as a reflective optical sensor in combination.

Also, the vertices of the guides 31 and 32 are rounded. This configuration is selected for the purpose of allowing smooth movement of the sliding operation piece 40 even with the guides 31 and 32 being in contact therewith and preventing the wear of the sliding operation piece 40 and the guides 31 and 32 due to the sliding contact between the sliding operation piece 40 and the guides 31 and 32.

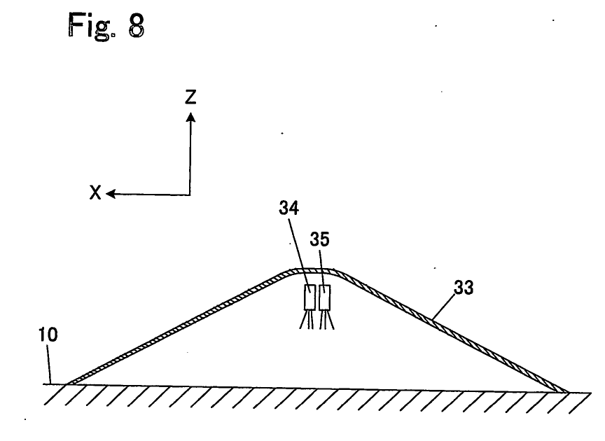

FIG. 8 is a cross sectional view showing the sliding saddle member 33 as illustrated in FIG. 7 along B-B line. As illustrated in FIG. 8, the sliding saddle member 33 is profiled in the form of a ridge as viewed in cross section and flattened at the vertex thereof. The vertex is flattened for the purpose of making approximately even the distances between the vertex of the sliding saddle member 33 and each of the head points of the phototransistors 34 and 35 and the light emitting diode 36. By this configuration, the phototransistor 34 and the phototransistor 35 are located to receive infrared rays under the same condition with the approximately same intensity.

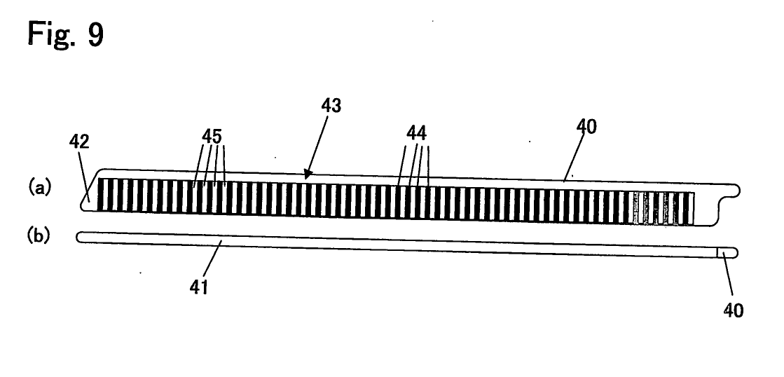

FIG. 9(a) is a side view showing another example of the sliding operation piece 40 of FIG. 1 while FIG. 9(b) is a bottom view thereof. As illustrated in FIG. 9(a), this sliding operation piece 40 is formed with a reflecting pattern 43 in one side surface 42 thereof. The operator slides the bottom surface 41 of this sliding operation piece 40 being in contact with the sliding saddle member 33. However, in this case, the phototransistors 34 and 35 and the light emitting diode 36 are placed in one of the guide 31 and the guide 32 rather than in the sliding saddle member 33.

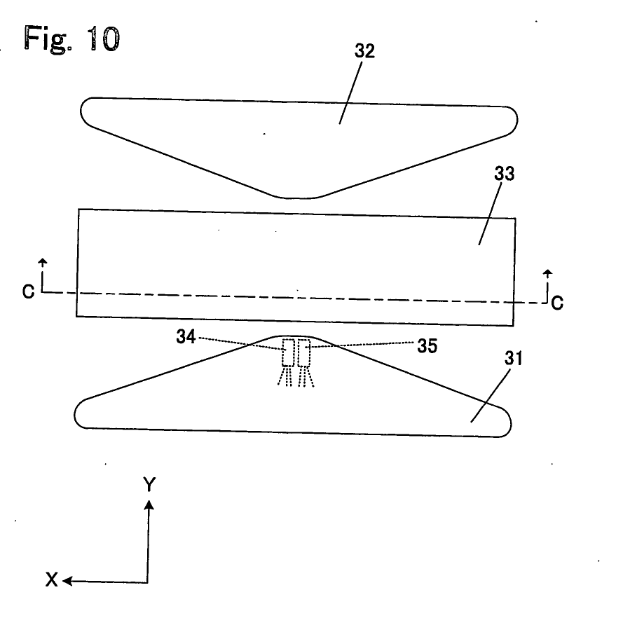

FIG. 10 is a view showing the arrangement of the reflective optical sensor when the sliding operation piece 40 as shown in FIG. 9(a) and FIG. 9(b) is used. As illustrated in FIG. 10, the phototransistors 34 and 35 and the light emitting diode 36 are placed inside the guide 31. The phototransistor 34 and the phototransistor 35 are arranged adjacent to each other in the x-direction. Incidentally, while the light emitting diode 36 is located behind the phototransistors 34 and 35 and therefore not illustrated in the figure, the light emitting diode 36 is located on the perpendicular line which is dropped in the z-axis direction and bisects the line connecting the phototransistor 34 and the phototransistor 35. On the other hand, the guide 31 functions as an infrared filter only passing infrared light in order that the phototransistors 34 and 35 can only detect the infrared rays output from the light emitting diode 36. Needless to say, the phototransistors 34 and 35 and the light emitting diode 36 can be placed in the guide 32, while the reflecting pattern 43 is formed on the other side surface of the sliding operation piece 40. The vertices of the guides 31 and 32 are flattened for the same reason as the vertex of the sliding saddle member 33 of FIG. 8 is flattened.

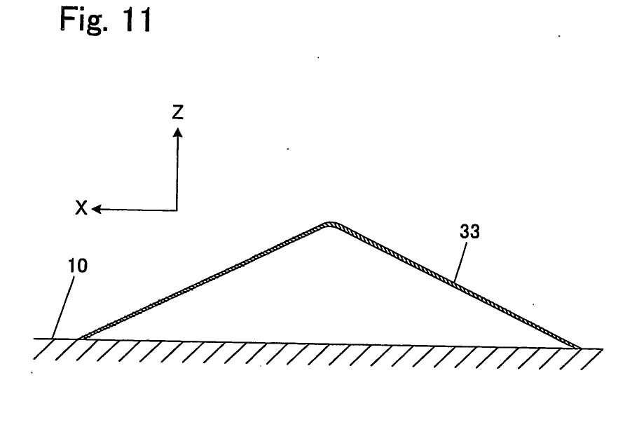

FIG. 11 is a cross sectional view showing the sliding saddle member 33 as illustrated in FIG. 10 along C-C line. As illustrated in FIG. 11, the sliding saddle member 33 has a higher center portion and lower opposite side portions (i.e., in the form of a ridge). The vertex thereof is rounded. This configuration is selected for the same reason as the vertices of the guides 31 and 32 of FIG. 7 are rounded.

Next, the automatic performance of the automatic performance system as shown in FIG. 1 will be explained. The operator connects the automatic musical instrument main body 1 with the television monitor 80 by the AV cable 60. Then, the power switch 24 of FIG. 3 is turned on. This power switch 24 is a slide switch having an “off” position at the center, an “on” position (television mode) at one end in which musical tones are output from a speaker (not shown in the figure) of the television monitor 80, and another “on” position (speaker mode) at the other end in which musical tones are output from the speaker unit 11 of the bout portion 10. Meanwhile, the sound volume of the musical tones as output from the headphone 70 or the speaker unit 11 can be adjusted by the volume dial 16. When the power switch 24 is turned on to start the television mode, an operation style selection screen is displayed on the screen 82.

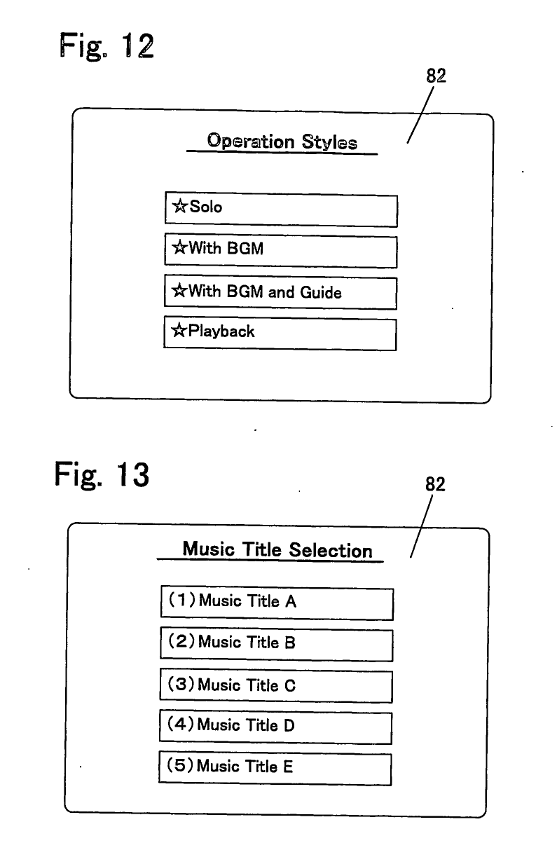

FIG. 12 is a view showing an example of the operation style selection screen displayed on the screen 82 of FIG. 1. As shown in FIG. 12, four operation styles are displayed on the screen 82. The operator selects any one of the operation styles by the selection keys 12a and 12b, and then presses the decision key 12d.

In what follows, the operation styles as shown in FIG. 12 will be briefly explained. “Solo” is a style corresponding to the mode in which the operator can take control of the automatic performance of the automatic musical instrument without an accompanying BGM (background music) and without an operation guide. “With BGM” is a style corresponding to the mode in which the operator can take control of the automatic performance of the automatic musical instrument with an accompanying BGM and without an operation guide. “With BGM and Guide” is a style corresponding to the mode in which the operator can take control of the automatic performance of the automatic musical instrument with an accompanying BGM and with an operation guide. “Playback” is a style corresponding to the mode in which the automatic musical instrument main body 1 plays back music while the operator does not take control of the automatic performance.

If the operator selects an operation style, then a music title selection screen is displayed on the screen 82. FIG. 13 is a view showing an example of the music title selection screen as displayed on the screen 82 of FIG. 1. As shown in FIG. 13, in this example, it is possible to select a desired music title from among title A to title E. The operator selects a music title by the selection keys 12a and 12b, followed by pressing the decision key 12d. On the other hand, the number of the music title as selected is displayed on the display portion 15.

When the operator selects and decides a music title, the performance can be started. In any style of “Solo”, “With BGM” and “With BGM and Guide”, the operator can take control of the automatic performance of the music title as selected by operating the sliding operation piece 40.

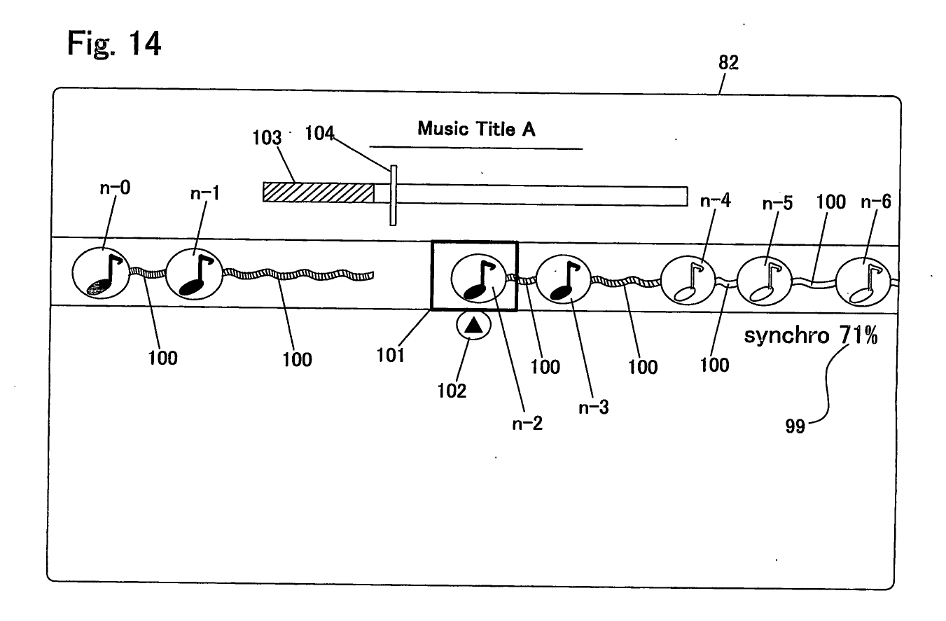

The style of “With BGM and Guide” as selected by the operator will be explained as an example of a mode in which the operator can take control of the automatic performance of the automatic musical instrument. FIG. 14 is a view showing an example of an operation guide screen as displayed on the screen 82 of FIG. 1. As illustrated in FIG. 14, if the operator selects “With BGM and Guide”, the operation guide screen is displayed on the screen 82. More specific description is as follows.

The music title as selected by the operator is displayed in the vicinity of the upper location of this operation guide screen. In this case, music A is displayed as a music title. An indicator 103 is displayed below the music title. This indicator 103 indicates the progress of the BGM. Namely, the entire length of the strip-shaped rectangle of the indicator 103 represents the entire time length of the music A. The left portion of the indicator 103 is shaded with a certain color and gradually extended with the progress of the BGM in order to indicate the current time position of the BGM as being currently played back.

For this reason, as the playback of the BGM advances, the area of the indicator 103 shaded with the certain color increases and completely fills the entirety of the indicator 103 when the music A ends. Incidentally, hatching is used in FIG. 14 for representing the shading with the certain color.

Furthermore, the indicator 103 is overlaid with a vertical bar 104 for indicating the current operation position by the operator. Accordingly, the operator can see how much the current operation position is displaced from the appropriate operation position. Namely, since the appropriate current operation position corresponds to the leading edge (right end) of the left portion of the indicator 103 which is shaded with the certain color, the operator can see how much the current operation position is displaced from the appropriate operation position by comparing the position of this leading edge (right end) with the position of the vertical bar 104 indicating the current operation position of the operator. The term “operation position” stands for the position in the time domain relating to the entirety of the music.

Also, musical notation marks n-0, . . , n-6, . . , are displayed below the indicator 103 as an operation guide. In the following description, the term “musical notation mark n” is used to generally represent the musical notation marks n-0, , . . , n-6, . . .

This musical notation mark n appears from the right end of the screen 82, then moves to the left in synchronism with the tempo of the BGM, and finally disappears at the left end of the screen 82. If the operator generates a trigger by operation of the sliding operation piece 40 at the right moment when this musical notation mark n enters a correct timing indication square 101 or passes directly above a correct timing mark 102, then the automatic musical instrument outputs musical tones keeping pace with the tempo of the BGM.

Also, the distance between adjacent ones of this musical notation mark n represents the timely distance between the corresponding notes written in the musical score of the music A as selected. Accordingly, the operator can intuitively recognize the correct timing of operating the sliding operation piece 40 by taking a look at this distance. In this situation, the timing of operating the sliding operation piece 40 means the timing of generating a trigger.

Furthermore, a note length indication bar 100 associated with the musical notation mark n represents a period for which the output of a musical note is continued. Accordingly, the operator can intuitively recognize the period of maintaining the sound of a note by taking a look at this note length indication bar 100. Incidentally, the note length indication bar 100 associated with the musical notation mark n-1 does not reach to the next musical notation mark n-2. This means that a rest notation exists at the end (right end) of this note length indication bar 100.

Furthermore, when the operator operates the sliding operation piece 40 to have the automatic musical instrument output a musical tone, the color of the musical notation mark n corresponding to the output musical tone and the color of the note length indication bar 100 associated with the musical notation mark n are changed. The operator can intuitively recognize by the color change which musical notation mark n is corresponding to the musical tone currently output from the automatic musical instrument in response to the trigger.

Furthermore, a synchronization value 99 is displayed on the screen 82. This synchronization value 99 is a numerical value indicating how much the current operation by the operator is displaced from the appropriate operation timing as will be explained later in detail.

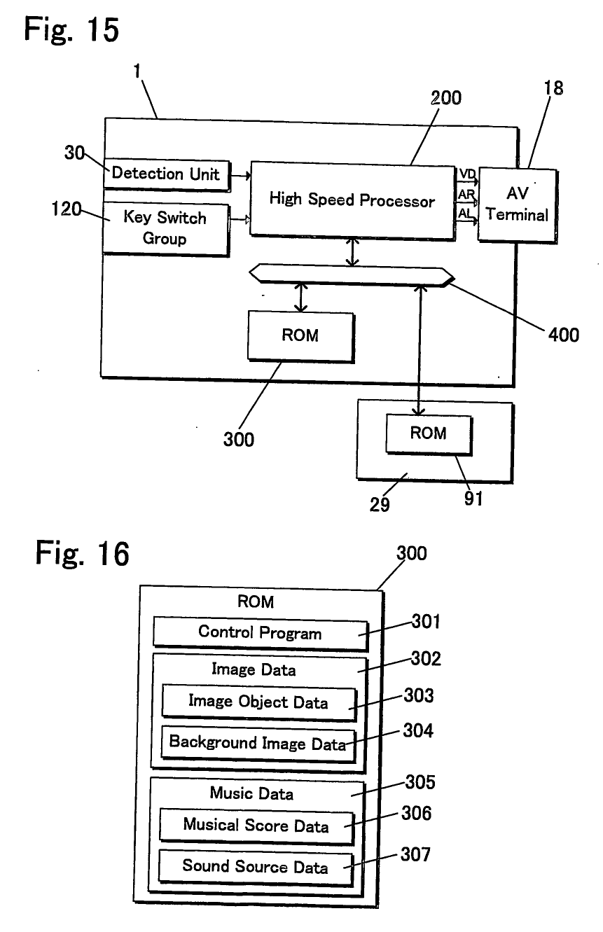

Next, the electrical construction of the automatic musical instrument main body 1 will be explained. FIG. 15 is a view showing the electrical construction of the automatic musical instrument main body 1 as illustrated in FIG. 1. As illustrated in FIG. 15, the automatic musical instrument main body 1 includes a detection unit 30, a key switch group 120, an AV terminal 18, a high speed processor 200, a ROM 300 and a bus 400. The key switch group 120 includes the decision key 12d, the cancel key 12c, the selection keys 12a and 12b, and the vibrato switch 12e as described above.

FIG. 16 is a schematic representation of a program and data stored in the ROM 300 of FIG. 15. As illustrated in FIG. 16, the ROM 300 is used to store a control program 301, image data 302, and music data 305. The image data 302 includes image object data 303 and background image data 304. The music data 305 includes musical score data 306 and sound source data 307.

Returning to FIG. 15, the high speed processor 200 is connected to the bus 400. Furthermore, the ROM 300 is connected to the bus 400. Accordingly, the high speed processor 200 can access the ROM 300 through the bus 400 to read and execute the control program 301 as stored in the ROM 300, and read and process the image data 302 and the music data 305 as stored in the ROM 300.

Incidentally, it is also possible to store the control program 301, the image data 302 and the music data 305 in the ROM 91 of the memory cartridge 29 instead of the ROM 300, and make use of the program and data by inserting this memory cartridge 29 into the socket 23. The memory cartridge 29 may contain an EEPROM in place of the ROM 91 for the same purpose. By making use of such a rewritable memory, the user can freely write musical score data to the memory and play automatic performance on the basis of the musical score data as written.

Namely, the high speed processor 200 can access the ROM 91 contained in the memory cartridge 29 as inserted through the bus 400 to read and execute the control program 301 as stored in the ROM 91, and read and process the image data 302 and the music data 305 as stored in the ROM 91.

On the other hand, the high speed processor 200 serves to calculate the sliding direction and the sliding speed of the sliding operation piece 40 on the basis of the pulse signals output from the phototransistors 34 and 35 of the detection unit 30 (refer to FIG. 7). Furthermore, the high speed processor 200 executes the process as indicated by on/off signals from the respective keys 12a to 12e of the key switch group 120.

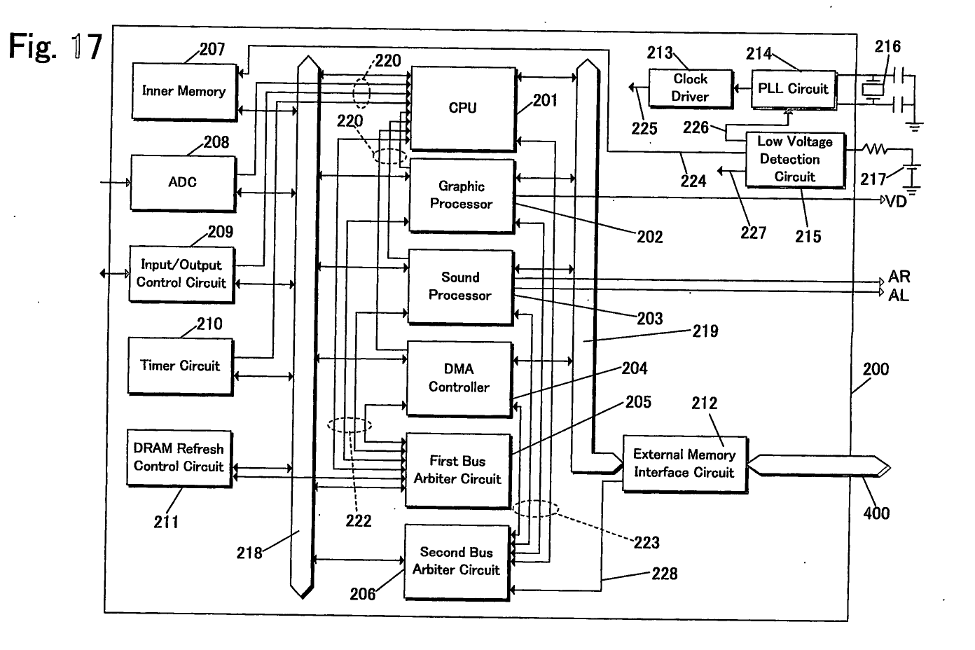

FIG. 17 is a block diagram of the high speed processor 200 of FIG. 15. As illustrated in FIG. 17, this high speed processor 200 includes a central processing unit (CPU) 201, a graphic processor 202, a sound processor 203, a DMA (direct memory access) controller 204, a first bus arbiter circuit 205, a second bus arbiter circuit 206, an inner memory 207, an A/D converter (ADC: analog to digital converter) 208, an input/output control circuit 209, a timer circuit 210, a DRAM (dynamic random access memory) refresh control circuit 211, an external memory interface circuit 212, a clock driver 213, a PLL (phase-locked loop) circuit 214, a low voltage detection circuit 215, a first bus 218, and a second bus 219.

The CPU 201 takes control of the entire system and perform various types of arithmetic operations in accordance with the program stored in the memory (the inner memory 207, the ROM 300, or the ROM 91). The CPU 201 is a bus master of the first bus 218 and the second bus 219, and can access the resources connected to the respective buses.

The graphic processor 202 is also a bus master of the first bus 218 and the second bus 219, and generates an image signal VD on the basis of the data as stored in the inner memory 207, the ROM 300 or the ROM 91, and output the image signal VD (composite signal in the case of this embodiment) through the AV terminal 18. The graphic processor 202 is controlled by the CPU 201 through the first bus 218. Also, the graphic processor 202 has the functionality of outputting an interrupt request signal 220 to the CPU 201.

The sound processor 203 is also a bus master of the first bus 218 and the second bus 219, and generates audio signals AR and AL on the basis of the data as stored in the inner memory 207, the ROM 300 or the ROM 91, and output the audio signals AR and AL through the AV terminal 18. The sound processor 203 is controlled by the CPU 201 through the first bus 218. Also, the sound processor 203 has the functionality of outputting an interrupt request signal 220 to the CPU 201.

The DMA controller 204 serves to transfer data from the ROM 300 or the ROM 91 to the inner memory 207. Also, the DMA controller 204 has the functionality of outputting, to the CPU 201, an interrupt request signal 220 indicative of the completion of the data transfer. The DMA controller 204 is also a bus master of the first bus 218 and the second bus 219. The DMA controller 204 is controlled by the CPU 201 through the first bus 218.

The inner memory 207 may be implemented with one or any necessary combination of a mask ROM, an SRAM (static random access memory) and a DRAM in accordance with the system requirements. A battery 217 is provided if an SRAM has to be powered by the battery for maintaining the data contained therein. In the case where a DRAM is used, the so called refresh cycle is periodically performed to maintain the data contained therein.

The first bus arbiter circuit 205 accepts a first bus use request signal from the respective bus masters of the first bus 218, performs bus arbitration among the requests for the first bus 218, and issue a first bus use permission signal to one of the respective bus masters. Each bus master is permitted to access the first bus 218 after receiving the first bus use permission signal. In FIG. 17, the first bus use request signal and the first bus use permission signal are illustrated as first bus arbitration signals 222.

The second bus arbiter circuit 206 accepts a second bus use request signal from the respective bus masters of the second bus 219, performs bus arbitration among the requests for the second bus 219, and issue a second bus use permission signal to one of the 5 respective bus masters. Each bus master is permitted to access the second bus 219 after receiving the second bus use permission signal. In FIG. 17, the second bus use request signal and the second bus use permission signal are illustrated as second bus arbitration signals 223.

The input/output control circuit 209 serves to perform input and output operations of input/output signals to enable the communication with external input/output device(s) and/or external semiconductor device(s). The read and write operations of input/output signals are performed by the, CPU 201 through the first bus 218. Incidentally, the input/output signals are input and output through a programmable input/output port. Also, the input/output control circuit 209 has the functionality of outputting an interrupt request signal 220 to the CPU 201.

The pulse signals A, B and “all” from the above detection unit 30 and the on/off signals from the respective keys 12a to 12e of the key switch group 120 are input to the input/output control circuit 209, for example, through the input/output ports IO0 to IO7.

The timer circuit 210 has the functionality of periodically outputting an interrupt request signal 220 to the CPU 201 with a time interval as preset. The setting of the timer circuit 210 such as the time interval is performed by the CPU 201 through the first bus 218.

The ADC 208 converts analog input signals into digital signals. The digital signals are read by the CPU 201 through the first bus 218. Also, the ADC 208 has the functionality of outputting an interrupt request signal 220 to the CPU 201.

The PLL circuit 214 generates a high frequency clock signal by multiplication of the sinusoidal signal as obtained from a crystal oscillator 216.

The clock driver 213 amplifies the high frequency clock signal as received from the PLL circuit 214 to a sufficient signal level to supply the respective blocks with the clock signal 225.

The low voltage detection circuit 215 monitors the power potential Vcc and issues the reset signal 226 of the PLL circuit 214 and the reset signal 227 to the other circuit elements of the entire system when the power potential Vcc falls below a certain voltage. Also, in the case where the inner memory 207 is implemented with an SRAM requiring the power supply from the battery 217 for maintaining data, the low voltage detection circuit 215 serves to issue a battery backup control signal 224 when the power potential Vcc falls below the certain voltage.

The external memory interface circuit 212 has the functionality of connecting the second bus 219 to the external bus 400 and issuing a bus cycle completion signal 228 of the second bus 219 to control the length of the bus cycle of the second bus.

The DRAM refresh cycle control circuit 211 periodically and unconditionally gets the ownership of the first bus 218 to perform the refresh cycle of the DRAM at a certain interval. Needless to say, the DRAM refresh cycle control circuit 211 is provided in the case where the inner memory 207 includes a DRAM.

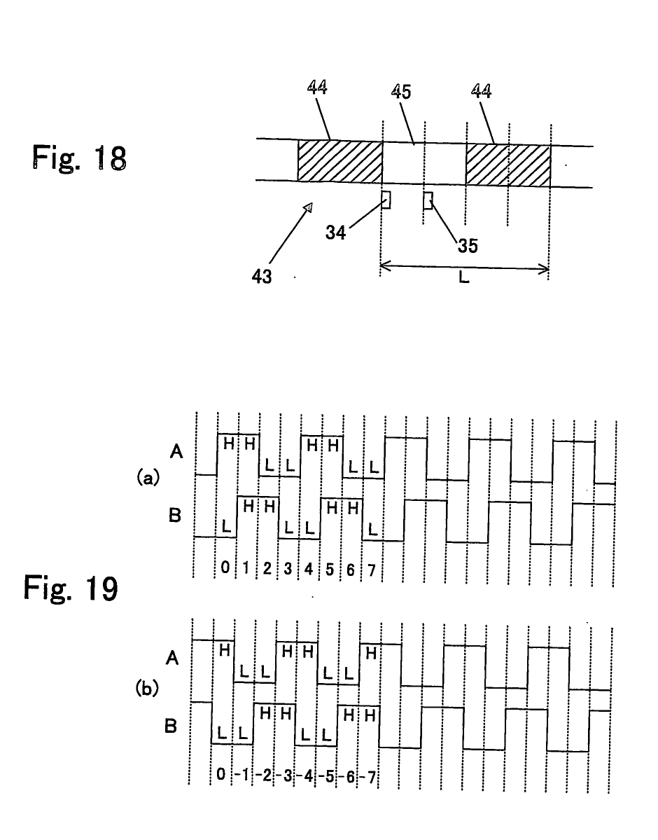

Next, the method of obtaining the sliding speed and the sliding direction of the sliding operation piece 40 will be explained in detail. FIG. 18 is a schematic diagram showing the relationship between the reflecting pattern 43 of the sliding operation piece 40 and the locations of the phototransistors 34 and 35 of the detection unit 30 of FIG. 15. As illustrated in FIG. 18, “L” is the sum of the width of the light reflecting region 45 and the width of the light absorbing region 44 in the reflecting pattern 43 of the sliding operation piece 40. In this case, the phototransistor 34 and the phototransistor 35 are located apart from each other by L/4.

The phototransistors 34 and 35 receive the infrared light output from the light emitting diode 36 and reflected by the reflecting pattern 43. Since the reflecting pattern 43 comprises the light reflecting regions 45 and the light absorbing regions 44 alternately arranged, the phototransistors 34 and 35 intermittently receive the infrared light when the sliding operation piece 40 is moved. Accordingly, when the sliding operation piece 40 is operated, the phototransistors 34 and 35 output the pulse signals having a frequency in proportion to the sliding speed of the sliding operation piece 40. Namely, as the sliding speed of the sliding operation piece 40 increases, the frequency of the pulse signals output from the phototransistors 34 and 35 increases. Conversely, as the sliding speed of the sliding operation piece 40 decreases, the frequency of the pulse signals output from the phototransistors 34 and 35 decreases.

Since the phototransistor 34 and the phototransistor 35 are located apart from each other by L/4, the phase difference between the pulse signal as output from the phototransistor 34 and the pulse signal as output from the phototransistor 35 is (90 degrees) or (−90 degrees) depending upon the sliding direction of the sliding operation piece 40. This point will be explained in detail.

FIG. 19(a) is a diagram showing the pulse signals A and B as output from the phototransistors 34 and 35 when the sliding operation piece 40 is moved in the direction of the positive x-axis, while FIG. 19(b) is a diagram showing the pulse signals A and B as output from the phototransistors 34 and 35 when the sliding operation piece 40 is moved in the direction of the negative x-axis. Incidentally, for the sake of clarity in explanation, FIG. 19(a) and FIG. 19(b) are illustrated on the assumption that the sliding speed of the sliding operation piece 40 is constant.

As illustrated in FIG. 19(a) and FIG. 19(b), the phase difference between the pulse signal A as output from the phototransistor 34 and the pulse signal B as output from the phototransistor 35 is (90 degrees) or (−90 degrees). The state transition of the waveforms of the pulse signals A and B in combination is different between the case where the sliding operation piece 40 is moved in the direction of the positive x-axis and the case where the sliding operation piece 40 is moved in the direction of the negative x-axis. This point will be explained in detail.

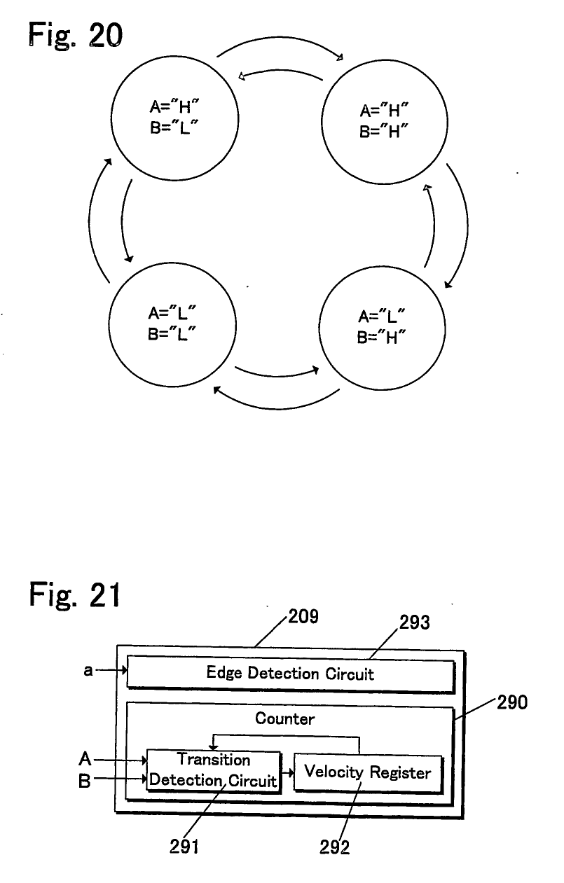

FIG. 20 is a schematic diagram showing the state transition of the pulse signals A and B as output from the phototransistors 34 and 35. When the sliding operation piece 40 is moved in the direction of the positive x-axis (corresponding to FIG. 19(a)), the state transition of the pulse signals A and B turns in the clockwise direction as illustrated in FIG. 20. Conversely, when the sliding operation piece 40 is moved in the direction of the negative x-axis (corresponding to FIG. 19(b)), the state transition of the pulse signals A and B turns in the counter clockwise direction as illustrated in FIG. 20.

It is possible to determine the sliding direction of the sliding operation piece 40 by detecting such a state transition. Namely, the state transition of the pulse signals A and B turning in the clockwise direction means that the sliding operation piece 40 is moved in the direction of the positive x-axis, while the state transition of the pulse signals A and B turning in the counter clockwise direction means that the sliding operation piece 40 is moved in the direction of the negative x-axis. The state transition is detected by the use of a counter 290 contained in the input/output control circuit 209 as shown in FIG. 17.

FIG. 21 is a partial block diagram showing a part of the input/output control circuit 209 as shown in FIG. 17. As illustrated in FIG. 21, the input/output control circuit 209 includes the counter 290 and an edge detection circuit 293. The counter 290 includes a transition detection circuit 291 and a velocity register 292.

The transition detection circuit 291 detects the state transition of the pulse signals A and B as input from the phototransistors 34 and 35 of the detection unit 30 and counts the frequency of state transition as a signed counter value. The transition detection circuit 291 then stores the counter value in the velocity register 292.

More specifically speaking, the transition detection circuit 291 reads the value of the velocity register 292, and increments or decrements the value in accordance with the direction of the state transition, and then stores the resultant value into the velocity register 292. In this case, the transition detection circuit 291 increments the value when state transition is detected in the clockwise direction as shown in FIG. 20 (corresponding to FIG. 19(a)). Conversely, the transition detection circuit 291 decrements the value when state transition is detected in the counter clockwise direction as shown (corresponding to FIG. 19(b)).

Since the state transition of the pulse signals A and B is detected in the clockwise direction in the case of the example as shown in FIG. 19(a), the transition detection circuit 291 counts up as 1, 2, . . , each time the state transition is detected, followed by storing the counter value in the velocity register 292. Since the state transition of the pulse signals A and B is detected in the counter clockwise direction in the case of the example as shown in FIG. 19(b), the transition detection circuit 291 counts down as −1, −2, . . , each time the state transition is detected, in order to have the velocity register 292 store the counter value.

Accordingly, it is possible to determine the direction of the state transition with reference to the sign of the counter value as stored in the velocity register 292, and therefore determine the sliding direction of the sliding operation piece 40.

Furthermore, the counter value stored in the velocity register 292 per predetermined time period (for example, per frame) represents the sliding velocity v0 of the sliding operation piece 40. In this case, the moving average (might be mentioned as “average”) of the counter value v0 stored in the velocity register 292 is termed as the sliding velocity v1. While the sliding speed |v| (=V1) of the sliding operation piece 40 can be determined in this manner, the sliding speed of the sliding operation piece 40 can be determined also in the following way.

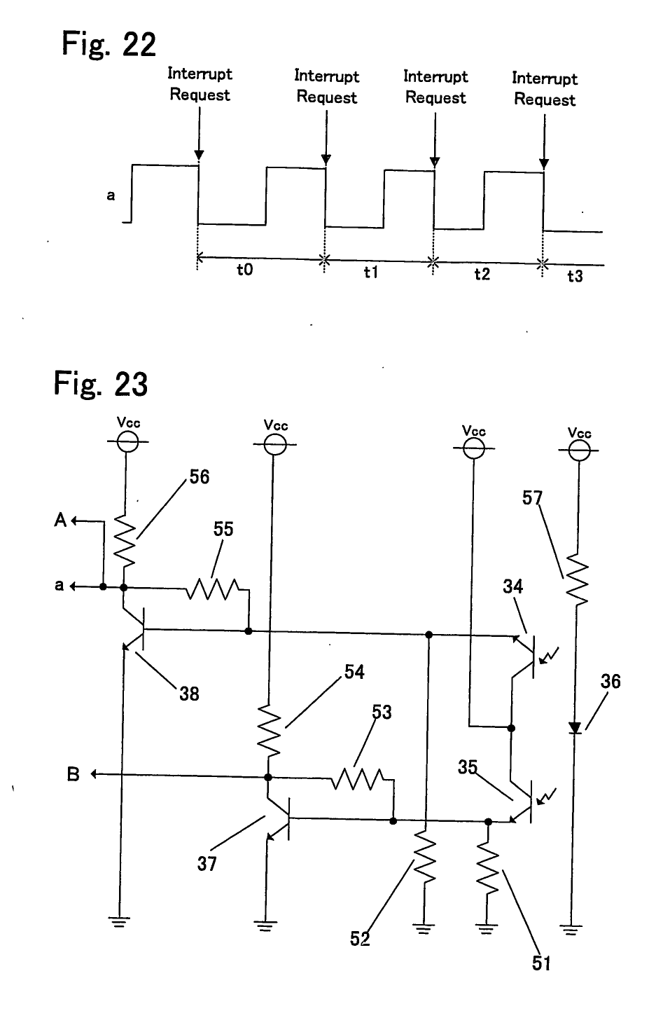

FIG. 22 is a view for explaining the other method of determining the sliding speed of the sliding operation piece 40. As illustrated in FIG. 22, the edge detection circuit 293 of the input/output control circuit 209 issues an interrupt request signal after detecting the falling edge transition of the pulse signal “a” as output from the phototransistor 34. When receiving the interrupt request signal, the CPU 201 reads the timer value from the timer circuit 210. The CPU 201 then calculates the difference between the current timer value and the previous timer value and obtains the period of one cycle of the pulse signal “a” (the pulse cycle). The CPU 201 reads the timer value in response to the interrupt request signal, calculates the difference between the current timer value and the previous timer value and obtains the pulse cycle t0, t1, t2, t3 and . . . The CPU 201 then obtains the moving average of the pulse cycle (averaged over N cycles: N is 2 or a larger integer). The reciprocal number of the average pulse cycle is the sliding speed V2 of the sliding operation piece 40. For example, if N=4 and the pulse cycle is sequentially obtained as t0, t1, t2, and the current cycle t3 in this order, then V2=4/(t0+t1+t2+t3). The number N is sometimes called the sample number.

Next, the detection unit 30 of FIG. 15 provided in the automatic musical instrument main body 1 will be explained. FIG. 23 is a circuit diagram showing the detection unit 30 provided in the automatic musical instrument main body 1. As illustrated in FIG. 23, this detection unit 30 includes the light emitting diode 36, the phototransistors 34 and 35, transistors 37 and 38 and resistance elements 51 to 57.

The resistance element 57 is connected to the electric power source Vcc at one terminal and connected to the anode of the light emitting diode 36 at the other terminal. The cathode of the light emitting diode 36 is grounded. The collectors of the phototransistors 34 and 35 are connected to the electric power source Vcc.

The base of the transistor 38, one terminal of the resistance element 55 and the emitter of the phototransistor 34 are connected to one terminal of the resistance element 52. The other terminal of the resistance element 52 is grounded. The collector of the transistor 38 and the other terminal of the resistance element 55 are connected to one terminal of the resistance element 56. The other terminal of the resistance element 56 is connected to the electric power source Vcc. The emitter of the transistor 38 is grounded.

The base of the transistor 37, one terminal of the resistance element 53 and the emitter of the phototransistor 35 are connected to one terminal of the resistance element 51. The other terminal of the resistance element 51 is grounded. The collector of the transistor 37 and the other terminal of the resistance element 53 are connected to the one terminal of the resistance element 54. The other terminal of the resistance element 54 is connected to the electric power source Vcc. The emitter of the transistor 37 is grounded.

When the phototransistor 34 receives infrared light, the transistor 38 is turned on to pull down the collector of the transistor 38 to low level. Conversely, when the phototransistor 34 receives no infrared light, the transistor 38 is turned off to maintain the collector of the transistor 38 at high level by virtue of the pull up resistor 56. Accordingly, when the phototransistor 38 intermittently receives infrared light, the pulse signals (electric signals) A and “a” are output from the detection unit 30. In the same manner, when the phototransistor 35 intermittently receives infrared light, the pulse signal (electric signal) B is output from the detection unit 30.

Incidentally, the pulse signal “all is obtained by branching the pulse signal A and therefore both signals are the same. The sliding direction and the sliding speed V1 of the sliding operation piece 40 as obtained from the pulse signals A and B are used in the trigger process. The sliding speed V2 of the sliding operation piece 40 as obtained from the pulse signal “a” is used to control the sound volume.

It is the following reason that the sliding speed V2 is used, rather than the sliding speed V1 to control the sound volume. Namely, this is because the sliding speed V2 is obtained by measuring the pulse cycle and therefore the movement of the sliding operation piece 40 can be more precisely reflected on the control of the sound volume by the use of the sliding speed V2 than by the use of the sliding speed V1.

Returning to FIG. 16, the music data 305 will be explained in detail. The sound source data 307 as stored in the ROM 300 contains waveform data and envelope data. The musical score data 306 contains the musical score data for BGM, the musical score data for registering musical notation marks, and the musical score data for outputting musical tones in response to triggers.

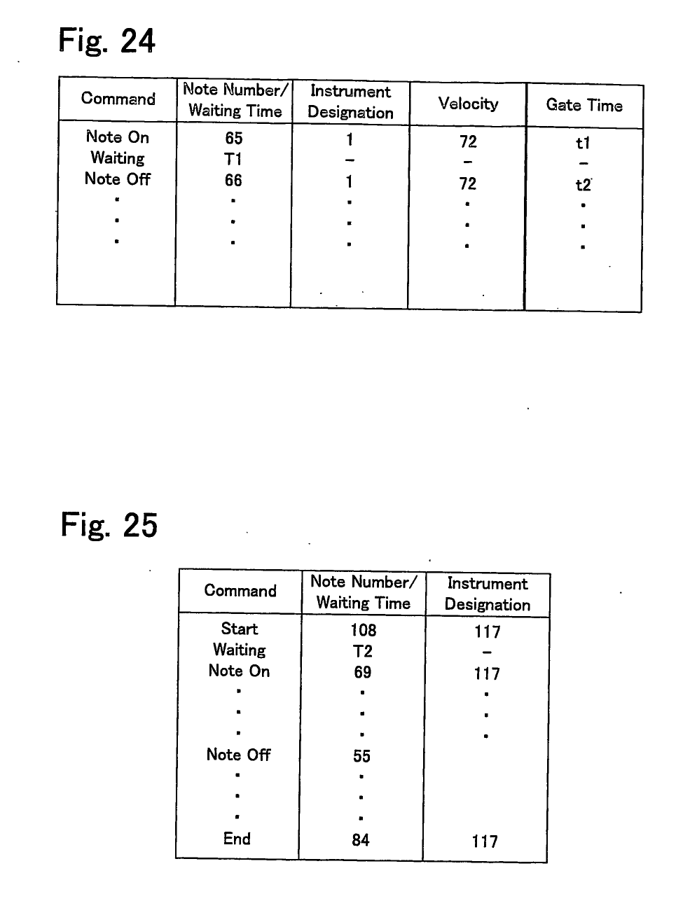

FIG. 24 is a view for explaining the musical score data for BGM as stored in the ROM 300 of FIG. 16. As illustrated in FIG. 24, the musical score data for BGM is time-series data containing commands, note number/waiting time information, instrument designation information, velocity information, and gate time information. In the figure, “Note On” is a command to output sound, and “Wait” is a command to set a waiting time. The waiting time is the time period to elapse to reading the next command after reading the current command (the time period between one musical note and the next musical note). The note number information designates a pitch (the frequency of sound vibration). The waiting time information designates a waiting time. The instrument designation information designates a musical instrument whose tone quality is to be used. The velocity information designates a magnitude of sound, i.e., a sound volume. The gate time information designates a period for which the output of a sound is continued.

FIG. 25 is a view for explaining the musical score data for registering musical notation marks as stored in the ROM 300 of FIG. 16. As illustrated in FIG. 25, the musical score data for registering musical notation marks is time-series data containing commands, note number/waiting time information, and instrument designation information. The instrument designation information designates the number corresponding to the instrument for displaying the musical notation mark n rather than the instrument number corresponding to the instrument of (tone quality) which sound is to be output. It is indicated by the instrument designation information that this musical score data is not musical score data for outputting music sound but musical score data for letting the musical notation mark n be displayed. Accordingly, “Note On” in this case is not a command to output sound but a command to let the musical notation mark n be displayed. More specifically speaking, the note number “69” corresponding to the “Note On” command is used to let the musical notation mark n be displayed.

Also, “Note Off” in this case is not a command to stop sound output but a command to stop drawing the note length indication bar 100. More specifically speaking, the note number “55” corresponding to the “Note Off” command is used to stop drawing the note length indication bar 100. Also, “Start Code” is located at the head of the musical score data for registering musical notation marks. The corresponding note number “108” is the information indicative of the head of the musical score data for registering musical notation marks. By this structure, it is possible to align the head of the musical score data for BGM with the head of the musical score data for registering musical notation marks. On the other hand, “End Code” is located at the end of the musical score data for registering musical notation marks. The corresponding note number “84” is the information indicative of the end of the music.

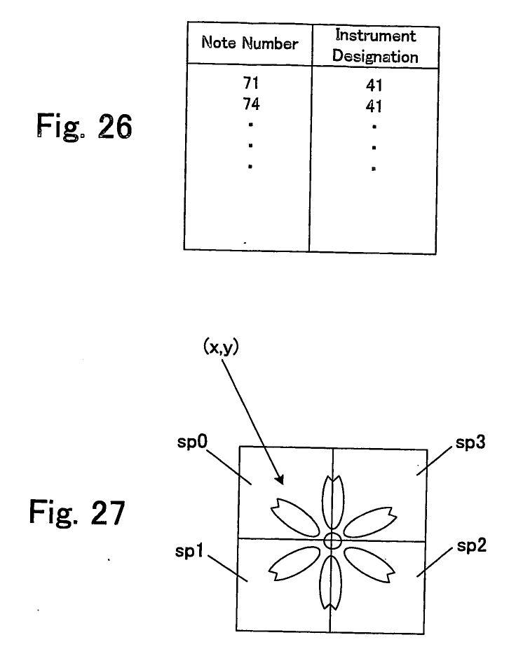

FIG. 26 is a view for explaining the musical score data for outputting musical tones in response to triggers as stored in the ROM 300 of FIG. 16. As illustrated in FIG. 26, the musical score data for outputting musical tones is time-series data containing note number information and instrument designation information. The note number information designates a pitch (the frequency of sound vibration). The instrument designation information designates a musical instrument whose tone quality is to be used. In the case of the present embodiment, the tone quality of a violin is designated as an example. Incidentally, the start timing of outputting sound, the length of sound output and the sound volume are determined by the operation of the sliding operation piece 40, and therefore this musical score data does not contain waiting commands, waiting time information, velocity information and gate time information.

At this time, pitch control information used for processing sound output will be explained. The pitch control information is used to perform the pitch conversion by changing the frequency of reading the waveform data and the envelope data. Namely, the sound processor 203 periodically reads the pitch control information for waveform data at a certain interval and accumulates the pitch control information for waveform data. Also, the sound processor 203 periodically reads the pitch control information for envelope data at a certain interval and accumulates the pitch control information for envelope data. The sound processor 203 makes use of these results of accumulation as the address pointer waveform data and the address pointer to envelope data respectively. Accordingly, if a large value is set as a pitch control information, the address pointer is quickly incremented by the large value to increase the frequency. Conversely, if a small value is set as a pitch control information, the address pointer is slowly incremented by the small value to decrease the frequency. In this way, the sound processor 203 performs the pitch conversion of waveform data and envelope data. Meanwhile, the pitch control information of waveform data is referred to as waveform pitch control information, and the pitch control information of envelope data is referred to as envelope pitch control information.

Next, the details of image data 302 will be explained. Image objects including the musical notation mark n and a background image are displayed on the screen 82. For example, the background image comprises a pixel set of 256 (width)×256 (height) pixels, among which 256 (width)×224 (height) pixels are visualized in the screen 82. An image object include one or more sprites. One sprite comprises a rectangular pixel set. For example, a sprite consists of 8 (width)×8 (height) pixels or 16 (width)×16 (height) pixels. Incidentally, a sprite can be arranged in an arbitrary position of the screen 82.

FIG. 27 is a view for explaining sprites constituting an image object. For example, as shown in FIG. 27, it is assumed that a certain image object is composed of four sprites sp0 to sp3. The display position of the image object can be designated by designating the horizontal coordinate x and the vertical coordinate y of the center of the upper left sprite sp0. Since the size of the sprites sp0 to sp3 is known, it is possible to calculate the display positions of the respective sprites sp0 to sp3 with ease.

The image object data 303 as stored in the ROM 300 contains the size and the pixel pattern designation information of each of the sprites constituting each object, and the size, the depth value, the color palette information, the vertical coordinate x and the vertical coordinate y of each object. Incidentally, the respective sprites have the same depth value and the same color palette information, which are designated by the depth value and the color palette information of the corresponding object.

The depth value indicates the depth position of the pixels, and if a plurality of pixels overlap each other only the pixel having the largest depth value is displayed. The pixel pattern designation information designates the color of each pixel constituting a sprite. The color palette information designates a color palette. A color palette consists of a plurality of color information entries. One color information entry includes Hue, Saturation and Brightness values. For example, if the color palette as designated by the color palette information corresponding to a certain sprite contains 16 colors, the color used for displaying each pixel of the sprite is designated from among the 16 colors in accordance with the pixel pattern designation information.

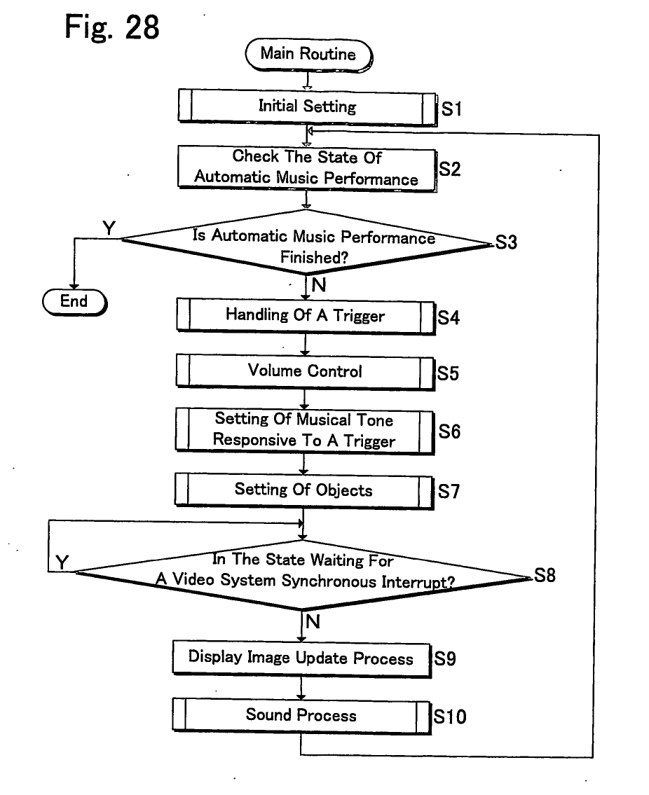

Next, the process flow of the automatic musical instrument of FIG. 1 will be explained. FIG. 28 is a flow chart showing an example of the overall process flow of the automatic musical instrument. As illustrated in FIG. 28, the CPU 201 performs the initial setting of the system in step S1. In step S2, the CPU 201 checks the state of automatic performance. In step S3, the CPU 201 determines whether or not the automatic performance is finished. If the automatic performance is finished (a music end flag is turned on as hereinafter described), the CPU 201 finishes the process. Conversely, if the automatic performance is not finished yet, the process then proceeds to step S4.

In step S4, the CPU 201 determines the sliding direction and calculates the sliding speed V0 of the sliding operation piece 40, and if the trigger generating requirements are satisfied, the CPU 201 generates a trigger (set an sound output flag on). In step S5, the CPU 201 calculates an envelope coefficient in proportion to the sliding speed V2 of the sliding operation piece 40 in order to control the volume of musical sound started in response to the trigger.

In step S6, the CPU 201 stores, in the inner memory 207, the initial addresses of the attack data and the loop data of waveform data by the use of the pointer to the musical score data for sound output as started in response to the trigger, together with the envelope data multiplied by the envelope coefficient as calculated. Meanwhile, the attack data and the loop data of waveform data and the envelope data are the musical tone related information used for sound output to be started in response to a trigger. In step S7, the CPU 201 stores, in the inner memory 207, the object related information required for displaying objects such as the musical notation mark n.

In step S8, it is determines whether or not the CPU 201 waits for the video system synchronous interrupt. The display screen of the television monitor 80 is updated in the vertical blanking period. Accordingly, after the process necessary for updating the display screen is completed, the CPU 201 refrains from proceeding its operation until the next video system synchronous interrupt is issued. Namely, while the CPU 201 waits for a video system synchronous interrupt in step S8 (i.e., as long as the interrupt signal responsive to the video system synchronous does not issue), the process repeats the same step S8. On the other hand, if the CPU 201 gets out of the state of waiting for a video system synchronous interrupt in step S8 (i.e., if the CPU 201 is given a video system synchronous interrupt), the process proceeds to the step S9.

In step S9, the CPU 201 transmits object related information to the graphic processor 202, and the graphics processor 202 acquires background image related information from the inner memory 207. The graphic processor 202 generates the image signal VD containing object and background images, and outputs it to the television monitor 80.

In step S10, the CPU 201 stores, in the inner memory 207, the musical tone related information on the basis of the musical score data for BGM. The sound processor 203 acquires the musical tone related information for trigger sound output (refer to step S6) and for the BGM sound output from the inner memory 207, and generates audio signals AL and AR on the basis of the information, and outputs these signals to the television monitor 80. Also, in step S10, the CPU 201 registers the musical notation mark n in accordance with the musical score data for registering musical notation marks.

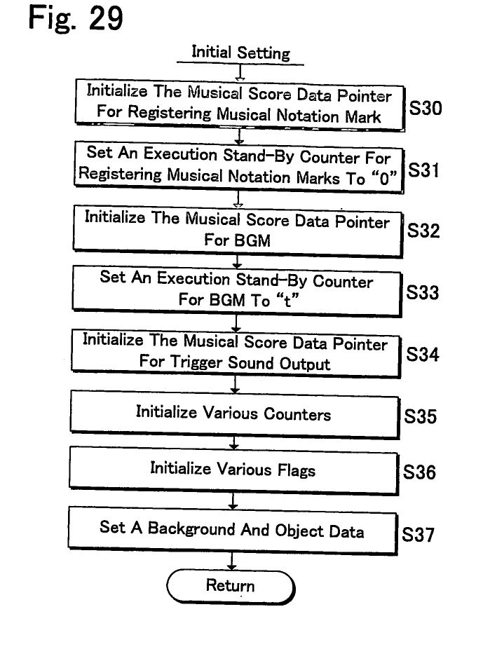

FIG. 29 is a flow chart showing an example of the process flow in the initial setting of the system in step S1 of FIG. 28. As shown in FIG. 29, the CPU 201 initializes the musical score data pointer for registering musical notation marks in step S30. In step S31, the CPU 201 sets an execution stand-by counter for registering musical notation marks to “0”. In step S32, the CPU 201 initializes the musical score data pointer for BGM. In step S33, the CPU 201 sets an execution stand-by counter for BGM to “t”. In step S34, the CPU 201 initializes the musical score data pointer for trigger sound output.

In step S35, the CPU 201 initializes various counters. In step S36, the CPU 201 initializes various flags. In step S37, the CPU 201 stores the object related information and the background related information required for displaying a background respectively in the object data area and the background data area of the inner memory 207.

More specific description is as follows. It is assumed that the background image consists, for example, of 32×32 blocks. Then, while the background image consists of a pixel set of 256 (width)×256 (height) pixels as described above, one block consists of 8 (width)×8 (height) pixels. The CPU 201 stores the depth value and the color palette information distinctively for each block in the inner memory 207, and also stores the storage location information of the pixel pattern designation information for each block in the inner memory 207.

Also, the CPU 201 stores the object related information (size, depth value, color palette information, the storage location information of pixel pattern designation information, vertical coordinate and vertical coordinate) of all the objects to be displayed in the inner memory 207.

Then, while the execution stand-by counter for BGM is set to “t” (step S33), the execution stand-by counter for registering musical notation marks is set to “0” (step S31). This is for the following reason.

Namely, this is because it takes a certain period for the musical notation mark n to enter the correct timing indication square 101 after appearing at the rightmost edge as illustrated in FIG. 14, and therefore the musical notation mark n must be displayed at the certain period earlier to compensate this differential time. In other words, the musical score data for registering musical notation marks is read out at the certain period (a counter value t) earlier than for BGM. The execution stand-by counter for registering musical notation marks and the execution stand-by counter for BGM serve to count down.

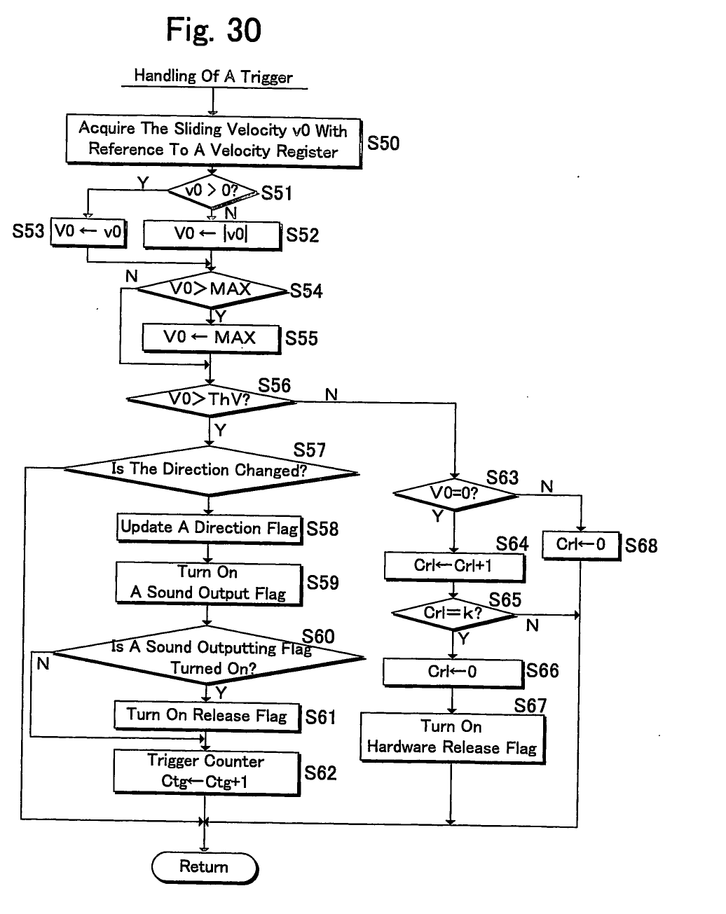

FIG. 30 is a flowchart showing an example of the procedure for handling a trigger in step S4 of FIG. 28. As illustrated in FIG. 30, in step S50, the CPU 201 accesses the velocity register 292 and acquires the counter value of the velocity register 292, i.e., the sliding velocity v0, followed by resetting the velocity register 292. In step S51, the CPU 201 proceeds to step S53 if the sign of the sliding velocity v0 is positive, or proceeds to step S52 if the sign of the sliding velocity v0 is negative. In step S53, the CPU 201 assigns the sliding velocity v0 to the variable V0 (the sliding speed). On the other hand, in step S52, the CPU 201 gets the absolute value |v0| of the sliding velocity v0, which is a negative value, and assigns it to the variable V0 (the sliding speed).

In step S54, the CPU 201 determines whether or not the sliding speed V0 of the sliding operation piece 40 exceeds a predetermined maximum value MAX. If the sliding speed V0 exceeds the predetermined maximum value MAX, the process proceeds to step S55, in which the maximum value MAX is assigned to the sliding speed V0, and then proceeds to step S56. Conversely, if the sliding speed V0 falls below the predetermined maximum value MAX, the process proceeds to step S56 as it is.

In step S56, the CPU 201 determines whether or not the sliding speed V0 exceeds a predetermined threshold value ThV. If the sliding speed V0 exceeds the predetermined threshold value ThV, the process proceeds to step S57, otherwise proceeds to step S63.

In step S57, the CPU 201 determines whether or not the sliding direction of the sliding operation piece 40 is changed with reference to the sliding velocity v0 and a direction flag. This direction flag is a flag indicative of the sliding direction of the sliding operation piece 40, and updated with a delay as described below. For example, while the direction flag is reset to “00” as an initial value, the direction flag is set to “01” when the pulse signals A and B indicates the state transition in the clockwise direction as illustrated in FIG. 20 (corresponding to FIG. 19(a)) and set to “10” when the pulse signals A and B indicates the state transition in the counter clockwise direction (corresponding to FIG. 19(a)). On the other hand, the current sliding direction of the sliding operation piece 40 is immediately reflected to the sign of the sliding velocity v0, which is obtained in step S50. Accordingly, the change in the sliding direction is detected when the sign of the sliding velocity v0 is positive and at the same time the direction flag is “10” or when the sign of the sliding velocity v0 is negative and at the same time the direction flag is “01”. Incidentally, just after startup, the change in the sliding direction is detected when the sliding velocity v0 is not zero (i.e., positive or negative) since the direction flag is initialized to be “00”. If the sliding direction of the sliding operation piece 40 is changed, the process proceeds to step S58, otherwise the process returns to the main routine.

Then, in step S58, the CPU 201 updates the direction flag. In step S59, the CPU 201 turns on the sound output flag. Namely, since the requirements of generating a trigger (the sliding speed V0 exceeding the threshold value ThV and the change in the sliding direction) are satisfied, the CPU 201 generates a trigger by turning the sound output flag on.

In step S60, the CPU 201 checks the sound outputting flag. For example, the sound outputting flag is set to “00” when sound is not outputting, “01” when sound is outputting through the channels CH0 and CH1, “10” when sound is outputting through the channels CH2 and CH3. The sound outputting flag is recognized to be turned off if set to “00”, and recognized to be turned on if set to “01” or “10”. In step S60, the process proceeds to step S62 if the sound outputting flag is turned off, and proceeds to step S61 if the sound outputting flag is turned on. In step S61, the CPU 201 turns on a hardware release flag. This is because a trigger is generated anew during sound output.

Incidentally, the hardware release is performed by the sound processor 203 which generates and uses the envelope data for deadening sound (decreasing the sound). Alternatively, software release can be used instead of the hardware release. The software release is invoked by the CPU 201 and performed by giving the sound processor 203 the envelope data used for deadening sound, and having the sound processor 203 perform the deadening of sound (decreasing the sound).

In step S62, the CPU 201 increments a trigger counter Ctg and returns to the main routine.

On the other hand, in step S63, the CPU 201 determines whether or not the sliding speed V0 of the sliding operation piece 40 is “0”. If the sliding speed V0 is “0”, the process proceeds to step S64, and if the sliding speed V0 is not “0”, the process proceeds to step S68. In step S64, the CPU 201 increments the release counter Crl. In step S65, the CPU 201 determines whether or not the release counter Crl reaches a constant value k. If the release counter Crl reaches the constant value k, the process proceeds to step S66, and if the release counter Crl does not reach the constant value k, the process returns to the main routine. In step S66, the CPU 201 resets the release counter Crl to “0”. In step S67, the CPU 201 sets the hardware release flag on. On the other hand, in step S68, the CPU 201 resets the release counter Crl to “0”, and returns to the main routine.

In this case, the process in steps S63 to S68 is a process of performing hardware release when the sliding speed V0 is successively detected to be “0” for k times. For example, k=4. This process is introduced for the purpose of avoiding the detection of the stopping of the sliding operation piece 40 despite the intention of the operator. When the sliding operation piece 40 is slowly slid, the sliding speed V0 may unintentionally be “0” at a time since the operator is human. However, it would be against the intention of the operator if the sliding operation piece 40 is recognized to be stopped in such a situation. Because of this, the stopping of the sliding operation piece 40 is recognized only after repeatedly detecting the sliding speed V0 of “0”.

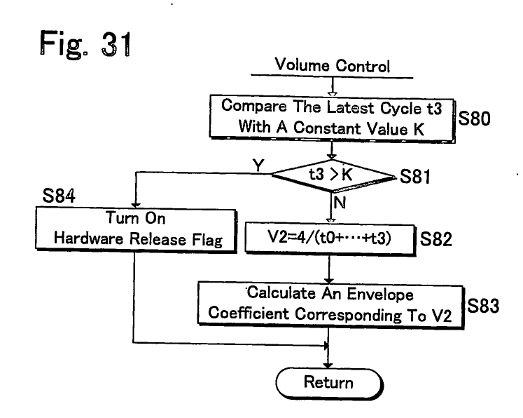

FIG. 31 is a flowchart showing an example of the procedure for controlling the sound volume in step S5 of FIG. 28. In the case of the example as shown in FIG. 31, it is assumed that the number of samples processed by the CPU 201 is “4”. In step S80, the CPU 201 compares the latest cycle t3 as output from the phototransistor 34 of the detection unit 30 with the constant value K. Then, in step S81, if the latest cycle t3 exceeds the constant value K in step S81, the process proceeds to step S84, and if the latest cycle t3 does not exceed the constant value K in step S81, the process proceeds to step S82.

In step S82, the CPU 201 calculates the reciprocal number of the average value of the four pulse cycles t0 to t3 as the sliding speed V2. In step S83, the CPU 201 calculates an envelope coefficient corresponding to the sliding speed V2. Namely, the CPU 201 calculates a larger envelope coefficient with a larger sliding speed V2 and a smaller envelope coefficient with a smaller sliding speed V2. For example, the envelope coefficient is calculated as V2/constant. By this configuration, it is possible by setting the envelope coefficient corresponding to the sliding speed V2 to tune up the sound volume if the sliding speed V2 increases and tune down the sound volume if the sliding speed V2 decreases. Furthermore, the sound volume can be controlled to continuously vary in accordance with the sliding speed V2.

On the other hand, in step S84, the CPU 201 sets the hardware release flag on. In this case, the process in steps S81 and S84 is a process of performing hardware release when the latest pulse cycle t3 is larger than the constant value K, i.e., when the sliding speed (1/t3) based only on the latest pulse cycle t3 is smaller than the constant value (1/K). Alternatively, software release can be used instead of the hardware release.

In this case, the process in steps S80, S81 and S84 is a process of detecting the stopping of the sliding operation piece 40 in agreement with the intention of the operator. In other words, the process is a process of handling the stopping of the sliding operation piece 40 in accordance with the intention of the operator to have the sound output gradually decrease and come to a halt by gradually decreasing the sliding speed.

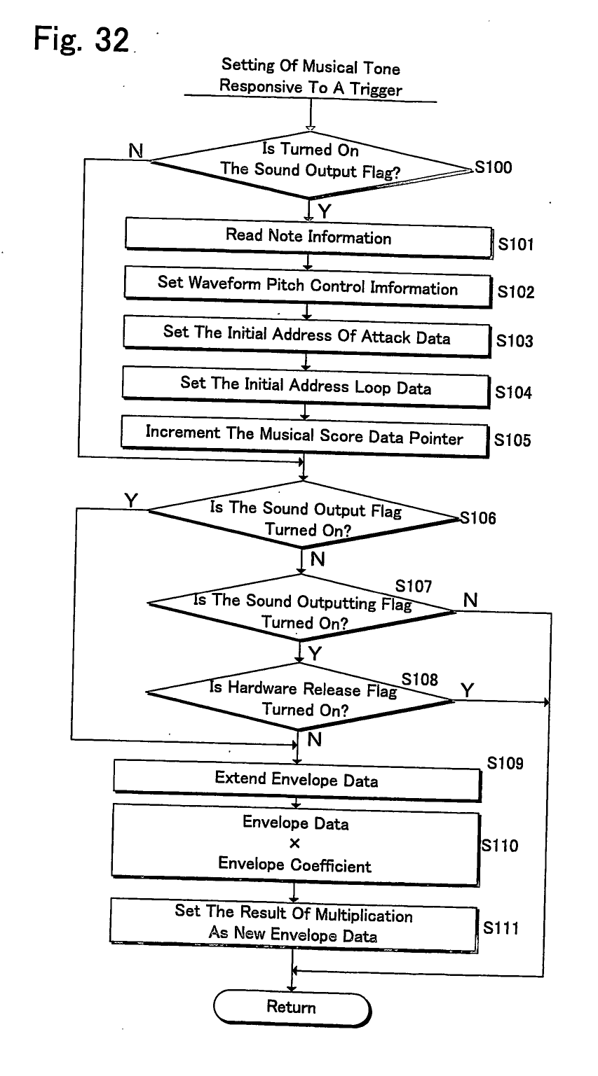

FIG. 32 is a flowchart showing one example of the procedure for setting musical tone in step S6 of FIG. 28. As illustrated in FIG. 32, in accordance with the on/off state of the sound output flag (whether or not a trigger generates), in step S100, the CPU 201 proceeds to step S107 if the sound output flag is turned off and proceeds to step S101 if the sound output flag is turned on (a trigger is generated). In step S101, the CPU 201 reads note information (note number and instrument designation information) from the musical score data with reference to the musical score data pointer for trigger sound output. In step S102, the CPU 201 stores the waveform pitch control information corresponding to the note number as read in the data area for musical tones of the inner memory 207. In this case, the waveform pitch control information is read from the table prepared in the ROM 300, in which the note number (the pitch information) are listed in association with the waveform pitch control information.

In step S103, the CPU 201 stores, in the data area for musical tones of the inner memory 207, the initial address of the attack data of the waveform data corresponding to the note information as read. In step S104, the CPU 201 stores, in the data area for musical tones of the inner memory 207, the initial address of the loop data of the waveform data corresponding to the note information as read. In step S105, the CPU 201 increments the musical score data pointer for trigger sound output.

In step S106, the CPU 201 checks the sound output flag and proceeds to step S109 if turned on, otherwise proceeds to step S107.

In step S107, after confirming whether or not the sound outputting flag is turned on, the CPU 201 returns to the main routine if turned off and proceeds to step S108 if turned on. In step S108, after confirming whether or not the state of the hardware release flag is turned on, the CPU 201 returns to the main routine if turned on. Conversely, the hardware release flag is turned off, the process proceeds to step S109.

In step S109, the CPU 201 reads the envelope data compressed and stored in the ROM 300, and extended in the inner memory 207. Furthermore, the CPU 201 stores the envelope pitch control information in the data area for musical tones of the inner memory 207. Incidentally, in step S109, the CPU 201 reads the envelope data corresponding to the waveform data associated with the note information read in step S101.

In step S110, the CPU 201 multiplies the extended envelope data by the envelope coefficient as calculated in step S83 of FIG. 31. In step S111, the CPU 201 stores the result of multiplication in step S110 in the data area for musical tones of the inner memory 207 as new envelope data. The sound volume is controlled by adjusting the envelope data with reference to the envelope coefficient corresponding to the sliding speed V2.

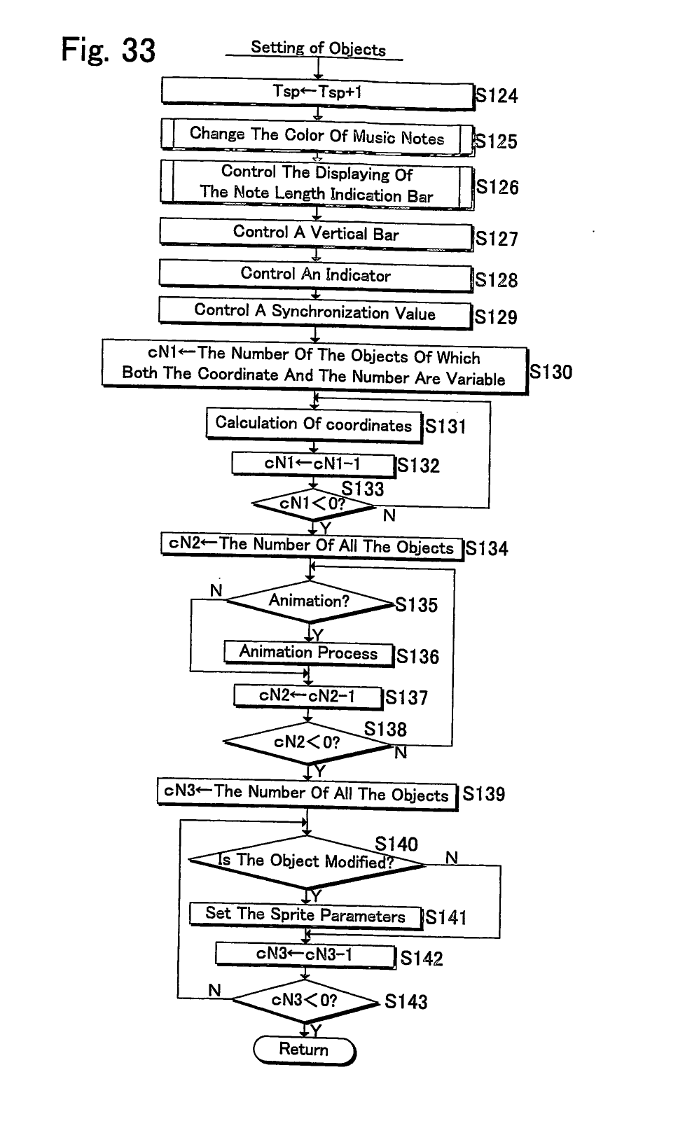

FIG. 33 is a flowchart showing one example of the procedure for setting objects in step S7 of FIG. 28. As illustrated in FIG. 33, in step S124, the CPU 201 increments a counter Tsp indicative of the time period elapsed from the start to the current time point. In step S125, the CPU 201 change, in response to the generation of a trigger, the color palette information of the corresponding musical notation mark n in order to change the color of the musical notation mark n. In step S126, the CPU 201 controls the displaying of the note length indication bar 100

In step S127, the CPU 201 controls the vertical bar 104 representing the current operation position. More specifically speaking, the process is as follows. In the case of the present embodiment, for example, it is assumed that the vertical bar 104 consists of a sprite consisting of 16×16 pixels. On the other hand, the position xvb of the vertical bar 104 relative to the left edge of the indicator is calculated by xvb=(Tns/Tse)×Lin, where Tns is the time period between the start code (see FIG. 25) and the note number of the musical notation mark n corresponding to the sound output by the latest trigger, Tse is the time period between the start code and the “End Code”, and Lin is the number of pixels corresponding to the entire length of the indicator 103. In this case, the x coordinate of the vertical bar 104 is calculated as (x1+xvb), and the y-coordinate as y1 which is a constant value, where x1 is the x coordinate of the left edge of the indicator 103. The default position is set as x=x1 and y=y1. The x coordinate of the vertical bar 104 is updated every time a trigger is generated as described above in order to inform the operator of the current operation position.

In step S128, the CPU 201 controls the indicator 103. More specific description is as follows. The indicator 103 consists of a plurality of belt objects. For example, in the case of the present embodiment, a belt object consists of one sprite consisting of 16×16 pixels. There are 17 types of the belt objects. The first belt object is composed of a transparent sprite, the second a sprite representing a belt having one pixel length, the third a sprite representing a belt having a two pixel length, . . . , and the 17th a sprite representing a belt having a 16 pixel length. The belt objects are available in pixel units. The length of the indicator 103 in the horizontal direction is, for example, 96 pixels, i.e., corresponding to 6 belt objects.

The CPU 201 calculates xin=(Tsp/Tse)/Lin by the use of the time Tsp from the start to the current time, the time Tse of the entire music and the number Lin of pixels corresponding to the entire length of the indicator 103. Furthermore, the CPU 201 calculates the quotient A and the remainder B of xin/16. The CPU 201 selects six belt objects to be displayed corresponding to the quotient A and the remainder B. Then, the CPU 201 determines the x coordinate and the y coordinate of each of the belt objects as selected. For example, if the quotient A=2 and the remainder B=4, two 17th belt objects, one fifth belt object and three first belt objects are selected followed by setting the x coordinate and the y coordinate of each belt object.

In step S129, the CPU 201 handles the synchronization value 99. More specifically speaking, the process is as follows. There are provided 10 numeral objects corresponding to “0” to “9”. Each numeral object consists of a sprite consisting of 16×16 pixels. The CPU 201 calculates the displacement Dif in accordance with Dif=|Tsp−Tns| where Tns is the time period between the start code (see FIG. 25) and the note number of the musical notation mark n corresponding to the sound output by the latest trigger, Tsp is the time period from the start to the current time.

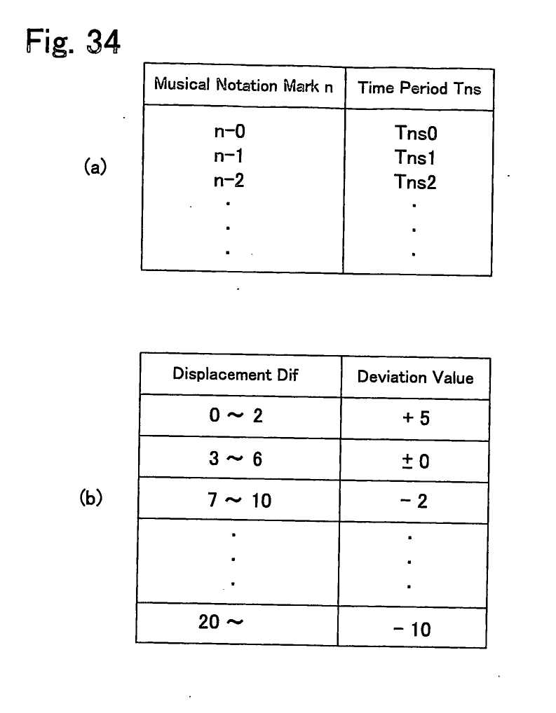

Then, the CPU 201 acquires a deviation value (FIG. 34(b) to be hereinafter described) corresponding to the displacement Dif and adds it to the current synchronization value 99. The CPU 201 selects the numeral objects corresponding to this result of the addition and sets the x coordinates and the y coordinates thereof. For example, if the result of the addition is “89”, one numeral object indicating “0”, one numeral object indicating “8” and one numeral object indicating “9” are selected followed by setting the x coordinates and the y coordinates of the respective numeral objects. In this case, the coordinates of the numeral object indicating “0” are set in the position outside the screen 82.

FIG. 34(a) is a view showing an example of the table of the time period Tns between the start code and the musical notation mark n in association with the respective musical notation mark n, and FIG. 34(b) is a view showing an example of the table of the deviation value of the synchronization value 99 in association with the respective displacement Dif. The CPU 201 acquires the time period Tns associated with the musical notation mark n corresponding to the sound output by the latest trigger from the table of FIG. 34(a), and calculates the above displacement Dif. The CPU 201 then acquires the deviation value corresponding to the displacement Dif from the table of FIG. 34(b) and adds it to the current synchronization value 99 as described above.

In step S130, the CPU 201 sets the number of the objects, of which both the coordinate and the number are variable, to the counter cN1. In the case of the present embodiment, the objects of which both the coordinate and the number are variable are the musical notation mark n and the bar objects constituting the note length indication bar 100. For example, the number of the musical notation marks n is “40”, and the number of the bar objects constituting the note length indication bar 100 is “40”. Then, “80” is set to the counter cN1.

In step S131, the CPU 201 performs calculation as Vx=Vx+Ax, Vy=Vy+Ay, x=x+Vx, and y=y+Vy, where Vx is the velocity of the current object in the horizontal direction, Ax is the acceleration of the current object in the horizontal direction, Vy is the velocity of the current object in the vertical direction, Ay is the acceleration of the current object in the vertical direction, x is the coordinate of the current object in the horizontal direction and y is the coordinate of the current object in the vertical direction.

In the case of the present embodiment, for example, one musical notation mark n consists of a sprite consisting of 16×16 pixels. Also, the note length indication bar 100 consists of one or more bar object. For example, in the case of the present embodiment, this bar object consists of one sprite consisting of 16×16 pixels. Incidentally, there are 9 types of the bar objects. The first bar object is composed of a transparent sprite, the second a sprite representing a bar having two pixel length, the third a sprite representing a bar having a four pixel length, . . . , and the ninth a sprite representing a bar having a 16 pixel length. The bar objects are available in units of two pixels. This is because the speed of the musical notation mark n and the speed of the note length indication bar 100 are two pixels per frame in the case of the present embodiment as described later.

In the case of the musical notation mark n as an object, the coordinates (x, y) of the musical notation mark n are calculated in step S131 with reference to the initial speed of Vx0 (the initial value of Vx), the initial coordinate x0 (the initial value of x) and the initial coordinate y0 (the initial value of y) which are set in the musical notation mark registration process to be hereinafter described. Incidentally, Vy=0 and Ax=Ay=0 in the case of the musical notation mark n. Vx0 is determined in accordance with the tempo of the music title. In the case of the present embodiment, for example, Vx0=2 pixels per frame. Also, Vx=Vy=0 and Ax=Ay=0 by default for the musical notation mark n while x and y are set in the position outside the screen 82.

In the case of the bar object constituting the note length indication bar 100, the coordinates (x, y) of the bar object are calculated in step S131 with reference to the initial speed of Vx0 (the initial value of Vx), the initial coordinate x0 (the initial value of x) and the initial coordinate y0 (the initial value of y) which are set in step S126. Incidentally, Vy=0 and Ax=Ay=0 in the case of the note length indication bar 100. Also, the initial coordinates x0 and y0 are same as the initial coordinates x0 and y0 of the musical notation mark n. Furthermore, in the same manner as the musical notation mark n, x and y are set in the position outside the screen 82 by default, while Vx=Vy=0 and Ax=Ay=0 by default.

In step S132, the CPU 201 decrements the counter cN1. In step S133, the CPU 201 determines whether or not the value of the counter cN1 is smaller than “0”. In other words, the CPU 201 determines whether or not the coordinate calculation in step S131 is completed for all the objects of which both the coordinate and the number are variable. If the value of the counter cN1 is no smaller than “0”, the coordinate calculation of all the objects are not completed and therefore the process proceeds to step S131. Conversely, if the value of the counter cN1 is smaller than “0”, the coordinate calculation of all the objects is completed and therefore the process proceeds to step S134.

In step S134, the CPU 201 sets the number of all the objects to be displayed to the counter cN2. In step S135, the CPU 201 determines whether or not the current object is to be animated. The process proceeds to step S136 if the object is to be animated, otherwise proceeds to step S137. In step S136, the animation process of the object is performed. More specifically speaking, the storage location information of the pixel pattern designation information of the object to be displayed in the next frame is stored in the inner memory 207.

For example, the six belt objects constituting the indicator 103 are animated by storing in the inner memory 207 the storage location information of the pixel pattern designation information of the respective six belt objects to be displayed in the next frame. Also, for example, the three numeral objects constituting the synchronization value 99 are animated by storing in the inner memory 207 the storage location information of the pixel pattern designation information of the respective three numeral objects to be displayed in the next frame.

In step S137, the CPU 201 decrements the counter cN2. In step S138, the CPU 201 determines whether or not the value of the counter cN2 is smaller than “0”. In other words, the CPU 201 determines whether or not the process in step S135 is completed for all the objects. The process proceeds to step S139 if the value of the counter cN2 is smaller than “0”, and proceeds to step S135 if the value of the counter cN2 is no smaller than “0”.

The results in steps S125 to S129, step S131 and step S136 are stored in the object data area of the inner memory 207.

In step S139, the CPU 201 sets the number of all the objects to be displayed to the counter cN3. In step S140, the CPU 201 determines whether or not the object is modified. The process proceeds to step S141 if the object is modified, otherwise proceeds to step S142. If at least one of the depth value, the color palette information, the storage location information of the pixel pattern designation information, the vertical coordinate and the vertical coordinate is modified, it is recognized that the object is modified. Needless to say, it is recognized that the respective objects are modified just after the object related information of the respective objects is stored in the inner memory 207 in step S37 of FIG. 29.

In step S141, the CPU 201 updates the sprite parameters (depth value, color palette information, the storage location information of pixel pattern designation information, vertical coordinate and vertical coordinate) of the modified object. However, only the updated sprite parameters are rewritten.

For example, when the coordinates of an object is modified, the CPU 201 calculates the horizontal coordinate and the vertical coordinate of each sprite constituting the object with reference to the horizontal coordinate and the vertical coordinate of the object, and then rewrites the coordinate information thereof. Incidentally, in the case where an object is composed only of one sprite, the horizontal coordinate and the vertical coordinate of the object are used as the horizontal coordinate and the vertical coordinate of the sprite.

Also, for example, when the color palette information of an object is modified, the CPU 201 updates the color palette information of each sprite constituting the object. Incidentally, in the case where an object is composed only of one sprite, the color palette information of the object is used as the color palette information of the sprite.

Furthermore, for example, when the storage location information of the pixel pattern designation information of an object is modified, the CPU 201 calculates the storage location information of the pixel pattern designation information of each sprite constituting the object with reference to the storage location information of the pixel pattern designation information of the object, and then rewrites the storage location information thereof. In this case, since the size of the sprite is known, it is easy to calculate the storage location information of the pixel pattern designation information of each sprite with reference to the storage location information of the pixel pattern designation information of the object. Also, in the case where an object is composed only of one sprite, the storage location information of the pixel pattern designation information of the object is used as the storage location information of the pixel pattern designation information of the sprite.

In step S142, the CPU 201 decrements the counter cN3. In step S143, the CPU 201 determines whether or not the value of the counter cN3 is smaller than “0”s. In other words, the CPU 201 determines whether or not the process in step S140 is completed for all the objects. The process proceeds to step S140 if the value of the counter cN3 is no smaller than “0”, and returns to the main routine if the value of the counter cN3 is smaller than “0”.

At this time, the sprite parameters have been stored in the sprite data area of the inner memory 207. Returning to FIG. 28, in step S9, the CPU 201 gives the graphic processor 202 the sprite parameters stored in the sprite data area. Also, in step S9, the graphic processor 202 reads the background related information (refer to step S37 of FIG. 29) from the background data area of the inner memory 207. Then, the graphic processor 202 generates the image signal VD on the basis of the information.

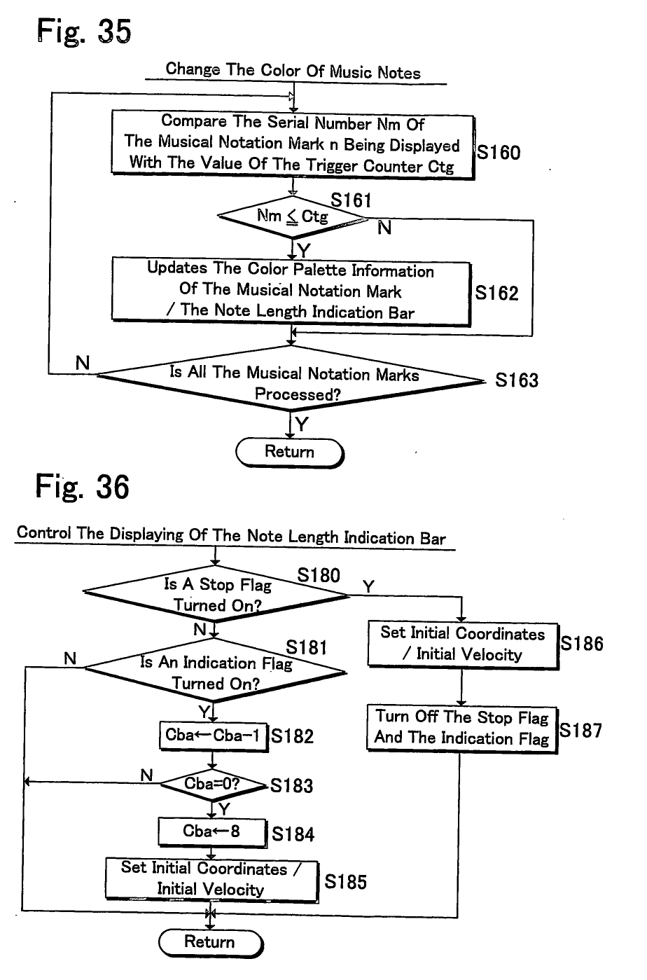

FIG. 35 is a flowchart showing one example of the procedure of modifying the colors of musical notation marks in step S125 of FIG. 33. As illustrated in FIG. 35, in step S160, the CPU 201 compares the serial number Nm of the musical notation mark n being displayed on the television monitor 80 with the value of the trigger counter Ctg. The process proceeds to step S162 if the serial number Nm of the musical notation mark n being displayed is no larger than the value of the trigger counter Ctg, otherwise proceeds to step S163.

In step S162, the CPU 201 updates the color palette information of the musical notation mark n corresponding to the serial number Nm and the color palette information of the note length indication bar 100 associated with the musical notation mark n. In step S163, the CPU 201 determines whether or not the process in steps S160 to S162 is completed for all the musical notation marks n being displayed. If not completed, the process proceeds to step S160, otherwise proceeds to step S126 of FIG. 33. As described above, while the musical notation mark n corresponding to each of the musical tones having been output in response to a trigger is changed, the color of the note length indication bar 100 associated with that musical notation mark n is also changed.

FIG. 36 is a flowchart showing one example of the procedure of controlling the display of the note length indication bar in step S126 of FIG. 33. As illustrated in FIG. 36, in step S180, the CPU 201 determines whether or not the stop flag of the note length indication bar 100 is turned on. The process proceeds to step S186 if turned on, otherwise proceeds to step S181. Meanwhile, this stop flag is turned on when “Note Off” is read out from the musical score data for registering musical notation marks as described later.

In step S181, the CPU 201 determines whether or not the indication flag of the note length indication bar 100 is turned on. The process proceeds to step S182 if turned on, otherwise proceeds to step S127 of FIG. 33. Incidentally, this indication flag is turned on when “Note On” is read out from the musical score data for registering musical notation marks as described later. In step S182, the CPU 201 decrements a counter Cba. Incidentally, the counter Cba is set to “8” when “Note On” is read out from the musical score data for registering musical notation marks as described later. The reason why set to “8” will be explained in detail later.

In step S183, the CPU 201 determines whether or not the value of the counter Cba is “0”. The process proceeds to step S184 if the value of the counter Cba is “0”, otherwise proceeds to step S127 of FIG. 33

In step S184, the CPU 201 sets 8” to the counter Cba. As described above, the reason why set to “8” will be explained in detail later. In step S185, the CPU 201 sets the initial coordinates (x0 and y0) and the initial velocity Vx0 of a bar object (constituting a note length indication bar 100) which is not displayed and corresponding to the value of the counter Cba (in this case, Cba=8), and then the process proceeds to step S127 of FIG. 33.

On the other hand, in step S186, the CPU 201 sets the initial coordinates (x0 and y0) and the initial velocity Vx0 of a bar object (constituting a note length indication bar 100) which is not displayed and corresponding to the value of the counter Cba. In step S187, the CPU 201 turns off the stop flag and the indication flag, and proceeds to step S127 of FIG. 33.

Incidentally, the bar object corresponding to the value of the counter Cba is a bar object consisting of a sprite in the form of a bar having a pixel length of (Cba×2).

In this above example, a musical notation mark n consists of one sprite of 16×16 pixels and has a speed of two pixels per frame. Accordingly, eight frames after registering a musical notation mark n (after indication flag is turned on), the entirety of the musical notation mark n of 16×16 pixels is displayed on the screen 82. Incidentally, when a musical notation mark n is registered, the musical notation mark n is arranged in order to locate the left edge of the sprite of 16×16 pixels constituting the musical notation mark n in alignment with the right edge of the screen 82.

When the entirety of the musical notation mark n is displayed on the screen 82, the bar object must stand by just in the right hand side of the screen 82. In other words, the bar object is arranged in order to locate the left edge of the sprite of 16×16 pixels constituting the bar object in alignment with the right edge of the screen 82. As described above, in step S181, the process does not immediately proceed from step S181 to step S185 even if the indication flag is turned on but does proceed to step S185 only eight frames after the indication flag is turned on.

In step S185 as described above, the initial coordinates and the initial velocity are set to the bar object consisting of a sprite corresponding to a bar having a 16 pixel length. This is because, an appropriate note length indication bar 100 can be displayed by successively displaying the bar object having a 16 pixel length until the stop flag is turned on. On the other hand, in step S186 as described above, the initial coordinates and the initial velocity are set to the bar object corresponding to a bar having a pixel length of (Cba×2).

For example, if the value of the counter Cba is “4” when the stop flag is turned on, the initial coordinates and the initial velocity are set to the bar object corresponding to a bar having an eight pixel length. By providing such a step S186, it is possible to display the note length indication bar 100 such as the note length indication bar 100 associated with the musical notation mark n-1 of FIG. 14 and terminating in a rest notation (at the right end).

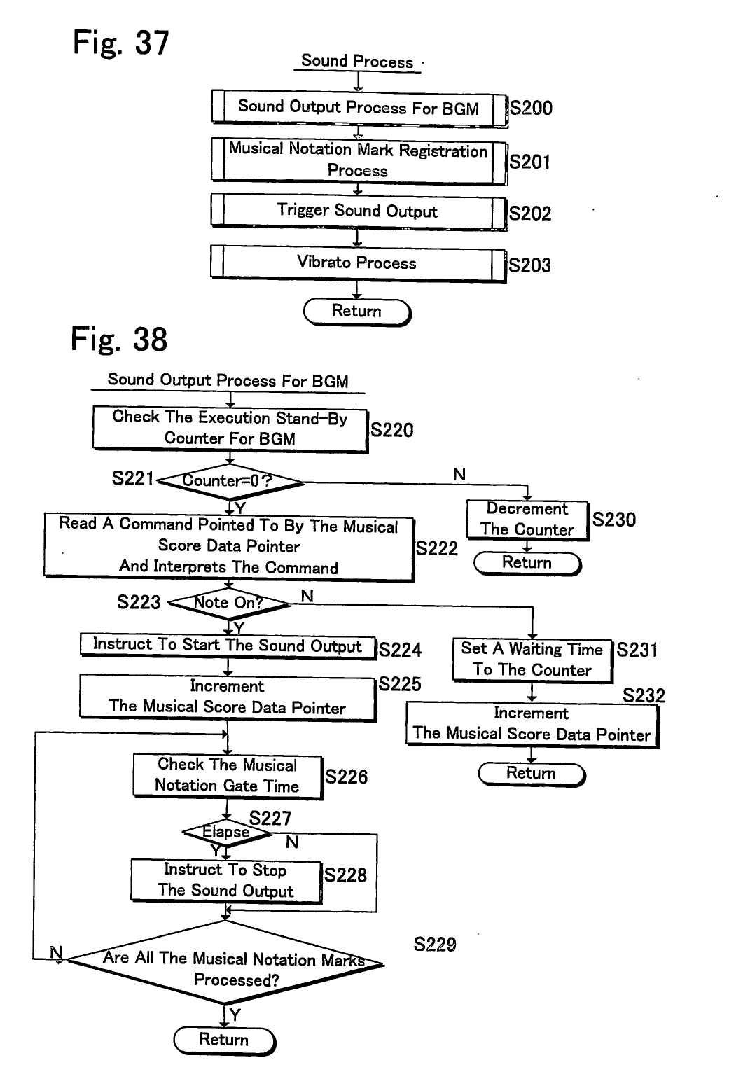

FIG. 37 is a flowchart showing one example of the procedure of sound processing in step S10 of FIG. 28. As illustrated in FIG. 37, the CPU 201 executes the sound output process for BGM in step S200. In step S201, the CPU 201 executes the process of registering the musical notation mark n. In step S202, the CPU 201 executes the sound output process as started in response to a trigger. In step S203, the CPU 201 executes the vibrato process when the vibrato switch 12e pushed down.

FIG. 38 is a flowchart showing, one example of the sound output process for BGM in step S200 of FIG. 37. As illustrated in FIG. 38, the CPU 201 checks the execution stand-by counter for BGM in step S220. The process proceeds to step S222 if the execution stand-by counter for BGM is “0”, otherwise proceeds to step S230 in which the execution stand-by counter is decremented followed by proceeding to step S201 of FIG. 37.

In step S222, the CPU 201 reads a command pointed to by the musical score data pointer for BGM and interprets the command. The process proceeds to step S224 if the command is “Note On”, otherwise (i.e., in the stand-by state) proceeds to step S231.

In step S224, the CPU 201 stores the waveform pitch control information, the initial address information of waveform data, the envelope pitch control information and the initial address information of envelope data in the data area for musical tones of the inner memory 207 in accordance with the note number and the instrument designation information pointed to by the musical score data pointer, and stores the channel volume information corresponding to the velocity information and the gate time information in the data area for musical tones. The CPU 201 then instructs the sound processor 203 to access the inner memory 207. In response to this, the sound processor 203 reads the above information as stored in the data area for musical tones of the inner memory 207 in the appropriate timing, and generates the audio signals AL and AR.

In step S225, the CPU 201 increments the musical score data pointer for BGM. In step S226, the CPU 201 checks the remaining time of the musical notation gate time. If the gate time elapses in step S227, the CPU 201 proceeds to step S228 and instructs the sound processor 203 to stop the sound output corresponding to the musical notation mark, and then proceeds step S229. On the other hand, if the gate time does not elapse in step S227, the process proceeds to step S229. In step S229, the CPU 201 determines whether or not the process in step S226 is completed for all the musical notation marks n being output, and if not completed the process proceeds to step S226 otherwise proceeds to step S201 of FIG. 37.

On the other hand, in step S231, the CPU 201 sets a waiting time to the execution stand-by counter for BGM. Then, in step S232, the CPU 201 increments the musical score data pointer for BGM, and proceeds to step S201 of FIG. 37.

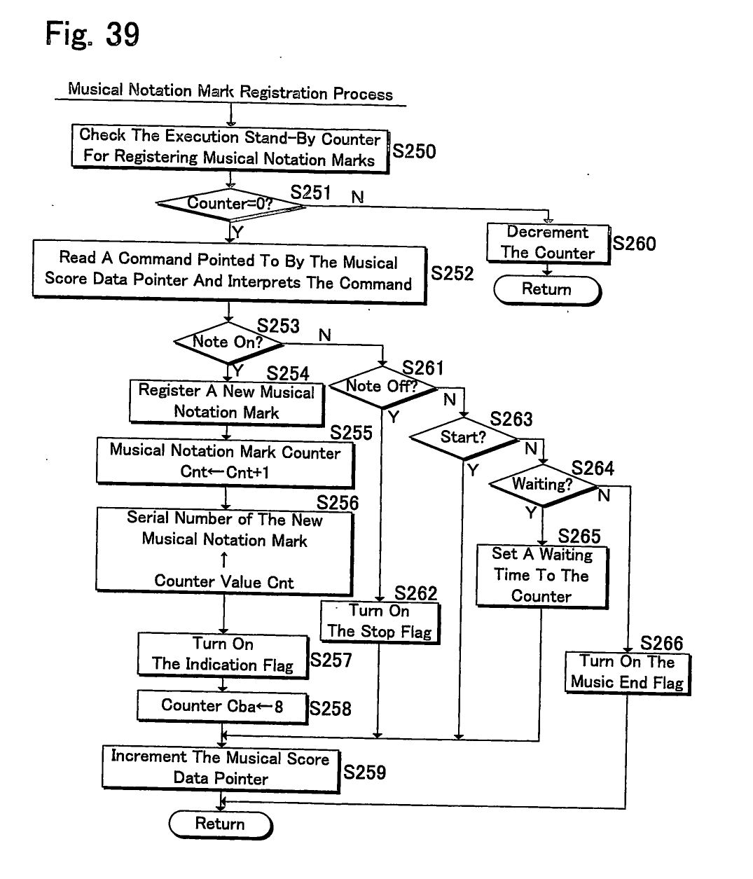

FIG. 39 is a flowchart showing one example of the musical notation mark registration process in step S201 of FIG. 37. As illustrated in FIG. 39, in step S250, the CPU 201 checks the execution stand-by counter for registering musical notation marks. The process proceeds to step S252 if the execution stand-by counter for registering musical notation marks is “0”, otherwise proceeds to step S263 in which the execution stand-by counter is decremented followed by proceeding to step S202 of FIG. 37.

In step S252, the CPU 201 reads a command pointed to by the musical score data pointer for registering musical notation marks and interprets the command. In step S253, the process proceeds to step S254 if the command is “Note On”, otherwise proceeds to step S264.

In step S254, the CPU 201 registers anew a musical notation mark n. More specifically speaking, the initial velocity Vx0 and the initial coordinates x0 and y0 of the new musical notation mark n are set. In step S255, the CPU 201 increments a musical notation mark counter Cnt. In step S256, the CPU 201 sets the value of the music-al notation mark counter Cnt to the serial number of the new musical notation mark.

In step S257, the CPU 201 turns on the indication flag of the note length indication bar 100. In step S258, the CPU 201 assigns “8” to the counter Cba (refer to FIG. 36). This is because, 8 frames after registering a musical notation mark n, the entirety of the musical notation mark n of 16×16 pixels is displayed on the screen 82 as described above.

On the other hand, if the command designated by the musical score data pointer for registering musical notation marks is “Note off” in step S261, the CPU 201 proceeds to step S262 to turn on the stop flag of the note length indication bar 100, and then proceeds to step S259 If the command designated by the musical score data pointer for registering musical notation marks is not “Note Off”, the process proceeds to step S263. In step S263, the CPU 201 proceeds to step S259 if the musical score data pointer for registering musical notation marks points to the command start code, otherwise proceeds to step S264.

In step S264, if the musical score data pointer for registering musical notation marks points to the command “Stand-by”, the CPU 201 proceeds to step S265 to set a waiting time to the execution stand-by counter, and then proceeds to step S259. Conversely, if the musical score data pointer for registering musical notation marks does not point to the command “Stand-by”, i.e., does point to the “End Code”, the CPU 201 proceeds to step S266 to turn on the music end flag, and then proceeds to step S202.

On the other hand, in step S259, the CPU 201 increments the musical score data pointer for registering musical notation marks, and proceeds to step S202 of FIG. 37.

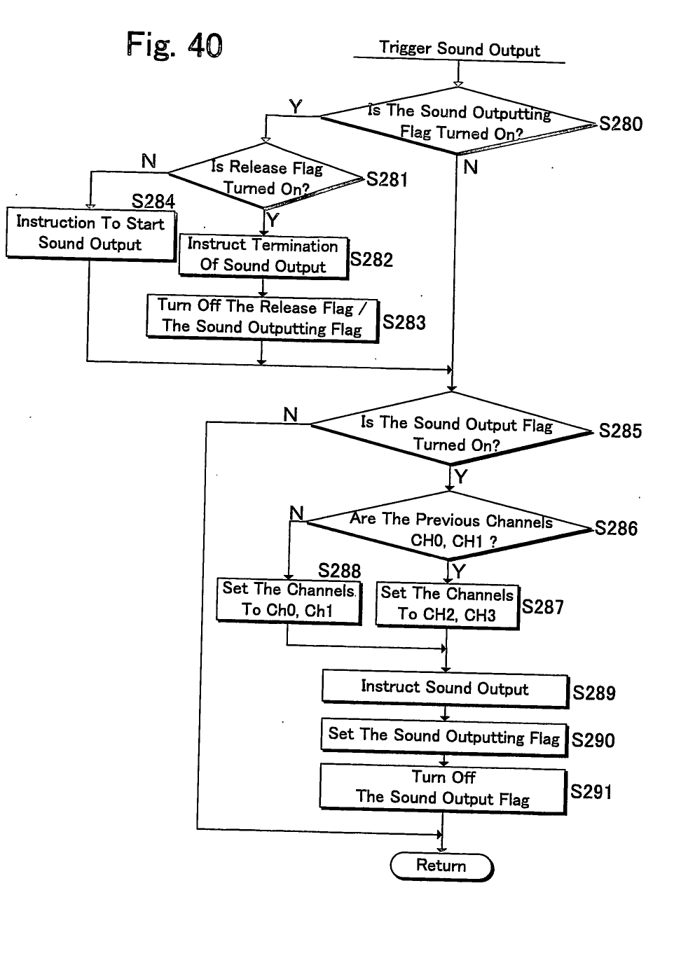

FIG. 40 is a flow chart showing an example of the process flow in the sound output as started in response to a trigger in step S202 of FIG. 37. As illustrated in FIG. 40, in step S280, the CPU 201 checks the sound outputting flag and, if turned off, the process proceeds to step S285 otherwise proceeds to step S281. In step S281, the CPU 201 checks the hardware release flag and, if turned off, the process proceeds to step S284 otherwise proceeds to step S282.

In step S282, the CPU 201 instructs the sound processor 203 to terminate the sound output in the current channels as started in response to a trigger. The channels which are currently used for sound output can be known by the value of the sound outputting flag. In step S283, the CPU 201 turns off the hardware release flag and the sound outputting flag, and proceeds to step S285.

On the other hand, in step S284, the CPU 201 instructs the sound processor 203 to access the inner memory 207 (the data area for musical tones corresponding to the channels which are currently used for sound output). Then, the sound processor 203 reads the musical tone related information (the initial address information of waveform data, waveform pitch control information, envelope data and envelope pitch control information) stored in step S6 of FIG. 28 from the inner memory 207 in the appropriate timing, and generates the audio signals AL and AR on the basis of the musical tone related information.

In step S285, the CPU 201 checks the sound output flag and proceeds to step S203 of FIG. 37 if turned off, otherwise proceeds to step S286. In step S286, the CPU 201 checks the channels which are currently used for sound output with reference to the sound outputting flag, and the process proceeds to step S287 if the current channels are the channels CH0 and CH1, and proceeds to step S288 if the current channels are the channels CH2 and CH3.

In step S287, the CPU 201 switches the channels for sound output from the channels CH0 and CH1 to the channels CH2 and CH3. On the other hand, in step S288, the CPU 201 switches the channels for sound output from the channels CH2 and CH3 to the channels CH0 and CH1.

In step S289, the CPU 201 instructs the sound processor 203 to access the inner memory 207 (the data area for musical tones corresponding to the channels which are set anew). Then, the sound processor 203 reads the musical tone related information stored in step S6 of FIG. 28 from the inner memory 207 in the appropriate timing, and generates the audio signals AL and AR on the basis of the musical tone related information.

In step S290, the CPU 201 sets the sound outputting flag in accordance with the channels as set in step S287 or step S288. In step S291, the CPU 201 turns off the sound output flag.

The channels for sound output are switched for each trigger (i.e., every time the sound output flag is turned on) in this manner for the purpose of preventing the sound output of the current musical note from terminating due to the sound output of the next musical note. For example, if all the musical notes for trigger sound output share the same channels, when the next trigger is generated during the sound output of the previous musical note, the sound output for tie next trigger has to be initiated after terminating the sound output of the previous musical note so that the sound output might be interrupted to be offensive to the ear. Incidentally, the two channels CH0 and CH1 or CH2 and CH3 are used for each trigger sound output in this manner for the purpose of increasing the sound volume.

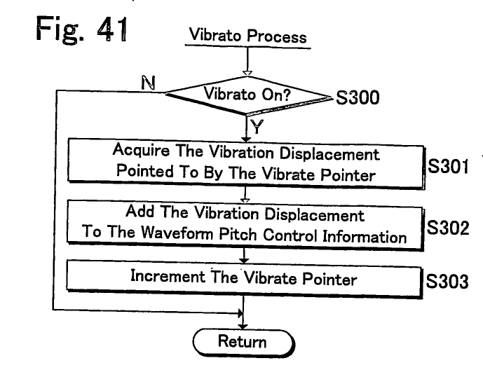

FIG. 41 is a flowchart showing one example of the vibrato process in step S203 of FIG. 37. As illustrated in FIG. 41, in step S300 the CPU 201 determines whether or not the vibrato switch 12e is turned on and, if turned on, the process proceeds to step S301 otherwise returns to the main routine.

In step S301, the CPU 201 acquires the vibration displacement pointed to by the vibrate pointer from a vibrate table as mentioned later. In step S302, the CPU 201 adds the vibration displacement to the waveform pitch control information as stored in the data area for musical tones corresponding to the current channels in which sound is output in response to a trigger. In step S303, the CPU 201 increments the vibrate pointer and then returns to the main routine.

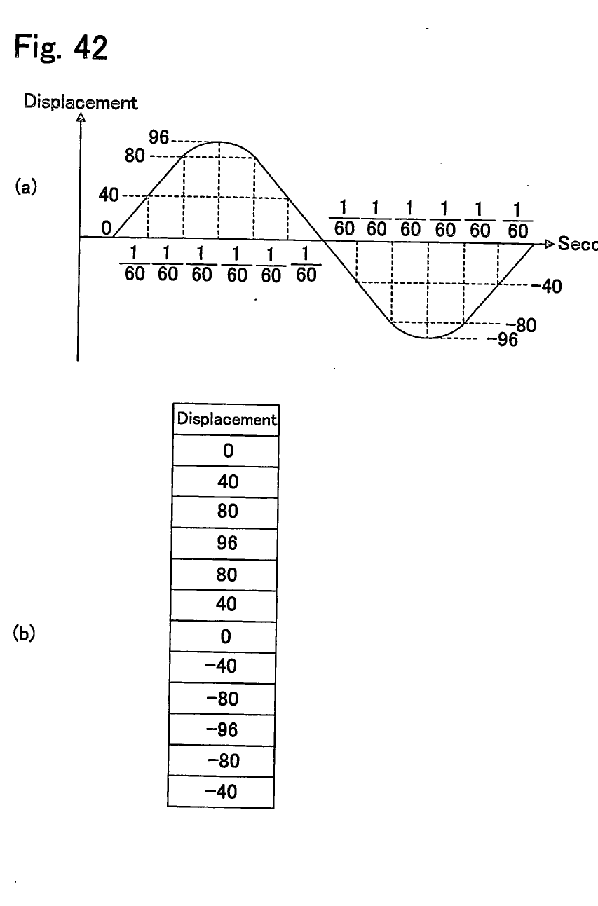

FIG. 42(a) is a view for explaining the vibrate effects, and FIG. 42(b) is a view showing an example of the vibrate table containing the vibration displacements for performing the vibrate process. As illustrated in FIG. 42(a), in the case of the present embodiment, the vibration displacement is given as a sinusoidal waveform. Meanwhile, in step S301 as described above, the vibration displacement is acquired with reference to the vibrate table of FIG. 42(b).

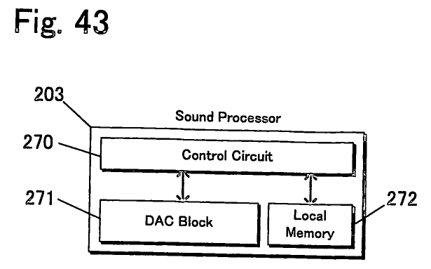

In what follows, the sound processor 203 will be explained in detail. FIG. 43 is a block diagram showing the sound processor 203 of FIG. 17. As illustrated in FIG. 43, the sound processor 203 includes a control circuit 270, a DAC block 271 and a local memory 272.

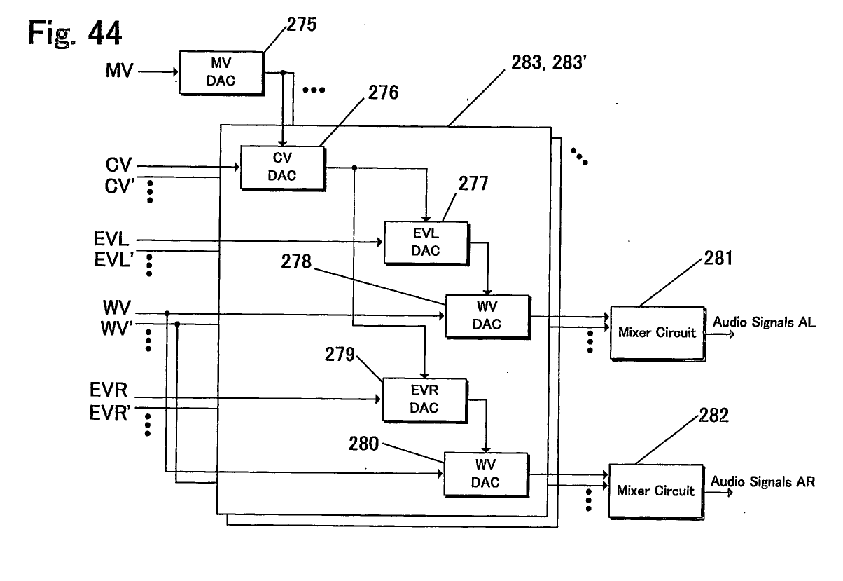

FIG. 44 is a block diagram showing the DAC block 271 of FIG. 43. As illustrated in FIG. 44, the DAC block 271 includes a main volume DAC (MV DAC) 275, M channel blocks (M is a positive integer) 283, 283′, . . , and mixer circuits 281 and 282. In this case, if each of the channel blocks 283, 283′, . . is capable of processing signals of N channels (N is two or more integer), the DAC block 271 of FIG. 43 can handle M×N channels. For example, if M=4 and N=4, it is possible to handle 16 channels. Each of the channel blocks 283, 283′, . . . includes a channel volume DAC (CV DAC) 276, an envelope (L) DAC (EVL DAC) 277, an envelope (R) DAC (EVR DAC) 279, a waveform DAC (WV DAC) 278, and a waveform data DAC (WV DAC) 280. In the following description, the term “channel blocks 2830” is used to generally represent the channel blocks 283, 283′, . . .

As illustrated in FIG. 44, the MV DAC 275, the CV DAC 276, the EVL DAC 277 and the WV DAC 278 are cascade connected. Also, the MV DAC 275, the CV DAC 276, the EVR DAC 279 and the WV DAC 280 are cascade connected in the same manner. As described above, analog multiplier circuits are formed with the plurality of these DACs (D/A converters: Digital-to-Analog Converters) as cascade connected.

The MV DAC 275 receives main volume data MV from the control circuit 203 for controlling the master volume of audio signals. The MV DAC 275 converts the input main volume data MV into analog signals, which is then output to the CV DAC 276.

The CV DAC 276 of the channel blocks 283, 283′, . . . receives channel volume data CV, CV′, . . , from the control circuit 270. Meanwhile, each of the channel volume data CV, CV′, . . , is prepared by time division multiplexing channel volume data in N channels (N is two or more integer). The channel volume data is the data used to control the volume of the corresponding channel. In the following description, the term “channel volume data CV0” is used to generally represent the channel volume data CV, CV′, . . . Incidentally, the channel volume data CV0 is a digital signal.

The CV DAC 2760 multiplies the channel volume data CV0 by the conversion signal (an analog signal) input from the MV DAC 275, and outputs the result of the multiplication (an analog signal) to the EVL DAC 277 and the EVR DAC 279.

Incidentally, the channel volume data is the data which is read from the inner memory 207 and stored in the local memory 272 by the control circuit 270 and based on the velocity information.

The EVL DAC 277 of the channel blocks 283, 283′, . . . receives envelope data EVL, EVL′, . . , from the control circuit 270. Each of the envelope data EVL, EVL′, . . , is prepared by time division multiplexing envelope data in N channels. The envelope data is the data used to control the envelope of the left channel of the corresponding channel. In the following description, the term “envelope data EVL0” is used to generally represent the envelope data EVL, EVL′, . . . Incidentally, the envelope data EVL0 is a digital signal.

The EVL DAC 277 multiplies the envelope data EVL0 by the conversion signal (an analog signal) input from the CV DAC 276, and outputs the result of the multiplication (an analog signal) to the WV DAC 278.

Incidentally, the envelope data is the data which is read from the inner memory 207 or the ROM 300 and stored in the local memory 272 by the control circuit 270. Accordingly, the control circuit 270 sequentially reads the envelope data from the local memory 272 while incrementing the address pointer on the basis of the envelope pitch control information, then multiplexes the envelope data and outputs the multiplexed data to the DAC block 271.

The WV DAC 278 of the channel blocks 283, 283′, receives the waveform data WV, WV′, . . . from the control circuit 270. Each of the waveform data WV, WV′, . . , is prepared by time division multiplexing waveform data in N channels. In the following description, the term “waveform data WV0” is used to generally represent the waveform data WV, WV′, . . . Incidentally, the waveform data WV0 is a digital signal.

The WV DAC 278 multiplies the waveform data WV0 by the conversion signal (an analog signal) input from the EVL DAC 277, and outputs the result of the multiplication (an analog signal) to the mixer circuit 281. The result of the multiplication is an analog audio signal.

Incidentally, the waveform data is the data read from the ROM 300 by the control circuit 270. In other words, the control circuit 270 reads the waveform data from the ROM 300 with reference to the initial address of the waveform data stored in the local memory 272, and stores the waveform data in the local memory 272. Then, the control circuit 270 sequentially reads the waveform data from the local memory 272 while incrementing the address pointer on the basis of the waveform pitch control information, then multiplexes the waveform data and outputs the multiplexed data to the WV DAC 278.

The mixer circuit 281 mixes the analog audio signals output respectively from the channel blocks 283, 283′, . . , and outputs the mixed signals to the left channel as the audio signal AL. In the same manner as the left channel audio signal AL is generated, a right channel audio signal AR is generated by the EVR DAC 279, the WV DAC 280 and the mixer circuit 282.

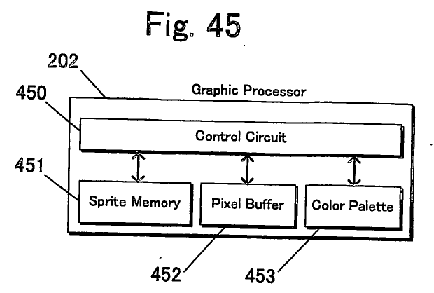

Next, the graphic processor 202 will be explained in detail. FIG. 45 is a block diagram showing the graphic processor 202 of FIG. 17. As illustrated in FIG. 45, the graphic processor 202 includes a control circuit 450, a sprite memory 451, a pixel buffer 452 and a color palette 453. The CPU 201 writes the horizontal coordinate, the vertical coordinate, the depth value, the size, the color palette information and the storage location information of the pixel pattern designation information of the sprite to be displayed to the sprite memory 451 of the graphic processor 202 during the vertical blanking period.

Then, the control circuit 450 writes the pixel pattern designation information and the depth value of the sprite to the pixel buffer 452 in accordance with the information stored in the sprite memory 451. For this purpose, the pixel pattern designation information is read out from the ROM 300 by the control circuit 450 with reference to the storage location information of the pixel pattern designation information stored in the sprite memory 451.

In this case, the control circuit 450 accesses the inner memory 207, reads the pixel pattern designation information of the respective blocks from the ROM 300 with reference to the storage location information of the pixel pattern designation information of the respective blocks constituting a background image, and reads the color palette information and the depth value of the respective blocks. Then, the pixel pattern designation information and the depth value of the background image are written to the pixel buffer 452.

Meanwhile, if a plurality of pixels overlap each other, the control circuit 450 writes only the pixel pattern designation information and the depth value of the sprite or the background image having the largest depth value to the pixel buffer 452.

In this case, the pixel buffer 452 is composed of a plurality of pixel buffer elements in a number smaller than 256 which is the number of the pixels constituting one line of the image (256×224 pixels) displayed on the screen 82. This pixel buffer element stores the depth value and the pixel pattern designation information of one pixel. Meanwhile, the depth value and the pixel pattern designation information of one pixel are generally referred to as pixel information as a whole.

More specifically speaking, the control circuit 450 sequentially stores the pixel information for each pixel in the pixel buffer 452 functioning as an FIFO ring buffer with indexing that wraps around to the beginning of the buffer so that the oldest data is overwritten by the latest data. In other words, when the scanning point is shifted, the control circuit 450 treats the tail of the storage location as the head of the storage location by virtually circulating the pixel buffer 452 as a ring buffer.

The control circuit 450 reads the pixel information from the pixel buffer 452 (by scanning the buffer), acquires the color information from the color palette 453 designated by the color palette information with reference to the pixel pattern designation information of the pixel information as read, and generates composite signals which are then output as the image signal VD.

Meanwhile, as described above, in accordance with the present embodiment, the operator can generate a trigger and control the sound volume during automatic performance by intuitive operation, for example, by changing the sliding direction (generating a trigger) or the sliding speed of the sliding operation piece 40 (changing the sound volume).

In this way, an operator with no particular musical knowledge and skill can add dynamics with tempo rubato by intuitive operations to music, which is automatically performed by the automatic musical instrument (computer), and therefore can enjoy individual automatic performance.

Also, when the sliding speed of the sliding operation piece 40 falls below the predetermined threshold value 1/K (refer to step S81 of FIG. 31), the termination process of the sound output of the latest trigger is invoked, while, when a trigger is generated anew, the termination process of the sound output of the previous trigger is invoked (refer to step S61 of FIG. 30).

Accordingly, there is the following advantage as compared with the case where a trigger is generated whenever the sliding speed of the sliding operation piece 40 exceeds the predetermined threshold value ThV while the sound output is terminated whenever the sliding speed of the sliding operation piece 40 falls below the predetermined threshold value 1/K.

If the operator quickly changes the sliding direction while moving the sliding operation piece 40 at a large sliding speed, it may not be detected that the sliding speed falls below the predetermined threshold value 1/K and therefore the termination process of sound output is not invoked, while the sliding speed detected just after the change exceeds the predetermined threshold value 1/K. In this case, there is a shortcoming that the sound output started responsive to a single trigger is unintentionally continued. The above shortcoming results in a substantial problem because the operation of quickly changing the sliding direction while moving the sliding operation piece 40 at a large sliding speed is often done.

The problem as described above can be avoided by handling the generation of a new trigger as a termination condition for terminating sound output started responsive to the previous trigger (in the case where the sliding speed exceeds the predetermined threshold value ThV and the sliding direction is changed after the previous trigger).

In this case, while the operator necessarily changes the sliding direction of the sliding operation piece 40, the change of the sliding direction can be perceived with ease and therefore it is recognized as an intuitive operation for the operator to change the sliding direction. Because of this, no restriction is imposed on the operation by the operator even if the change of the sliding direction is treated as a condition of detecting a trigger.

Furthermore, while a trigger is unintentionally generated for example by an involuntary small movement of a hand of the operator if a trigger is generated whenever the sliding direction of the sliding operation piece 40 is changed, this shortcoming can be avoided by adding another trigger generation requirement that the sliding speed exceeds the predetermined threshold value ThV.

The termination process of sound output does not mean that the sound output is stopped without delay, but does rather means that the sound output is gradually deadened (a hardware release process in the case of the present embodiment). Accordingly, there is a predetermined time (release time) before the sound output is completely stopped after starting the termination process.

Also, in the case of the present embodiment, the phototransistors 34 and 35 generate the pulse signal A and the pulse signal B with a phase difference depending upon the sliding direction of the sliding operation piece 40 for detecting the sliding direction of the sliding operation piece 40. Furthermore, the phototransistor 34 generates the pulse signal “a” at the frequency in proportion to the sliding speed of the sliding operation piece 40 for measuring the sliding speed of the sliding operation piece 40.

For this reason, it is possible to easily measure the sliding speed (refer to FIG. 22) only by measuring the frequency of the pulse signal “a” or a quantity derived therefrom (for example, the period of the cycle divided by m). Incidentally, a cycle which is the reciprocal of the frequency falls into the concept of frequency. Also, it is possible to easily detect the sliding direction (refer to FIG. 20) only by measuring the phase difference between the pulse signal A and the pulse signal B or a quantity derived therefrom (for example, the direction of the state transition of the pulse signals A and B).

Furthermore, since a signal is shared (the pulse signal A and the pulse signal “a” are the same signal) when evaluating the two trigger generation conditions (the sliding direction and the sliding speed) in this case, it is possible to implement the trigger handling process in a simple configuration.

Also, in the case of the present embodiment, the images 103 and 104 indicative of the current state of the automatic performance and the images n, 100, 101 and 102 indicative of the operation guide are displayed on the television monitor 80 (refer to FIG. 14). In this case, these images are displayed with the movement and color variation of objects.

Accordingly, the operator can intuitively recognize the current state of the automatic performance and the operation guide, and therefore can take control of the automatic performance with ease.

Also, it is possible to display the images indicative of the current state of the automatic performance and the image indicative of the operation guide only by connecting the main body 1 with the television monitor 80.

Furthermore, it is possible to dispense with an image display unit in the main body 1 for displaying these images and therefore realize an automatic musical instrument which is cheaper than that provided with an image display unit in the main body 1.

Still further, since these images are displayed on the television monitor 80 which is separately provided from the main body 1, the weight becomes lighter and therefore the operator can operate the sliding operation piece, while holding the main body 1, with ease as compared to the case where the main body 1 is implemented with a built-in image display unit.

Still further, since these images are displayed on the television monitor 80 which is separately provided from the main body 1, the operator can see these images, while holding the main body 1, with ease as compared to the case where the main body 1 is implemented with a built-in image display unit. In the case where the operator holds the main body 1 during sliding operation, it is difficult to maintain the visibility of these images if the main body 1 is implemented with a built-in image display unit.

Also, in the case of the present embodiment, the main body 1 is provided with the cartridge socket 23 into which is inserted a medium, the memory cartridge 29 in the above example, containing musical note data for automatic performance and image data for display.

Because of this, it is possible to enjoy a variety of music titles only by changing the memory cartridge 29. Incidentally, the medium can be used to store the control program in addition.

Also, in the case of the present embodiment, the guides 31 and 32 serves to form the bottleneck portion (narrowed portion) and broaden portions (gradually widen toward the opposite sides from the bottleneck portion) continued from the bottleneck portion by which the sliding operation is guided (refer to FIG. 4).

In accordance with this configuration, it is possible to enable the operator to easily perform the sliding operation of the sliding operation piece 40 making into contact with the sliding saddle member 33, as the primary function of the guides, and in addition to this, to increase the flexibility of the movement of the sliding operation piece 40, and therefore the operator can perform a variety of sliding operations. Also, since the sliding position of the sliding operation piece 40 is limited by the two guides 31 and 32, the operator can have the sliding operation piece 40 pass over the light emitting diode 36 and the phototransistors 34 and 35 without particular attention.

Furthermore, in the case of the present embodiment, the sliding saddle member 33 has a surface whose cross section has a highest portion in a center position thereof and downwardly extending therefrom toward the opposite ends thereof (refer to FIG. 5). Because of this, it is possible to increase the flexibility of the movement of the sliding operation piece 40, and therefore the operator can perform a variety of sliding operations.

Also, in the case of the present embodiment, a trigger of the automatic performance is generated when the sliding direction of the sliding operation piece 40 is changed and, at the same time, the sliding speed of the sliding operation piece 40 exceeds the predetermined threshold value ThV. For this reason, for example, the following specific control can be carried out.

That is, it is possible to carry out the specific control that, during the sound output corresponding to a certain musical note, the sound volume is turned up by gradually increasing the sliding speed, next temporarily turned down by gradually decreasing the sliding speed, furthermore next, turned up again by gradually increasing the sliding speed, still further, turned down by gradually decreasing the sliding speed and so forth.

Meanwhile, if a trigger of sound output is generated whenever the sliding speed of the sliding operation piece 40 exceeds the threshold value, there is a shortcoming that the sound output corresponding to the next musical note data is unintentionally output by a trigger which is generated by gradually decreasing the sliding speed and then increasing the sliding speed again.

Also, in the case of the present embodiment, the channels for the sound output to be started in response to a new trigger are different from the channels for the sound output started in response to the previous trigger (refer to steps S286 to S288 of FIG. 40). Accordingly, the sound output started in response to the previous trigger is not immediately terminated by starting the sound output in response to a new trigger, and therefore continuous automatic performance can be realized.

### Embodiment 2

In the case of the embodiment 1, while the state transition of the pulse signals A and B is detected by the use of the counter 290, the falling edge transition of the pulse signal “a” is detected by the edge detection circuit 293 (refer to FIG. 21). Then, the sliding speed and the sliding direction of the sliding operation piece 40 are obtained on the basis of the detection result. In contrast to this, in the case of the embodiment 2, the sliding speed and the sliding direction of the sliding operation piece 40 are obtained by reading the values of the input/output ports (for example, IO0 and IO1), to which the pulse signals A and B are input, by the CPU 201.

Also, in the case of the embodiment 1, the sliding saddle member 33 is designed in the form of a ridge as viewed in cross section. In contrast to this, in the case of the embodiment 2, the sliding saddle member 533 is designed in the form of an arc as viewed in cross section.

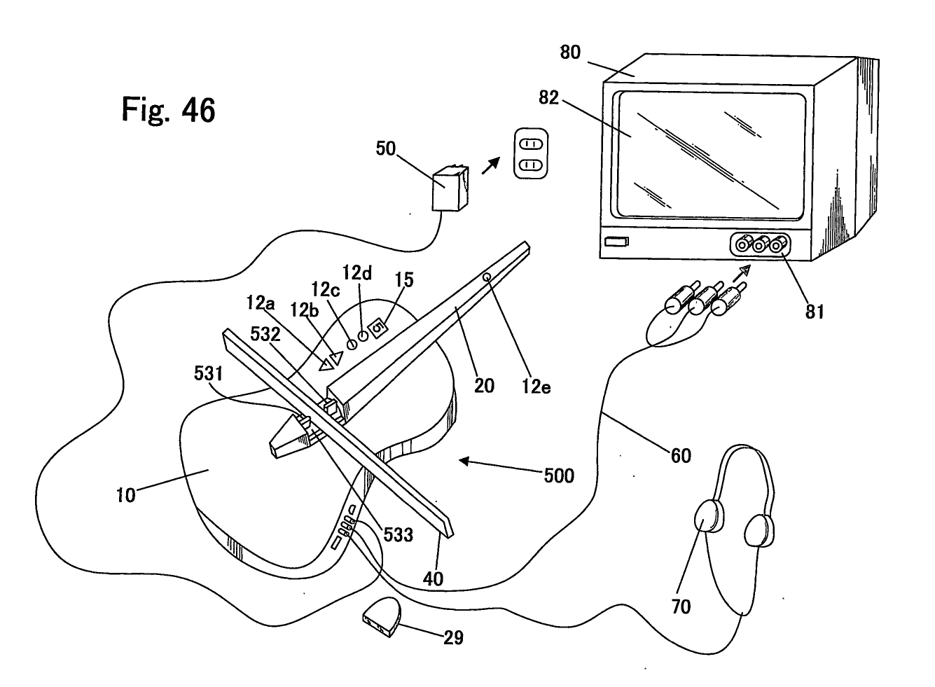

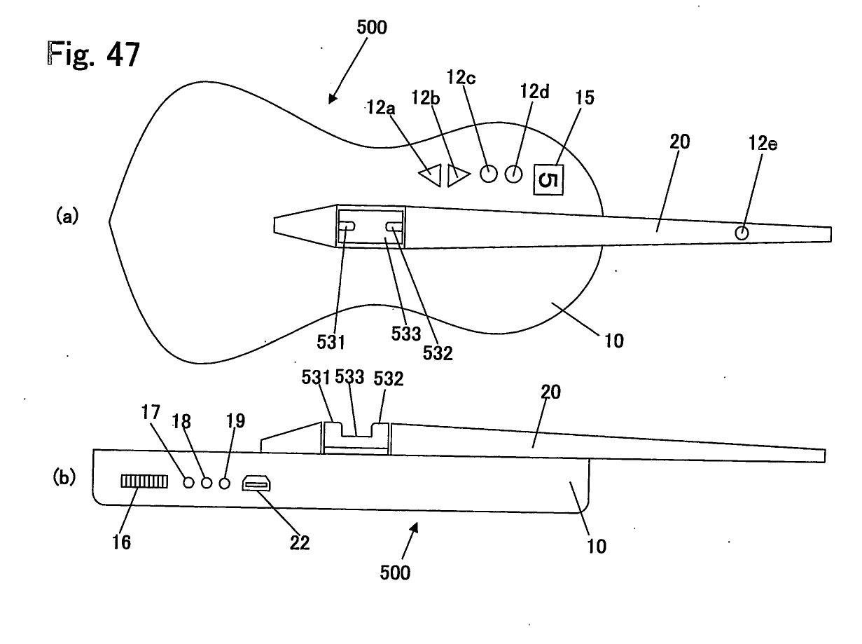

In what follows, the features of the embodiment 2 differing from the embodiment 1 will be mainly explained while omitting the similar description. FIG. 46 is a schematic diagram showing the overall configuration of the automatic performance system in accordance with the embodiment 2 of the present invention. FIG. 47(a) is a plan view showing an automatic musical instrument main body 500 of FIG. 46. FIG. 47(b) is a side view showing the automatic musical instrument main body 500 of FIG. 46. Meanwhile, the bottom surface of the automatic musical instrument main body 500 of FIG. 46 is similar to the bottom surface of the automatic musical instrument main body 1 of FIG. 1, and therefore redundant explanation is dispensed with (refer to FIG. 3).

As illustrated in FIG. 46, this automatic musical instrument includes the automatic musical instrument main body 500 and a sliding operation piece 40. The present embodiment is designed in the form of a violin as an exemplary design of the automatic musical instrument main body 500. The principal surface of the bout portion 10 of the automatic musical instrument main body 500 is provided with a sliding saddle member 533 which is different from the sliding saddle member 33 of the automatic musical instrument main body 1.

The sliding saddle member 533 will be explained with reference to FIG. 47(a) and FIG. 47(b). As explained later, the sliding saddle member 533 is designed in the form of an arc as viewed in cross section. A guide 531 and a guide 532 are projected from the opposite ends of the sliding saddle member 533 along the peak of this sliding saddle member 533. The opposite side surfaces of the guides 531 and 532 are rounded in a plan view and provided to come into contact with the sliding operation piece 40 during operation. This configuration is selected for the purpose of allowing smooth movement of the sliding operation piece 40 even with the guides 531 and 532 being in contact therewith and preventing the wear of the guides 531 and 532 due to the sliding contact between the sliding operation piece 40 and the guides 531 and 532. The operator can take control of the automatic performance of the automatic musical instrument by sliding the sliding operation piece 40 that is located between the guide 531 and the guide 532 of the sliding saddle member 533 while remaining in contact with the curved surfaces thereof.

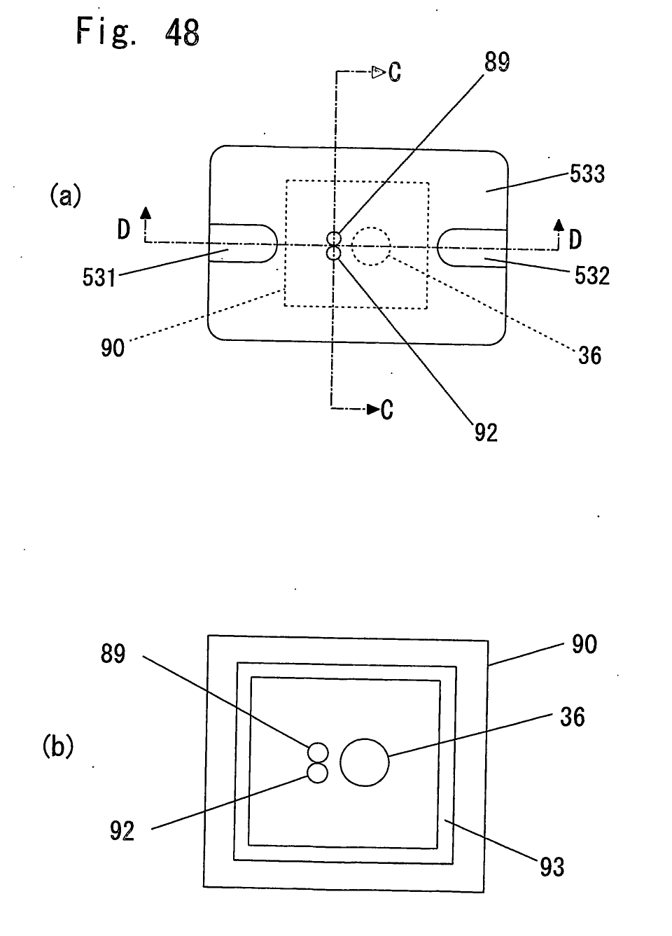

FIG. 48(a) is an expanded view showing the sliding saddle member 533 as shown in FIG. 47(a), and FIG. 48(b) is a plan view showing the optical sensor unit 90 as shown in FIG. 48(a). As illustrated in FIG. 48(a), the optical sensor unit 90 is located inside the sliding saddle member 533 in such a position that the sliding operation piece 40 is passed thereover. This optical sensor unit 90 includes a light emitting diode 36, optical fibers 89 and 92, and phototransistors. 34 and 35 (not shown in FIG. 48). The optical fiber 89 and the optical fiber 92 are arranged along the sliding direction of the sliding operation piece 40.

On the other hand, the light emitting diode 36 is located and opposed to the optical fibers 89 and 92 in the perpendicular direction to the sliding direction. Meanwhile, as illustrated in FIG. 48(b), an adhering member 93 is attached to the upper surface of the optical sensor unit 90 along the peripheral edge, i.e., the surface contacting the inner surface of the sliding saddle member 533. This adhering member 93 serves to provide close contact between the optical sensor unit 90 and the sliding saddle member 533, prevent misalignment of the optical sensor unit 90 and prevent dusts from entering therein and adhering to the optical fibers 89 and 92.

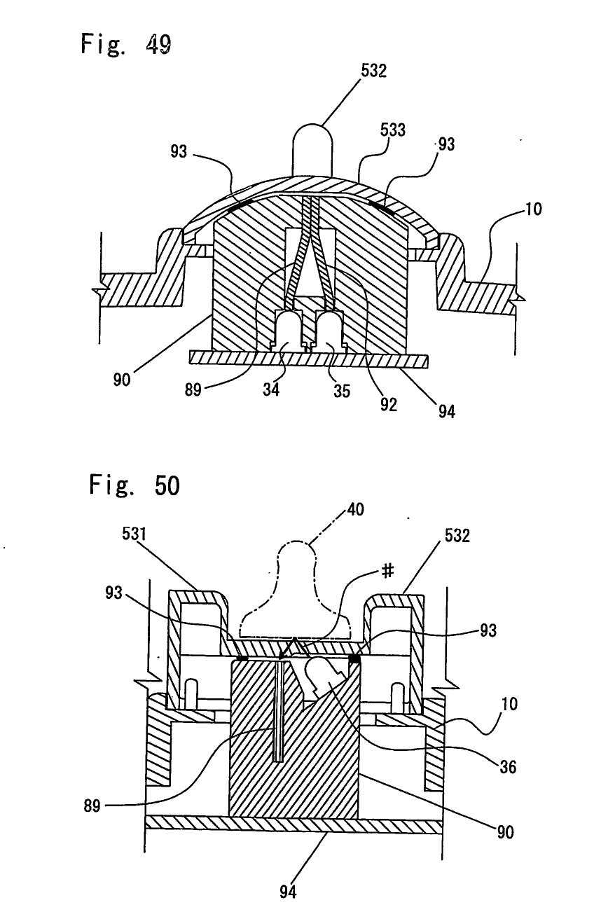

FIG. 49 is a cross sectional view along C-C line of FIG. 48(a). FIG. 50 is a cross sectional view along D-D line of FIG. 48(a). As illustrated in FIG. 49, the sliding saddle member 533 is designed in the form of an arc as viewed in cross section. Namely, the sliding saddle member 533 has a convex surface whose cross section has a highest portion in a center position thereof and downwardly and curvingly extending therefrom toward the opposite ends thereof.

The optical sensor unit 90 is closely attached to the inner surface of the sliding saddle member 533. One ends of the optical fibers 89 and 92 are exposed to the upper surface of the optical sensor unit 90 (from the surface portion located opposed to the sliding saddle member 533). The optical fiber 89 and the optical fiber 92 are arranged at a predetermined distance in the sliding direction. The predetermined distance is selected in order to create a certain differential phase between the pulse signal A of the phototransistor 34 and the pulse signal B of the phototransistor 35. This point will be explained later in detail.

On the other hand, the other ends of the optical fibers 89 and 92 are fixed respectively in the vicinity of the heads of the phototransistors 34 and 35. By this configuration, the light rays output from the light emitting diode 36 and reflected by the sliding operation piece 40 are led respectively to the phototransistors 34 and 35 by the optical fibers 89 and 92. The optical sensor unit 90 and the phototransistors 34 and 35 are mounted on a substrate 94. Furthermore, the phototransistors 34 and 35 are inserted respectively into the two holes which are opened in the bottom surface of the optical sensor unit 90. By this configuration, the phototransistors 34 and 35 are arranged in order to receive the light rays output from the optical fibers 89 and 92 but not to receive other light rays.

On the other hand, as illustrated in FIG. 50, the light emitting diode 36 is mounted on an inclined surface formed in the upper portion of the optical sensor unit 90. By this configuration, it is therefore possible to increase the amount of the incident light as illustrated with an arrow # output from the light emitting diode 36, reflected by the sliding operation piece 40 and then received by the optical fibers 89 and 92. Incidentally, the light emitting diode 36 serves to output infrared light. The sliding saddle member 533 serves as an infrared filter having the functionality of passing only the infrared light output from the light emitting diode 36 in order to let the phototransistors 34 and 35 detect only the infrared light.

Next, the automatic performance of the automatic performance system as shown in FIG. 46 will be explained. The operator connects the automatic musical instrument main body 500 with the television monitor 80 by the AV cable 60. Then, the power switch 24 (refer to FIG. 3) is turned on (in a television mode). The operation style selection screen (refer to FIG. 12) is displayed on the screen 82 of the television monitor 80, from which the operator selects any one of the operation styles by the selection keys 12a and 12b, and then presses the decision key 12d. Then, the music title selection screen (refer to FIG. 13) is displayed from which the operator selects a music title by the selection keys 12a and 12b, followed by pressing the decision key 12d.

When the operator selects and decides a music title, the operation guide screen (refer to FIG. 14) is displayed on the screen 82. The operator can generate a trigger in an appropriate timing with reference to the operation guide screen. Musical tones are thereby output one by one in response to the generation of each trigger in the same manner as in the embodiment 1. A trigger is generated when the sliding direction of the sliding operation piece 40 is changed and at the same time when the speed of the sliding operation piece 40 relative to the automatic musical instrument main body 500 (sliding speed) exceeds a predetermined threshold. Also, the sound volume of musical tones can be controlled in accordance with the sliding speed of the sliding operation piece 40. This is done also in the same manner as in the embodiment 1.

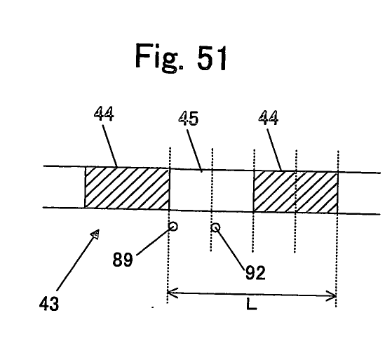

Next, the method of obtaining the sliding speed and the sliding direction of the sliding operation piece 40 will be explained. FIG. 51 is a schematic diagram showing the relationship between the reflecting pattern 43 of the sliding operation piece 40 and the locations of the optical fibers 89 and 92 of the optical sensor unit 90 of FIG. 48(a). As illustrated in FIG. 51, with reference to the reflecting pattern 43 of the sliding operation piece 40, L is the sum of the width of the light reflecting region 45 and the width of the light absorbing region 44. In this case, the exposed end of the optical fiber 89 is located L/4 apart from the exposed end of the optical fiber 92. Here, the exposed end is the tip end of the optical fiber 89 or 92 and exposed to the inner surface of the sliding saddle member 533.

The phototransistors 34 and 35 receive, through the optical fibers 89 and 92, the infrared light output from the light emitting diode 36 and reflected by the reflecting pattern 43. Since the reflecting pattern 43 comprises the light reflecting regions 45 and the light absorbing regions 44 alternately arranged, the phototransistors 34 and 35 intermittently receive the infrared light when the sliding operation piece 40 is moved. Accordingly, when the sliding operation piece 40 is operated, the phototransistors 34 and 35 output the pulse signals A and B having a frequency in proportion to the sliding speed of the sliding operation piece 40.

Namely, as the sliding speed of the sliding operation piece 40 increases, the frequency of the pulse signals A and B output from the phototransistors 34 and 35 increases. Conversely, as the sliding speed of the sliding operation piece 40 decreases, the frequency of the pulse signals output from the phototransistors 34 and 35 decreases. This is done in the same manner as in the embodiment 1.

Since the optical fiber 89 for directing infrared light to the phototransistor 34 is located L/4 apart from the optical fiber 92 for directing infrared light to the phototransistor 35, the differential phase between the pulse signal A output from the phototransistor 34 and the pulse signal B output from the phototransistor 35 is (90 degrees) or (−90 degrees) depending upon the sliding direction of the sliding operation piece 40. The reason for this is the same as in the embodiment 1 (refer to FIG. 19(a) and FIG. 19(b) and FIG. 20).

Accordingly, in the same manner as the embodiment 1, it is possible to determine the sliding direction of the sliding operation piece 40 by detecting the state transition of the pulse signals A and B. While the transition detection is performed by hardware (by the counter 290) in the case of the embodiment 1, the embodiment 2 makes use of software instead. This point will be explained later.

In this description of the embodiment 2, for the sake of clarity in explanation, the transition in the clockwise direction is referred to as “(+) transition direction” while the transition in the counter clockwise direction is referred to as “(−) transition direction”.

The detection unit 510 provided in the automatic musical instrument main body 500 will be explained. The electrical construction of the automatic musical instrument main body 500 is substantially identical to that as illustrated in FIG. 15 except for the detection unit 510 as explained below in place of the detection unit 30 of FIG. 15.

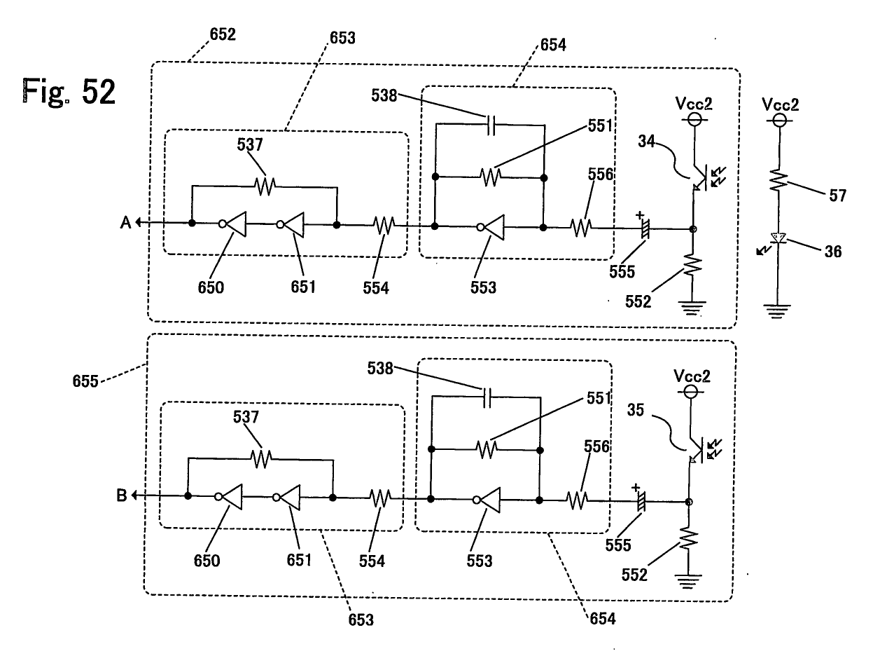

FIG. 52 is a circuit diagram showing the detection unit 510 provided in the automatic musical instrument main body 500. As illustrated in FIG. 52, this detection unit 510 includes a light emitting diode 36, a resistor element 57, and sensor circuits 652 and 655. The sensor circuit 652 includes the above phototransistor 34, an electrolytic capacitor 555, a resistor element 552, an amplifier 654 and a waveform shaping circuit 653. The sensor circuit 655 includes the above phototransistor 35, an electrolytic capacitor 555, a resistor element 552, an amplifier 654 and a waveform shaping circuit 653.

The amplifier 654 includes resistor elements 551 and 556, a capacitor 538, and an inverter 553. The waveform shaping circuit 653 includes resistor elements 537 and 554, and inverters 650 and 651.

The resistor element 57 and the light emitting diode 36 are connected between an electric power supply Vcc2 and a ground GND in series. The phototransistor 34 and the resistor element 552 are connected between the electric power supply Vcc2 and the ground GND in series. The resistor element 556 and the electrolytic capacitor 555 are connected in series between the input terminal of the inverter 553 and the connecting point between the phototransistor 34 and the resistor element 552. The capacitor 538 and the resistor element 551 are connected in parallel between the input terminal and the output terminal of the inverter 553.

The resistor element 554 is connected to the output terminal of the inverter 553 at one terminal and connected to the input terminal of the inverter 651 at the other terminal. The inverter 651 is connected to the input terminal of the inverter 650 at the output terminal. The resistor element 537 is connected between the input terminal of the inverter 651 and the output terminal of the inverter 650. The sensor circuit 655 has the same configuration as the sensor circuit 652, and therefore no redundant description is repeated.

The amplifier 654 is a negative feedback amplifier which amplifies the electrical signal of the phototransistor 34. Also, this amplifier 654 serves also as a lowpass filter which remove high frequency components. The waveform shaping circuit 653 serves to shape the input waveform into a sharp rectangular pattern. Namely, the waveform shaping circuit 653 forms a dead band defined by the ratio between the resistor element 537 and the resistor element 554 in order to generate the sharp pulse signal A while preventing the output from being inverted within a certain voltage range. Meanwhile, the operations of the amplifier 654 and the waveform shaping circuit 653 of the sensor circuit 655 are same as those of the sensor circuit 652, and therefore no redundant description is repeated.

The pulse signals A and B as output from the sensor circuits 652 and 655 are input to the input/output ports of the high speed processor 200 (for example, IO0 and IO1 in the case of the present embodiment).

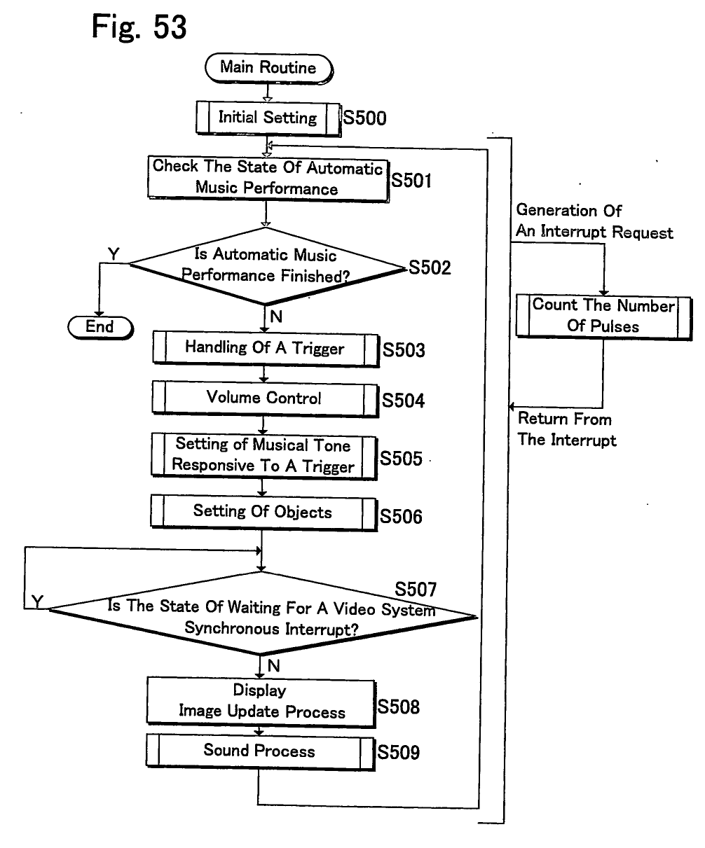

Next, the entire operation of the automatic musical instrument of FIG. 46 will be explained with reference to the flowchart. FIG. 53 is a flowchart showing the entire operation of the automatic musical instrument of FIG. 46. As illustrated in FIG. 53, in step S500, the CPU 201 performs the initial setting of the system. In step S501, the CPU 201 checks the condition of automatic performance. In step S502, the CPU 201 determines whether or not the automatic performance is finished. If the automatic performance is finished (the music end flag is turned on), the CPU 201 finishes the process. Conversely, if the automatic performance is not finished yet, the process then proceeds to step S503.

In step S503, the CPU 201 determines the sliding 30 direction of the sliding operation piece 40 and calculates the sliding speed thereof, and if the trigger generating requirements are satisfied, the CPU 201 generates a trigger (set an sound output flag on). In step S504, the CPU 201 calculates an envelope coefficient in proportion to the sliding speed of the sliding operation piece 40 in order to control the volume of musical sound as started in response to the trigger.

In step S505, the CPU 201 stores the musical tone related information for trigger sound output in the inner memory 207. This process is same as the step S6 of FIG. 28, and therefore no redundant description is repeated. In step S506, the CPU 201 stores the object related information in the inner memory 207. This process is same as the step S7 of FIG. 28, and therefore no redundant description is repeated.

In step S507, it is determines whether or not the CPU 201 waits for the video system synchronous interrupt. While the CPU 201 waits for a video system synchronous interrupt, the process repeats the same step S507. On the other hand, if the CPU 201 gets out of the state of waiting for a video system synchronous interrupt, the process proceeds to the step S508. This process is same as the step S8 of FIG. 28.

In step S508, the CPU 201 transmits object related information to the graphic processor 202, and the graphics processor 202 acquires background image related information from the inner memory 207. The graphic processor 202 generates the image signal VD containing object and background images, and outputs them to the television monitor 80. This process is same as the step S9 of FIG. 28.

In step S509, the CPU 201 stores, in the inner memory 207, the musical tone related information on the basis of the musical score data for BGM. The sound processor 203 acquires the musical tone related information for trigger sound output (refer to step S505) and for the BGM sound output from the inner memory 207, and generates audio signals AL and AR on the basis of the information, and outputs these signals to the television monitor 80. Also, in step S509, the CPU 201 registers the musical notation mark n in accordance with the musical score data for registering musical notation marks. Furthermore, in step S509, the CPU 201 executes the vibrato process when the vibrato switch 12e pushed down. These processes are same as the step S10 of FIG. 28, and therefore no redundant description is repeated.

The pulse count process in step S510 is performed by the CPU 201 every time the timer circuit 210 issues an interrupt request signal. The pulse count process is a process of counting the state transition of the pulse signals A and B as output from the phototransistors 34 and 35 (refer to FIG. 52).

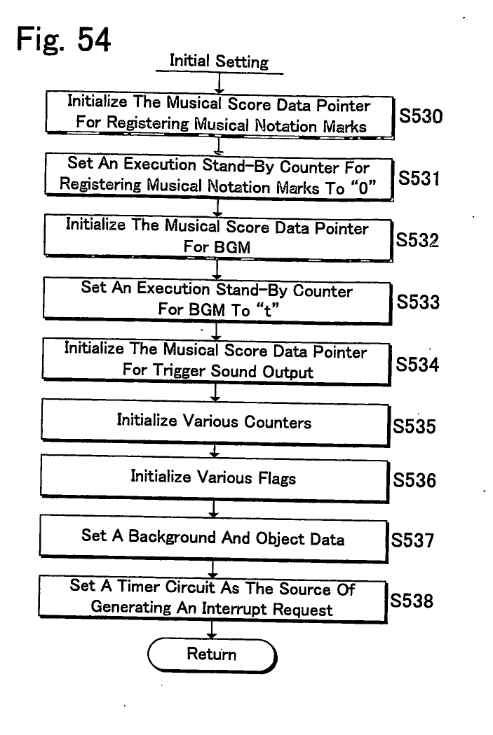

FIG. 54 is a flowchart showing an example of the process flow in the initial setting of the system in step S500 of FIG. 53. The processes in steps S530 to S537 of FIG. 54 are same as the steps S30 to S37 of FIG. 29, and therefore no redundant description is repeated. In step S538, the CPU 201 sets the timer circuit 210 as the source of generating an interrupt request signal for repeating the pulse count process in step S510. In this case, the timer circuit 210 is set in order that an interrupt request signal is issued with a time interval which is no longer than the shortest high level period or the shortest low level period of the pulse signal A of the phototransistor 34 or the pulse signal B of the phototransistor 35.

For example, the interrupt request signal is generated at 10 kHz. Also, for example, the display image is updated (updating the frame) every 60th second.

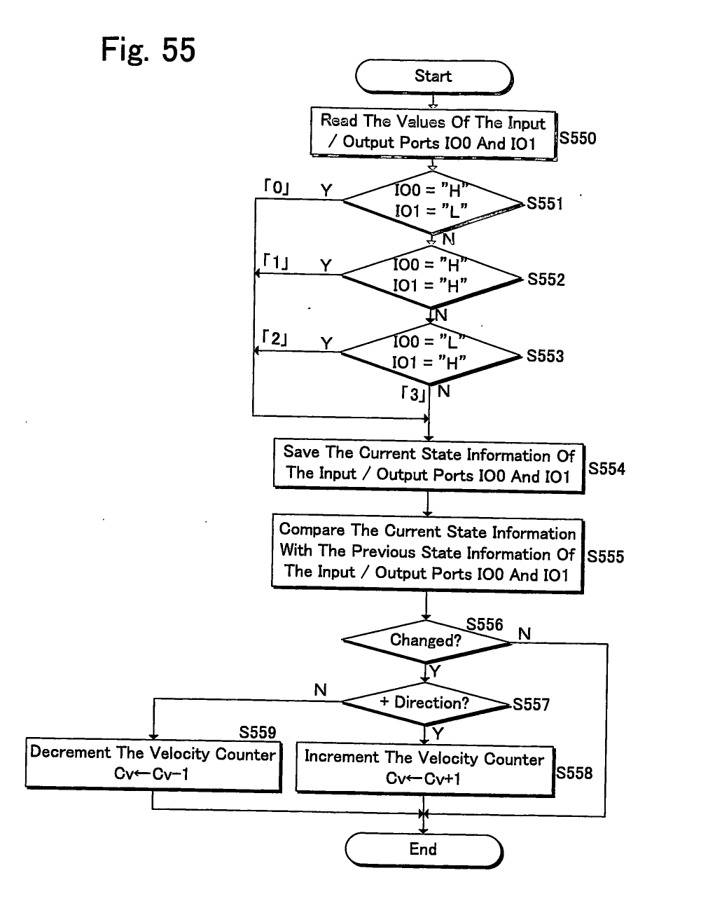

FIG. 55 is a flow chart showing an example of the pulse count process in step S510 of FIG. 53. In this case, the pulse signal A and the pulse signal B are input respectively to the input/output ports IO0 and IO1 of the high speed processor 200. As illustrated in FIG. 55, in step S550, the CPU 201 reads the values of the input/output ports IO0 and IO1 through the input/output control circuit 209.

In step S551, if the value of the input/output port IO0 is a high level and at the same time the value of the input/output port 101 is a low level, the CPU 201 determines the state transition of the input/output ports IO0 and IO1 as “0” and proceeds to step S554. Otherwise, the CPU 201 proceeds to step S552. In step S552, if the value of the input/output port IO0 is a high level and at the same time the value of the input/output-port IO1 is a high level, the CPU 201 determines the state transition of the input/output ports IO0 and IO1 as “1” and proceeds to step S554. Otherwise, the CPU 201 proceeds to step S553.

In step S553, if the value of the input/output port IO0 is a low level and at the same time the value of the input/output port IO1 is a high level, the CPU 201 determines the state transition of the input/output ports IO0 and IO1 as “2” and proceeds to step S554. Otherwise, since the value of the input/output port IO0 is a low level and at the same time the value of the input/output port IO1 is a low level, the CPU 201 determines the state transition of the input/output ports IO0 and IO1 as “3” and proceeds to step S554.

In step S554, the CPU 201 saves the current state information of the above state transition of the input/output ports IO0 and IO1 in the inner memory 207. In step S555, the CPU 201 compares the current state information of the input/output ports IO0 and IO1 with the previous state information. In step S556, if the current state information of the input/output ports IO0 and IO1 is changed, the CPU 201 proceeds to step S557.

In step S557, the CPU 201 determines the transition direction of the state information of the input/output ports IO0 and IO1 (refer to FIG. 20). If the transition direction of the state information is changed in agreement with the (+) transition direction, the CPU 201 increments a velocity counter Cv by one. On the other hand, if the transition direction of the state information is changed in agreement with the (−) transition direction, the CPU 201 proceeds to step S559 in which the velocity counter Cv is decremented by one. In this manner, the state transition of the pulse signals A and B from the phototransistors 34 and 35 is counted. Incidentally, the velocity counter Cv is a software counter.

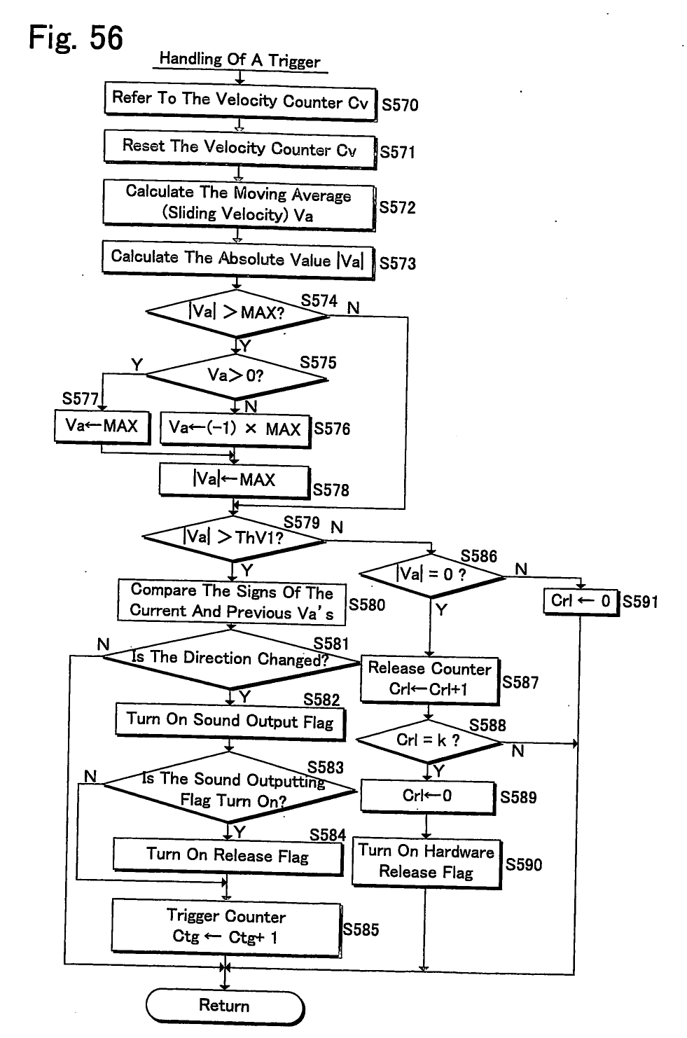

FIG. 56 is a flow chart showing an example of the procedure for handling a trigger in step S503 of FIG. 53. As illustrated in FIG. 56, in step S570, the CPU 201 acquires the counter value of the velocity counter Cv. The counter value as acquired is the counter value per frame and indicative of the current sliding velocity of the sliding operation piece 40. In step S571, the CPU 201 resets the velocity counter Cv.

In step S572, the CPU 201 calculates the moving average of the sliding velocity of the sliding operation piece 40 (the average counter value of the velocity counter Cv). For example, the average sliding velocity is calculated over ten frames by the use of the current sliding velocity of the sliding operation piece 40 and the sliding velocities of the previous 9 frames. The average sliding velocity of the sliding operation piece 40 is referred here to as the sliding velocity Va.

In step S573, the CPU 201 calculates the absolute value |Va| of the sliding velocity Va, i.e., the sliding speed |Va|. In step S574, the CPU 201 determines whether or not the sliding speed |Va| of the sliding operation piece 40 exceeds a predetermined maximum value MAX. If the sliding speed |Va| of the sliding operation piece 40 exceeds the predetermined maximum value MAX, the process proceeds to step S575, otherwise proceeds to step S580.

In step S575, the CPU 201 refers to the sign of the sliding velocity Va and, if the sign is positive, the maximum value MAX is assigned to the sliding velocity Va in step S577. Conversely, if the sign is negative, (−1)×MAX is assigned to the sliding velocity Va in step S576. In step S578, the CPU 201 assigns the maximum value MAX to the sliding speed |Va| and proceeds to step S579.

In step S579, the CPU 201 determines whether or not the sliding speed |Va| of the sliding operation piece 40 exceeds a predetermined threshold value ThV. If the sliding speed |Va| exceeds the predetermined threshold value ThV1, the process proceeds to step S580, otherwise proceeds to step S584.

In step S580, the CPU 201 compares the sign of the current sliding velocity Va with the sign of the previous sliding velocity Va of the sliding operation piece 40. If the sign of the sliding velocity Va is not changed, the CPU 201 judges that the sliding direction of is not changed and returns to the main routine. Conversely, if the sign of the sliding velocity Va is changed, the CPU 201 judges that the sliding direction of is changed, and proceeds to step S582. Then, in step S582, the CPU 201 turns on the sound output flag. The sound output flag as turned on means the generation of a trigger. In step S583, the CPU 201 checks the sound outputting flag. For example, the sound outputting flag is set to “00” when sound is not outputting, “10” when sound is outputting through the channels CH0 and CH1, “10” when sound is outputting through the channels CH2 and CH3. The sound outputting flag is recognized to be turned off if set to “00”, and recognized to be turned on if set to “01” or “10”. In step S583, the process proceeds to step S585 if the sound outputting flag is turned off, and proceeds to step S584 if the sound outputting flag is turned on. In step S584, the CPU 201 turns on the hardware release flag. This is because a trigger is generated anew during sound output.

In step S585, the CPU 201 increments the trigger counter Ctg and returns to the main routine.

As described above, a trigger is generated when the sliding direction of the sliding operation piece 40 is changed (refer to step S581) while the speed of the sliding operation piece 40 relative to the automatic musical instrument main body 500 (i.e., the sliding speed |Va|) exceeds a predetermined threshold ThV1 (refer to step S579).

On the other hand, in step S586, the CPU 201 determines whether or not the sliding speed |Va| is “0”. If the sliding speed |Va| is not “0”, the CPU 201 proceeds to step S591, in which the release counter Crl is reset, and then returns to the main routine. Conversely, if the sliding speed |Va| is “0”, the CPU 201 proceeds to step S587.

In step S587, the CPU 201 increments the release counter Crl by one. In step S588, the CPU 201 determines whether or not the release counter Crl reaches a constant value k. If the release counter Crl does not reach the constant value k, the CPU 201 returns to the main routine. Conversely, if the release counter Crl reaches the constant value k, the CPU 201 proceeds to step S589. In step S589, the CPU 201 resets the release counter Crl. In step S590, the CPU 201 turns on the hardware release flag, and returns to the main routine.

The process of steps S586 to S590 is a process of invoking the hardware release process after the sliding speed |Va| is successively detected to be “0” for k times (for example, k=7). Meanwhile, software release can be used instead of the hardware release.

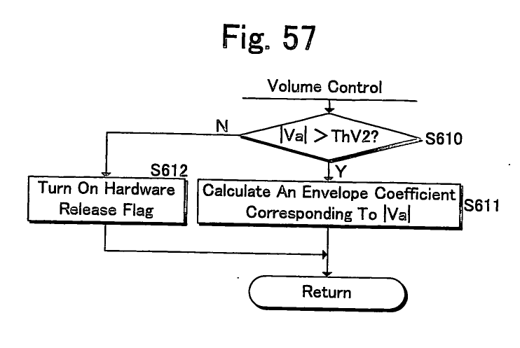

FIG. 57 is a flowchart showing an example of the procedure for controlling the sound volume in step S504 of FIG. 53. As illustrated in FIG. 57, in step S610, the CPU 201 determines whether or not the sliding speed |Va| of the sliding operation piece 40 exceeds a predetermined threshold value ThV2. If the sliding speed |Va| exceeds the threshold value ThV2, the CPU 201 proceeds to step S611, and otherwise proceeds to step S612.

In step S611, the CPU 201 calculates an envelope coefficient in proportion to the sliding speed |Va| of the sliding operation piece 40, and returns to the main routine. For example, if the velocity counter Cv is an 8 bit counter, the envelope coefficient is calculated as 8×|Va|×(1/255) while it is clipped to “1” if the envelope coefficient as calculated exceeds “1”. On the other hand, in step S612, the CPU 201 turns on the hardware release flag, and returns to the main routine.

In this case, the process in steps S610 and S612 is introduced for the purpose of performing hardware release if the sliding speed |Va| does not exceed the threshold value ThV2 even when the sliding speed |Va| is not repeatedly “0” for k times. In other words, the process in steps S610 and S612 is introduced for the purpose of flexibly detecting the stopping of the sliding operation piece 40 in agreement with the intention of the operator. Namely, the process is a process of handling the stopping of the sliding operation piece 40 in accordance with the intention of the operator to have the sound output gradually decrease and halt by gradually decreasing the sliding speed. Incidentally, for example, ThV2≦ThV1. The threshold ThV1 is selected so large in order to prevent the generation of a trigger due to unintentional operation by the operator (for example, due to a very small movement of the sliding operation piece 40 caused by involuntary small movement of a hand of the operator). On the other hand, the threshold ThV2 is selected so small for the purpose of avoiding the detection of the stopping of the sliding operation piece 40 when the operator intentionally slides the sliding operation piece 40 at a low speed. However, by trial and error, it may be experientially selected that ThV1=Thv2.

Meanwhile, as described above, in accordance with the present embodiment, the operator can generate a trigger and control the sound volume during automatic performance by intuitive operation, for example, by changing the sliding direction or the sliding speed of the sliding operation piece 40.

In this way, an operator with no particular musical knowledge and skill can add dynamics with tempo rubato by intuitive operations to music, which is automatically performed by the automatic musical instrument (computer), and therefore can enjoy individual automatic performance.

Also, when the sliding speed of the sliding operation piece 40 falls below the predetermined threshold value ThV2 (refer to step S610 of FIG. 57), the termination process of the sound output of the latest trigger is invoked, while, when a trigger is generated anew, the termination process of the sound output of the previous trigger is invoked (refer to step S584 of FIG. 56).

Accordingly, there is the following advantage as compared with the case where-a trigger is generated whenever the sliding speed of the sliding operation piece 40 exceeds the predetermined threshold value ThV1 while the sound output is terminated whenever the sliding speed of the sliding operation piece 40 falls below the predetermined threshold value ThV2.

If the operator quickly changes the sliding direction while moving the sliding operation piece at a large sliding speed, it may not be detected that the sliding speed falls below the predetermined threshold value ThV2 and therefore the termination process of sound output is not invoked, while the sliding speed detected just after the change exceeds the predetermined threshold value ThV2. In this case, there is a shortcoming that the sound output started responsive to a single trigger is unintentionally continued. The above shortcoming results in a substantial problem because the operation of quickly changing the sliding direction while moving the sliding operation piece at a large sliding speed is often done.

The problem as described above can be avoided by handling the generation of a new trigger as a termination condition for terminating sound output started responsive to the previous trigger (in the case where the sliding speed exceeds the predetermined threshold value ThV1 and the sliding direction is changed after the previous trigger).

Furthermore, while a trigger is unintentionally generated for example by an involuntary small movement of a hand of the operator if a trigger is generated whenever the sliding direction of the sliding operation piece 40 is changed, this shortcoming can be avoided by adding another trigger generation requirement that the sliding speed exceeds the predetermined threshold value ThV1.

The termination process of sound output does not mean that the sound output is stopped without delay, but does rather means that the sound output is gradually deadened (a hardware release process in the case of the present embodiment). Accordingly, there is a predetermined time (release time) before the sound output is completely stopped after starting the termination process.

Also, in the case of the present embodiment, the phototransistors 34 and 35 and the light emitting diode 36 function as a reflective optical sensor in combination with which the sliding speed and the sliding direction of the sliding operation piece 40 can be obtained with ease. In this case, the infrared light as reflected by the reflecting pattern 43 of the sliding operation piece 40 is led to the phototransistors 34 and 35 by the optical fibers 89 and 92. Accordingly, by adjusting the distance between one end of the optical fiber 89 (the tip end thereof exposed to the inner surface of the sliding saddle member 533) and one end of the optical fiber 92 (the tip end thereof exposed to the inner surface of the sliding saddle member 533), it is possible to easily and accurately adjust the phase difference between the electronic signal output from the phototransistor 34 and the electronic signal output from the phototransistor 35.

Also, in accordance with the present embodiment, since the sliding position of the sliding operation piece 40 is limited by the two guides 531 and 532, the operator can have the sliding operation piece 40 pass over the light emitting diode 36 and the optical fibers 89 and 92 without particular attention. Furthermore, since the sliding saddle member 533 is designed in the form of an arc as viewed in cross section, it is possible to increase the flexibility of the movement of the sliding operation piece 40, and therefore the operator can perform a variety of sliding operations.

Still further, in the case of the present embodiment, the images 103 and 104 indicative of the current state of the automatic performance and the images n, 100, 101 and 102 indicative of the operation guide are displayed on the television monitor 80 (refer to FIG. 14), in the same manner as in the embodiment 1, while the main body 500 is provided with the cartridge socket 23 into which the memory cartridge 29 is inserted. Still further, in the case of the present embodiment, while the same trigger generation requirements are used as in the embodiment 1, the channels for the sound Output to be started in response to a new trigger are different from the channels for the sound output started in response to the previous trigger (refer to steps S286 to S288 of FIG. 40). Accordingly, because of the configuration, there are the same advantages in the case of the present embodiment as in the embodiment 1.

### Embodiment 3

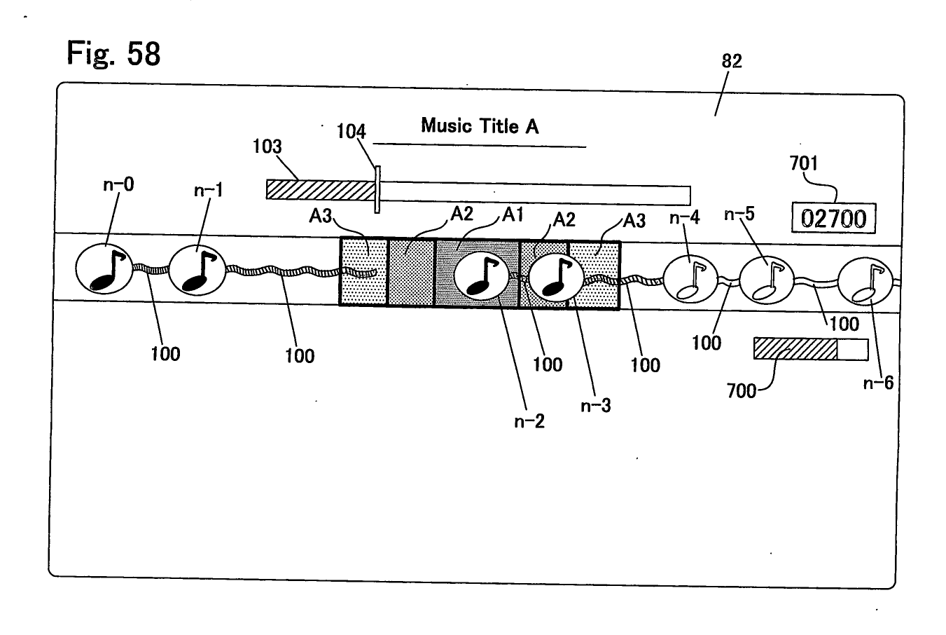

In the case of the embodiment 3, the operation guide screen as displayed on the screen 82 differs from that as illustrated in FIG. 14. FIG. 58 is a view showing an example of the operation guide screen in accordance with the embodiment 3. In this operation guide screen, a best operation area A1, a pair of second best operation areas A2 located in the opposite side of the best operation area A1, a pair of third best operation areas A3 located in the opposite side of the best operation area A1 with the second best operation areas A2 intervening therebetween, a life indicator 700 and a score indicator 701 are displayed in addition to the elements as displayed on the operation guide screen of FIG. 14. However, the correct timing indication square 101, the correct timing mark 102 and the synchronization value 99 as shown in FIG. 14 are not displayed on the operation guide screen of FIG. 58. In the following description, the term “operation area A” is used to generally represent the best operation area A1, the second best operation areas A2 and the third best operation areas A3.

If the operator generates a trigger when the musical notation mark n enters the best operation area A1, he can get for example 50 points. If the operator generates a trigger when the musical notation mark n enters the second best operation areas A2, he can get for example 30 points. If the operator generates a trigger when the musical notation mark n enters the third best operation areas A3, he can get for example 10 points.

Furthermore, for example, the operator can get 60 points when he successively generates a trigger within the best operation area A1 for 5 to 9 times, 70 points when he successively generates a trigger within the best operation area A1 for 10 to 29 times, 80 points when he successively generates a trigger within the best operation area A1 for 30 to 49 times, 90 points when he successively generates a trigger within the best operation area A1 for 50 to 99 times, and 100 points when he successively generates a trigger within the best operation area A1 for 100 or more times.

When starting automatic performance, the operator is given for example 8 lifes. One life is consumed when a trigger is generated outside the best operation area A1, the second best operation areas A2 and the third best operation areas A3. All the lifes are consumed, the automatic performance is terminated. Also, for example, if a trigger is successively generated for 10, 30, 50 or 100 times, a life is recovered each time the trigger is generated. However, the number of lifes does not exceed 8.

The above points acquired by the operator is displayed in the score indicator 701 on a real time base. On the other hand, the number of lifes of the operator is displayed on the life indicator 700. The, when one life is consumed, the portion shaded with the particular color of the life indicator 700 is diminished by ⅛. Conversely, when one life is recovered, the portion shaded with the particular color of the life indicator 700 is expanded by ⅛. When the portion shaded with the particular color of the life indicator 700 disappears, i.e., if all the eight lifes are consumed, the automatic performance is terminated.

Meanwhile, if the operator generates a trigger when the musical notation mark n enters the best operation area A1, the automatic musical instrument outputs musical tones keeping pace with the tempo of the BGM. In this case, the best operation area A1 functions in the same manner as the correct timing indication square 101 of FIG. 14.

Also, for example, for the respective cases where a trigger is generated when the musical notation mark n enters the best operation area A1, where a trigger is generated when the musical notation mark n enters the second best operation areas A2, and where a trigger is generated when the musical notation mark n enters the third best operation areas A3, it is possible to indicate which case occurs of the best, the second best and the third best. Furthermore, it is possible to indicate the number of times a trigger is successively generated within the best operation area A1.

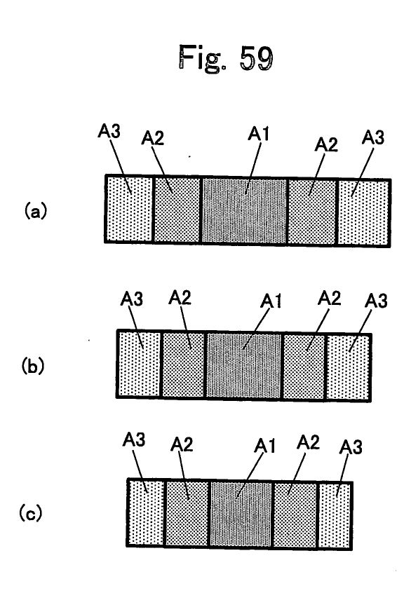

Meanwhile, in the case of the present embodiment, three different modes (a hard mode, a standard mode, an easy mode) are provided. FIG. 59(a) is a view for explaining the hard mode, FIG. 59(b) is a view for explaining the standard mode, and FIG. 59(c) is a view for explaining the easy mode. As illustrated in FIGS. 59(a) to 59(c), the width of the operation area A is narrowed in the horizontal direction in the order of the hard mode, the standard mode, and the easy mode. Accordingly, the hard mode has the highest difficulty level, the standard mode the next and the easy mode the lowest.

Either the automatic musical instrument of FIG. 1 and the automatic musical instrument of FIG. 46 can be used as the automatic musical instrument of the present embodiment. In the case where the automatic musical instrument of FIG. 1 is used the following trigger generation area determination process is performed, for example, between step S6 and step S7 of FIG. 28. On the other hand, in the case where the automatic musical instrument of FIG. 46 is used the following trigger generation area determination process is performed, for example, between step S505 and step S506 of FIG. 53.

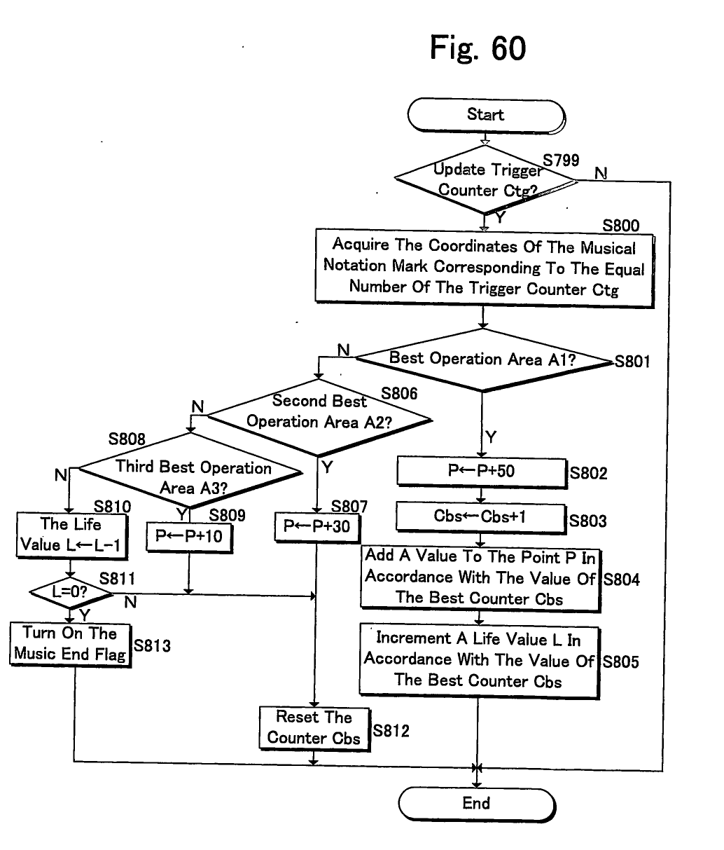

FIG. 60 is a flowchart showing an example of the trigger generation area determination process in accordance with the automatic musical instrument of the present embodiment. As illustrated in FIG. 60, the CPU 201 determines whether or not the trigger counter Ctg is updated (i.e., incremented) in step S799, and if updated the process proceeds to step S800 otherwise returns to the main routine.

In step S800, the CPU 201 acquires the coordinates of the musical notation mark n corresponding to the equal number of the value of the trigger counter Ctg. The coordinates of the musical notation mark n are the center coordinates of the sprite constituting the musical notation mark n. In step S801, the CPU 201 determines whether or not the coordinates of the musical notation mark n corresponding to the equal number of the value of the trigger counter Ctg falls within the best operation area A1, and if it falls within the area the process proceeds to step S802 otherwise proceeds to step S806.

In step S802, the CPU 201 adds 50 points to the point P. In step S803, the CPU 201 increments a best counter Cbs. In step S804, the CPU 201 adds a value to the point P in accordance with the value of the best counter Cbs. Accordingly, as described above, when a trigger is repeatedly generated within the best operation area A1, the points in accordance with the number of repetition times is added. In step S805, the CPU 201 increments a life value L by one in accordance with the value of the best counter Cbs, followed by returning to the main routine. Accordingly, as described above, when a trigger is repeatedly generated within the best operation area A1, the life value L is incremented by one in accordance with the number of repetition times.

On the other hand, in step S806, the CPU 201 determines whether or not the coordinates of the musical notation mark n corresponding to the equal number of the value of the trigger counter Ctg falls within the second best operation areas A2, and if it falls within the area the process proceeds to step S807, in which 30 points is added to the point P, followed by proceeding to step S812. Conversely, if it does not fall with the area, the process proceeds to step S808.

In step S808, the CPU 201 determines whether or not the coordinates of the musical notation mark n corresponding to the equal number of the value of the trigger counter Ctg falls within the third best operation areas A3, and if it falls within the area the process proceeds to step S809, in which 10 points is added to the point P, followed by proceeding to step S812. Conversely, if it does not fall with the area, the process proceeds to step S810.

In step S810, the CPU 201 decrements the life value L by one. This is because, in this case, a trigger is generated in a position which does not fall within any of the best operation area A1, the second best operation areas A2 and the third best operation areas A3. In step S811, the CPU 201 determines whether or not the life value L is “0”. If the life value L is not “0”, the process proceeds to step S812, otherwise proceeds to step S813 in which the music end flag is turned on followed by returning to the main routine.

In step S812, the CPU 201 resets the best counter Cbs. This is because the best counter Cbs is used to indicate the number of times a trigger is successively generated within the best operation area A1.

Incidentally, in the case of the present embodiment, the score indicator control process is performed in place of the synchronization value control process in step S129 of FIG. 33. In this process, the CPU 201 selects five belt objects in accordance with the point P and sets the coordinates of the respective belt objects.

More specific description is as follows. There are provided 10 numeral objects corresponding to “0” to “9”. Each numeral object consists of a sprite consisting of 16×16 pixels. Then, the CPU 201 selects numeral objects representing the point P, and sets the x coordinate and the y coordinate of each of the numeral objects as selected. For example, if the point P is “2700”, three numeral objects indicating “0”, one numeral object indicating “2” and one numeral object indicating “7” are selected followed by setting the x coordinates and the y coordinates of the respective numeral objects.

Meanwhile, in the case of the present embodiment, for example, a life indicator control process is performed after the score indicator control process. In this process, the CPU 201 selects two belt objects in accordance with the life value L and sets the coordinates of the respective belt objects.

More specific description is as follows. The life indicator 700 consists of two belt objects each of which consists of one sprite of 16×16 pixels. There are 5 types of the belt objects. The first belt object is composed of a transparent sprite, the second a sprite representing a belt having 4 pixel length, the third a sprite representing a belt having an 8 pixel length, . . . , and the 5th a sprite representing a belt having a 16 pixel length. The length of the life indicator 700 in the horizontal direction is, for example, 32 pixels, i.e., corresponding to two belt objects.

The CPU 201 selects two belt objects in accordance with the life value L. Then, the CPU 201 sets the x coordinates and the y coordinates of all the belt objects as selected. For example, if the number of life L is “5”, one 5th belt object and one second belt object are selected followed by setting the x coordinate and the y coordinate of each belt object.

By the way, in the case of the present embodiment as described above, the best operation area A1, the second best operation area A2 and the third best operation area A3 is displayed on the screen 82, and the addition and subtraction of points and lifes are performed in accordance with the area in which a trigger is generated. As described above, the automatic performance is combined with attractiveness of a game, and therefore it is possible to provide another way in which the operator enjoys (refer to FIG. 58).

### Embodiment 4

The embodiment 4 is characterized in that two operators can enjoy together to participate the automatic performance of the same music piece. In this case, the duet can be performed by preparing two pairs of the automatic musical instrument main body 1 and the sliding operation piece 40 as illustrated in FIG. 1 and connecting the two automatic musical instrument main bodies 1 to each other, or by preparing two pairs of the automatic musical instrument main body 500 and the sliding operation piece 40 as illustrated in FIG. 46 and connecting the two automatic musical instrument main bodies 500 to each other. First, the operation guide screen in the case of the present embodiment will be explained.

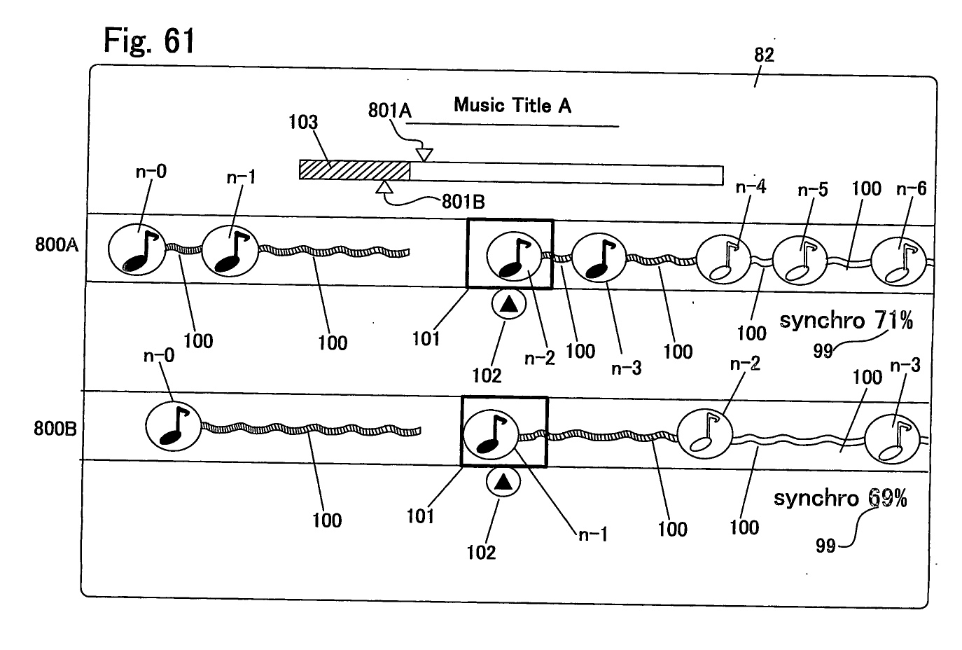

FIG. 61 is a view showing an example of the operation guide screen in accordance with the present embodiment. As illustrated in FIG. 61, the guide stave 800A provided for the operator operating one automatic musical instrument and the guide stave 800B provided for the operator operating the other automatic musical instrument are displayed on this operation guide screen. Each of the guide staves 800A and 800B contains musical notation marks n, note length indication bars 100, a correct timing indication square 101, and a synchronization value 99. The functions thereof are the same as those of FIG. 14.

Also, an indicator 103 as illustrated in FIG. 14 is displayed with an operation position indicating object 801A located along the upper edge of the indicator 103 for the operator operating the above one automatic musical instrument, and an operation position indicating object 801B located along the lower edge of the indicator 103 for the operator operating the above other automatic musical instrument. The functionality of the operation position indicating objects 801A and 801B is the same as the vertical bar 104 of FIG. 14 and indicates the current operation position of the respective operators.

Accordingly, the two operators can see how much the current operation position is displaced from the appropriate operation position. Meanwhile, the term “operation position” stands for the position in the time domain relating to the entirety of the music.

As understood from FIG. 61, the contents of the guide stave 800A differs from the contents of the guide stave 800B (in the combination of musical notation marks n), and therefore the two operators perform different parts. There are two different parts for two operators. Accordingly, different musical tones are output in response to the triggers generated by the respective two operators.

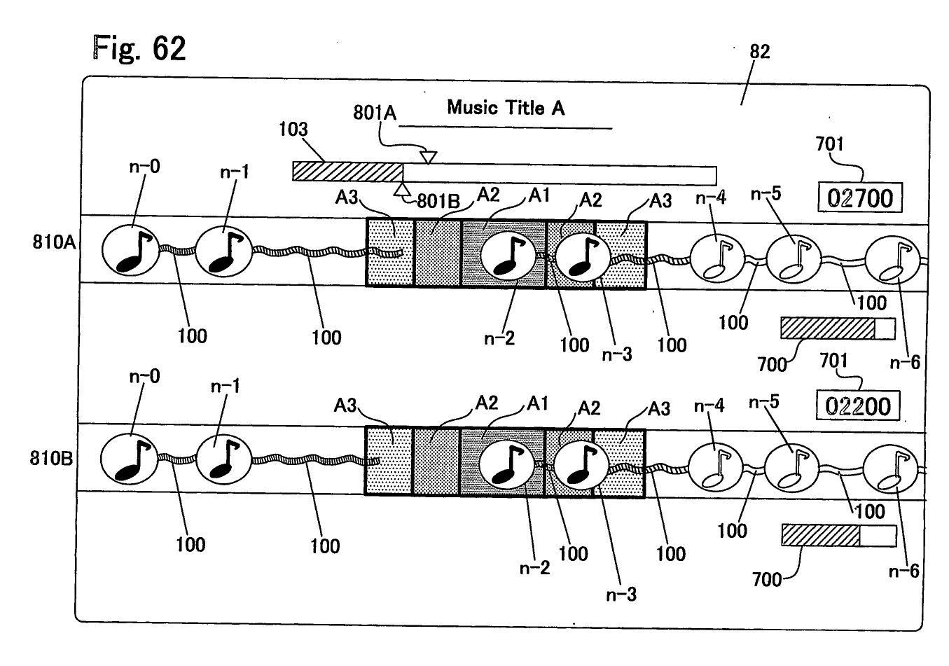

FIG. 62 is a view showing another example of the operation guide screen in accordance with the present embodiment. As illustrated in FIG. 62, the guide stave 810A provided for the operator operating one automatic musical instrument and the guide stave 810B provided for the operator operating the other automatic musical instrument are displayed on this operation guide screen. Each of the guide staves 810A and 810b contains musical notation marks n, note length indication bars 100, a best operation area A1, second best operation areas A2, third best operation areas A3, a score indicator 701 and a life indicator 700. The functions thereof are the same as those of FIG. 58. Also, this operation guide screen contains an indicator 103 and operation position indicating objects 801A and 801B in the same manner as in FIG. 61.

As understood from FIG. 62, the contents of the guide stave 810A and the contents of the guide stave 810B (indication of the musical notation mark n) are the same. Namely, the same part is assigned to the two operators. Accordingly, the same musical tones are output by the triggers generated by the two operators.

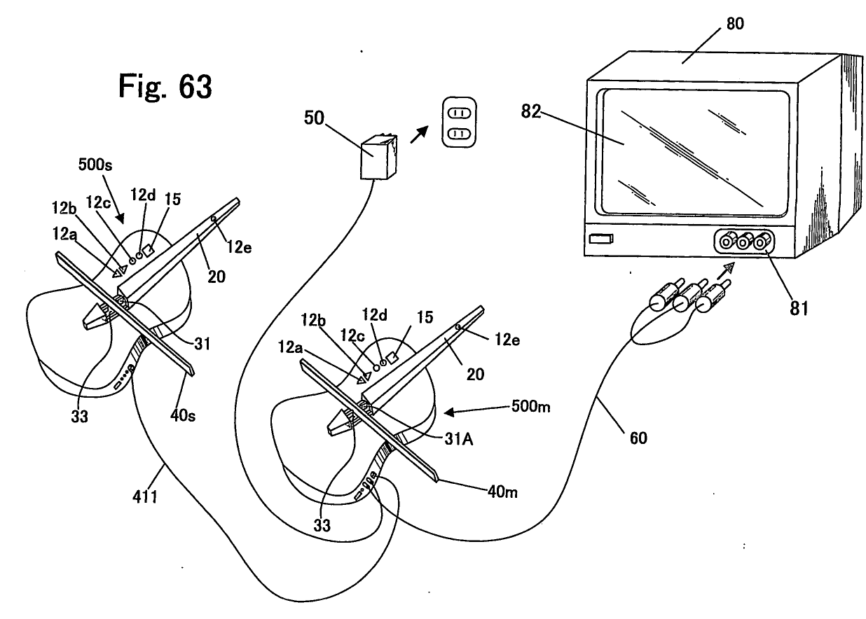

FIG. 63 is a schematic diagram showing the overall configuration of the automatic performance system in accordance with the present embodiment. As illustrated in FIG. 63, this automatic performance system includes an automatic musical instrument main body 500m (hereinafter referred to as the “main body 500m”), a sliding operation piece 40m, an automatic musical instrument main body 500s (hereinafter referred to as the “main body 500s”), a sliding operation piece 40s, and a television monitor 80. The configurations of the main bodies 500m and 500s are the same as that of the automatic musical instrument main body 500 as shown in FIG. 46, while the configurations of the sliding operation pieces 40m and 40s are the same as that of the sliding operation piece 40 as shown in FIG. 46. Accordingly, in the following description, the term “main body 500” is used to generally represent the main bodies 500m and 500s, while the term “sliding operation piece 40” is used to generally represent the sliding operation pieces 40m and 40s.

As illustrated in FIG. 63, the main body 500m functioning as a master is connected to the television monitor 80 by an AV cable 60. In this case, the AV cable 60 is connected to the AV terminal 18 of the main body 500m (refer to FIG. 47(b)) and the AV terminal 81 of the television monitor 80 (refer to FIG. 46).

Also, the main body 500m and the main body 500s are connected by a cable 411. In this case, the cable 411 is connected to the connectors 22 of the main bodies 500m and 500s.

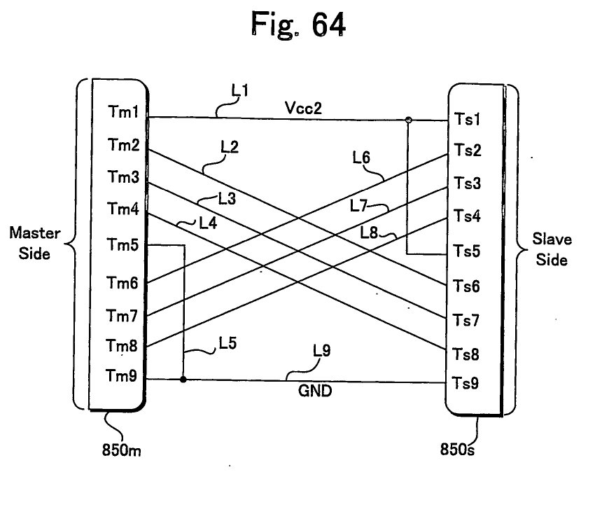

FIG. 64 is a schematic diagram showing the inner structure of the cable 411 of FIG. 63. As illustrated in FIG. 64, the cable 411 is provided with a connector 850m which is connected to the connector 22 of the main body 500m serving as a master and a connector 850s which is connected to the connector 22 of the main body 500s serving as a slave. The connector 850m includes terminals Tm1 to Tm9 while the connector 850s includes terminals Ts1 to Ts9.

The terminal Tm1 and the terminal Ts1 are connected by a line L1. The line L1 is used to supply the power supply voltage Vcc2 from the master main body 500m to the slave main body 500s. As will be described later, this power supply voltage Vcc2 is supplied to the detection unit 30 of the main body 500s and the vibrato switch 12e but not supplied to the high speed processor 200 and the peripheral circuits of the main body 500s. The terminal Tm9 and the terminal Ts9 are connected by a line L9. The line L9 is used to supply a ground voltage GND from the master main body 500m to the slave main body 500s.

The terminal Tm2 and the terminal Ts6 are connected by a line L2. The terminal Tm4 and the terminal Ts8 are connected by a line L4. The terminal Tm6 and the terminal Ts2 are connected by a line L6. The terminal Tm8 and the terminal Ts4 are connected by a line L8. The line L6 and the line L8 are used to supply the pulse signals A and B as output from the detection unit 30 of the main body 500s to the master main body 500m respectively.

The terminal Tm3 and the terminal Ts7 are connected by a line L3. The terminal Tm7 and the terminal Ts3 are connected by a line L7 The line L7 is used to supply the on/off signal of the vibrato switch 12e of the main body 500s to the master main body 500m.

The terminal Tm5 is connected to the line L9 for supplying the ground voltage GND while the terminal Ts5 is connected to the line L1 for supplying the power supply voltage Vcc2. Connected with the terminal Tm5 as grounded, the main body 500m has its power supply circuit being activated and therefore serves as a master. On the other hand, connected with the terminal Ts5, the main body 500s has its power supply circuit being deactivated and therefore serves as a slave. This point will be explained in detail with reference to the circuit diagram of the power supply related circuit.

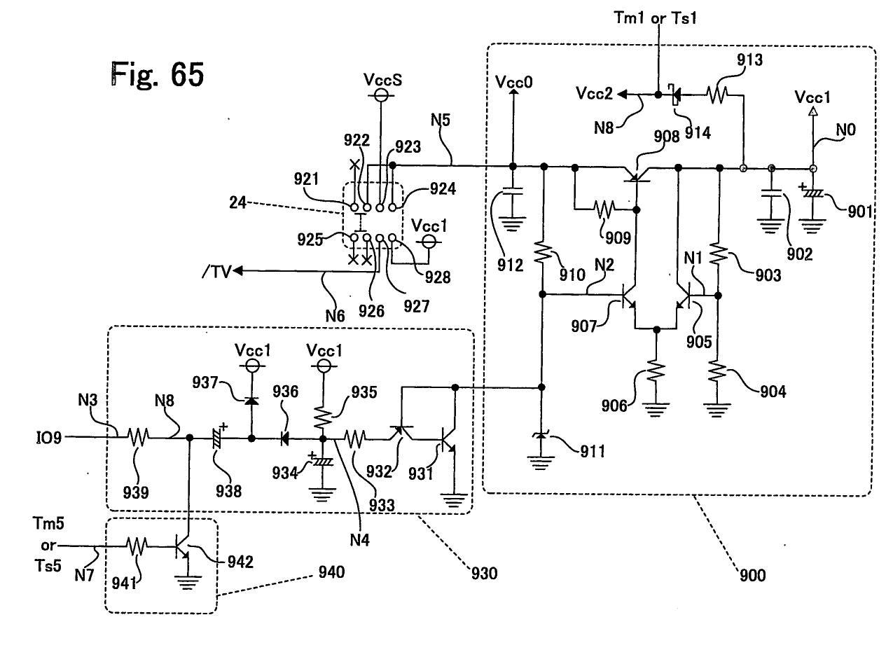

FIG. 65 is a circuit diagram showing the power supply related circuit in each of the main body 500m and the main body 500s. As illustrated in FIG. 65, the power supply related circuit includes a power supply circuit 900 for generating a power supply voltage Vcc1, a power supply switch 24, a runaway monitor circuit 930 for detecting an abnormal operation of the high speed processor 200 and deactivating the power supply circuit 900, and a power supply stopping circuit 940 for stopping the operation of the power supply circuit 900 of the slave main body 500s.

The power supply circuit 900 includes an electrolytic capacitor 901, capacitors 902 and 912, resistor elements 903, 904, 906, 909, 910 and 913, NPN transistors 905 and 907, a PNP transistor 908, a zener diode 911, and a schottky diode 914. The power supply switch 24 includes eight terminals 921 to 928.

The runaway monitor circuit 930 includes an NPN transistor 931, a PNP transistor 932, resistor elements 933, 935 and 939, electrolytic capacitors 934 and 938, and diodes 936 and 937. The power supply stopping circuit 940 includes a resistor element 941 and an NPN transistor 942.

The collector of the PNP transistor 908 of the power supply circuit 900 is connected to the collector of the NPN transistor 905, one terminal of the resistor element 913, one terminal of the resistor element 903, one terminal of the capacitor 902, and a positive terminal of the electrolytic capacitor 901. The other terminal of the capacitor 902 and the negative terminal of the electrolytic capacitor 901 are grounded. The base of the NPN transistor 905 is connected the other terminal of the resistor element 903 and one terminal of the resistor element 904. The other terminal of the resistor element 904 is grounded. The schottky diode 914 is connected to the other terminal of the resistor element 913 at the anode and connected to the terminal Tml of the connector 850m or the terminal Tsl of-the connector 850s at the cathode.

The base of the PNP transistor 908 is connected to the collector of the NPN transistor 907 and the one terminal of the resistor element 909. The emitters of the NPN transistors 905 and 907 are connected to one terminal of the resistor element 906. The other terminal of the resistor element 906 is grounded.

The base of the NPN transistor 907 is connected to one terminal of the resistor element 910, the cathode of the zener diode 911, the collector of the NPN transistor 931, and the base of the PNP transistor 932 respectively. The anode of the zener diode 911 is grounded.

The emitter of the PNP transistor 908 is connected to the other terminal of the resistor element 909, the other terminal of the resistor element 910, one terminal of the capacitor 912, and the terminals 922 and 924 of the power supply switch 24 respectively.

The terminals 921, 925 and 926 of the power supply switch 24 are provided in a high impedance state. A power supply voltage VccS (for example, 6 V) is supplied through the terminal 923 from a battery or an AC adapter 50. A power supply voltage Vccl (for example, 3.3 V) is supplied through the terminal 928 from the power supply circuit 900. The terminal 927 is connected to a line for outputting a television mode signal /TV.

The NPN transistor 931 of the runaway monitor circuit 930 is connected to the collector of the PNP transistor 932 at the base and is grounded at the emitter. The PNP transistor 932 is connected to the one terminal of the resistor element 933 at the emitter. The anode of the diode 936 is connected to one terminal of the resistor element 935, the other terminal of the resistor element 933 and the positive terminal of the electrolytic capacitor 934. The other terminal of the resistor element 935 is connected to the electric power supply Vcc1 while the negative terminal of the electrolytic capacitor 934 is grounded.

The cathode of the diode 936 is connected to the anode of the diode 937 and the positive terminal of the electrolytic capacitor 938. The cathode of the diode 937 is connected to the electric power supply Vcc1. The negative terminal of the electrolytic capacitor 938 is connected to the collector of the NPN transistor 942 and one terminal of the resistor element 939. The other terminal of the resistor element 939 is connected to the input/output port of the high speed processor 200 (for example, 109).

The NPN transistor 942 of the power supply stopping circuit 940 is grounded at the emitter, and connected to one terminal of the resistor element 941 at the base. The other terminal of the resistor element 941 is connected to the terminal Tm5 of the connector 850m or the terminal Ts5 of the connector 850s.

The operation of the power supply circuit 900 will be explained below. The power supply circuit 900 compares the potential of the node N2 (the reference voltage Vref generated by the zener diode 911) with the potential of the node N1 (corresponding to the potential of the output node N0, i.e., the power supply voltage Vcc1, as divided by the ratio between the resistor element 903 and the resistor element 904). If the potential of the node N1 is higher than the reference voltage Vref, the power supply circuit 900 decreases the current as supplied to the output node N0 through the PNP transistor 908. Conversely, if the potential of the node N1 is lower than the reference voltage Vref, the power supply circuit 900 increases the current as supplied to the output node N0 through the PNP transistor 908. The potential of the output node N0 (the power supply voltage Vcc1) is maintained at a constant level in this manner.

For example, if the reference voltage Vref is 2 V and the ratio between the resistance value of the resistor element 903 and the resistance value of the resistor element 904 is 1.3:2, the power supply voltage Vcc1 is maintained at 3.3 V. The power supply voltage Vcc1 is supplied to the high speed processor 200 and the peripheral circuits thereof.

Next, the power supply switch 24 will be explained. With the power supply switch 24 being turned off, the terminal 921 and the terminal 922 are connected white the terminal 925 and the terminal 926 are connected. Accordingly, the node N5 assumes a high impedance state to stop the output of the power supply voltage Vcc0, deactivate the power supply circuit 900 and stop the output of the power supply voltage Vcc1.

In the television mode, the terminal 922 and the terminal 923 are connected while the terminal 926 and the terminal 927 are connected. Accordingly, the power supply voltage VccS is supplied to the node N5 to activate the power supply circuit 900 and output the power supply voltage Vcc1. On the other hand, the node N6 assumes a high impedance state. This state is the state in which the television mode signal /TV is activated (at a low level).

In the speaker mode, the terminal 923 and the terminal 924 are connected while the terminal 927 and the terminal 928 are connected. Accordingly, the power supply voltage VccS is supplied to the node N5 to activate the power supply circuit 900 and output the power supply voltage Vcc1. On the other hand, the power supply voltage Vcc1 is supplied to the node N6. This state is the state in which the television mode signal /TV is deactivated (at a high level).

The high speed processor 200 determines what mode is selected on the basis of the above television mode signal /TV, and performs the process in accordance with the mode as selected. Also, in the television mode, the switch of the speaker unit 11 is turned off in accordance with the above television mode signal /TV, and therefore no sound is output from the speaker unit 11. On the other hand, in the speaker mode, the switch of the speaker unit 11 is turned on in accordance with the above television mode signal /TV, and therefore sound is output from the speaker unit 11.

Next, the runaway monitor circuit 930 will be explained. The input node N3 of the runaway monitor circuit 930 is supplied with a pulse signal at a certain frequency from the input/output port IO9 of the high speed processor 200. When the pulse signal is not supplied, it is judged that the program is out of control followed by cutting power off. This point will be explained in detail.

The electrolytic capacitor 934 is always charged through the resistor element 935. The electrolytic capacitor 938 is charged through the diode 936 with the charge of the electrolytic capacitor 934 when the pulse signal at the input/output port IO9 is low. On the other hand, when the pulse signal is high, the charge of the electrolytic capacitor 938 is drained to the output node N0 through the diode 937. The potential of the node N4 is inhibited from rising in this manner as long as the pulse signal is supplied to the input node N3 to repeat charging and discharging the electrolytic capacitor 934.

However, when a program is abnormally running to halt supplying the pulse signal to the input node N3, the electrolytic capacitor 934 can no longer be discharged to elevate the potential of the node N4. This is because when the input node N3 is in a low level, the charge of the electrolytic capacitor 938 cannot be drained to the output node N0 and therefore cannot charge the electrolytic capacitor 934.

When the potential of the node N4 rises and the potential of the emitter of the PNP transistor 932 exceeds a level which is a certain value (determined by the input characteristics of the transistor 932) higher than the potential of the node N2, the PNP transistor 932 is turned on followed by turning on the NPN transistor 931. Then, the potential of the node N2 drops to furthermore decrease the on-resistance of the PNP transistor 932 and thereby to furthermore decrease the on-resistance of the NPN transistor 931. As a result of the operation, the anode and the cathode of the zener diode 911 are short-circuited. By this configuration, the reference voltage Vref becomes 0 V so that the output of the power supply circuit 900 (i.e., the power supply voltage Vcc1) is stopped.

The power supply stopping circuit 940 will be explained. At first, the power supply stopping circuit 940 of the main body 500m to which the connector 850m of the cable 411 is connected will be explained. In this case, the node N7 of the electric power supply 940 is connected to the terminal Tm5 of the connector 850m. As illustrated in FIG. 64, this terminal Tm5 is connected to the line L9 to which the ground voltage GND is supplied. Accordingly, the potential of the node N7 is in a low level. In this case, the NPN transistor 942 is turned off, and therefore the power supply circuit 900 serves to output the power supply voltage Vcc1 as long as the pulse signal is supplied to the input node N3.

Also, this power supply voltage Vcc1 is given as the power supply voltage Vcc2 to the terminal Tm1 of the connector 850m, the detection unit 30 and the vibrato switch 12e of the main body 500m through the resistor element 913 and the schottky diode 914.

Next, the operation of the power supply stopping circuit 940 of the main body 500s to which the connector 850s of the cable 411 is connected will be explained. In this case, the node N7 of the power supply stopping circuit 940 is connected to the terminal Ts5 of the connector 850s. As illustrated in FIG. 64, this terminal Ts5 is connected to the line L1 to which the power supply voltage Vcc2 is supplied. Accordingly, the potential of the node N7 is maintained at a high level. In this case, the NPN transistor 942 is turned on, and therefore the node N8 is pulled down to a low level irrespective of the input of the pulse signal. For the same reason as in the case where a program is abnormally running as described above, the output of the power supply voltage Vcc1 from the power supply circuit 900 is stopped.

Also, the power supply voltage Vcc2 is given from the terminal Ts1 of the connector 850s to the node N8, and then to the detection unit 30 and the vibrato switch 12e of the main body 500s. In this case, no current flows into the node N0 by virtue of the schottky diode 914.

As described above, while turning on the power supply circuit 900 of the main body 500m to which the connector 850m is connected and supplying the power supply voltage Vcc1 to the high speed processor 200 and the peripheral circuits thereof, the power supply voltage Vcc2 are supplied to the detection unit 30 and the vibrato switch 12e of the main body 500s to which the connector 850s is connected through the line L1 of FIG. 64.

On the other hand, the power supply circuit 900 of the main body 500s to which the connector 850s is connected is turned off, and as a result the power supply voltage Vcc1 is not supplied to the high speed processor 200 of the main body 500s which is therefore stopped.

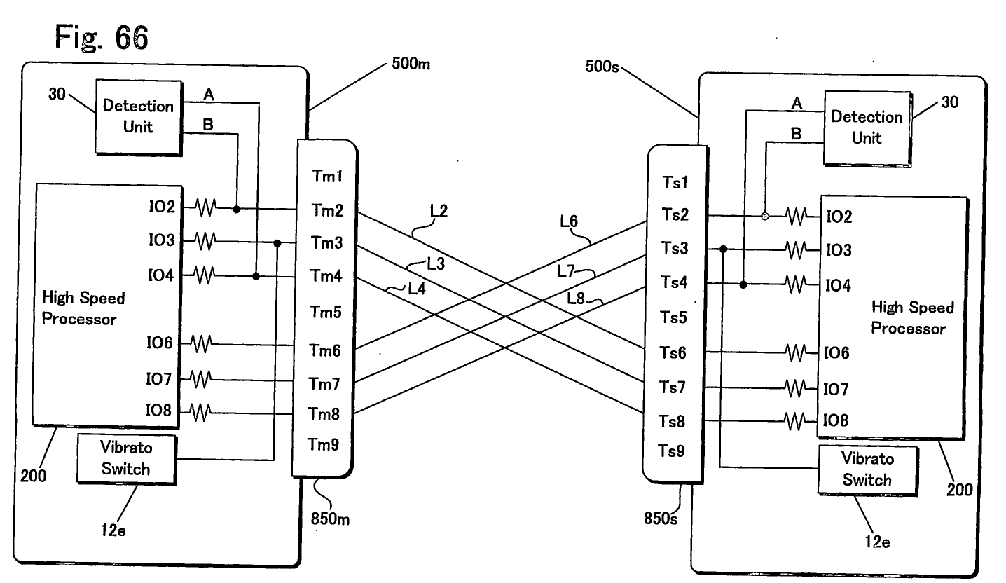

Next, the signal transmission paths from the slave to the master will be explained. FIG. 66 is a view for explaining the transmission path of the pulse signals A and B and the on/off signal of the vibrato switch 12e from the slave main body 500s to the master main body 500m of FIG. 63.

As illustrated in FIG. 66, the connector 850m of the cable 411 is connected to the master main body 500m. In other words, when connected to the connector 850m, the main body 500m serves as a master. On the other hand, the connector 850s is connected to the main body 500s which is a slave. In other words, when connected to the connector 850s, the main body 500s serves as a slave.

The pulse signals A and B output from the detection unit 30 of the main body 500s, which is a slave, are input to the input/output ports IO6 and IO8 of the high speed processor 200 of the main body 500m, which is a master, through the terminals Ts2 and Ts4, the lines L6 and L8 and the terminals Tm6 and Tm8.

On the other hand, the pulse signals A and B output from the detection unit 30 of the main body 500m, which is a master, are input to the input/output ports IO2 and IO4 of the high speed processor 200 of the main body 500m.

Also, the on/off signal as output from the vibrato switch 12e of the slave main body 500s is input to the input/output port IO7 of the high speed processor 200 of the master main body 500m through the terminal Ts3, the line L7 and the terminal Tm7.

On the other hand, the on/off signal as output from the vibrato switch 12e of the master main body 500m is input to the input/output port IO3 of the high speed processor 200 of the master main body 500m.

The high speed processor 200 of the master main body 500m receives the pulse signals A and B from the detection units 30 of the main bodies 500m and 500s and the on/off signals from the vibrato switches 12e of the main bodies 500m and 500s.

Then, the high speed processor 200 of the main body 500m executes the processes of FIG. 53. However, the processes are performed respectively for the main body 500m and the main body 500s. The processes performed respectively for the main body 500m and the main body 500s are as follows. Needless to say, any other process not described here is performed if necessary for the respective main bodies.

The high speed processor 200 of the main body 500m performs the process in step S510 of FIG. 53 with the pulse signals A and B of the main body 500m and the pulse signals A and B of the main body 500s respectively.

The high speed processor 200 of the main body 500m performs the process in steps S530, S531 and S534 of FIG. 54 corresponding to the process in step S500 of FIG. 53 for the main body 500m and the main body 500s respectively.

The high speed processor 200 of the main body 500m performs the process in steps S503, S504 and S505 of FIG. 53 for the main body 500m and the main body 500s respectively.

The high speed processor 200 of the main body 500m performs the process in steps S125, S126, S127 and S129 of FIG. 33 corresponding to the process in step S506 of FIG. 53 for the main body 500m and the main body 500s respectively.

The high speed processor 200 of the main body 500m performs the process in steps S201, S202 and S203 of FIG. 37 corresponding to the process in step S509 of FIG. 53 for the main body 500m and the main body 500s respectively.

Accordingly, the view as illustrated in FIG. 61 is displayed on the screen 82. On the other hand, when the view as illustrated in FIG. 61 is displayed, the high speed processor 200 of the main body 500m performs the process of FIG. 60 respectively for the main body 500m and the main body 500s.

In this case, the high speed processor 200 of the main body 500m which is a master executes the control program 301 stored in the ROM 300 of the main body 500m or the ROM 91 inserted to the main body 500m to perform the above processes. In this case, the high speed processor 200 of the main body 500m generates the audio signals AR and AL and the image signal VD by the use of the image data 302 and the music data 305 stored in the ROM 300 of the main body 500m or the ROM 91 inserted to the main body 500m.

In the case of the example as illustrated in FIG. 61, the musical score data for registering musical notation marks as shown in FIG. 25 and the musical score data for trigger sound output as shown in FIG. 26 are provided respectively for the main body 500m and the main body 500s. On the other hand, in the case of the example as illustrated in FIG. 62, the musical score data for registering musical notation marks and the musical score data for trigger sound output are provided for either the main body 500m or the main body 500s.

By the way, in the case of the present embodiment as described above, the main body 500m serving as a master are connected with the main body 500s by the cable 411. The operation guides are displayed on the screen 82 respectively for the main bodies 500s and 500m. Accordingly, two operators can add variegated expression to the music which is automatically performed together.

In addition, in the case of the present embodiment, while the power supply of the main body 500s serving as a slave is turned off, the main body 500s is supplied the power supply voltage Vcc2 and the ground voltage GND from the main body 500m serving as a master through the cable 411. However, the power supply voltage Vcc2 is supplied only to the detection unit 30 and the vibrato switch 12e of the main body 500s. Accordingly, since the power supply voltage Vcc2 is not supplied to the high speed processor 200 and other peripheral circuits of the main body 500s, the power consumption of the main body 500s can be saved.

Also, in the case of the present embodiment, while the terminals Tm2 and Tm4 connected with the signal lines from the detection unit 30 of the main body 500m are connected with the terminals Ts6 and Ts8 which are different from the terminals Ts2 and Ts4 connected with the signal lines from the detection unit 30 of the main body 500s, the terminals Ts2 and Ts4 connected with the signal lines from the detection unit 30 of the main body 500s are connected with the terminals Tm6 and Tm8 which are different from the terminals Tm2 and Tm4 connected with the signal lines from the detection unit 30 of the main body 500m. In addition to this, while the terminals Tm2 and Tm4 are arranged in the same position as the terminals Ts2 and Ts4, the terminals Tm6 and TmB are arranged in the same position as the terminals Ts6 and Ts8.

Furthermore, the terminal Tm3 connected with the signal line from the vibrato switch 12e, of the main body 500m is connected with the terminal Ts7 which is different from the terminal Ts3 connected with the signal line from the vibrato switch 12e of the main body 500s, the terminal Ts3 connected with the signal line from the is vibrato switch 12e of the main body 500s is connected with the terminal Tm7 which is different from the terminal Tm3 connected with the signal line from the vibrato switch 12e of the main body 500m. In addition to this, while the terminal Tm3 is arranged in the same position as the terminal Ts3, the terminal Tm7 is arranged in the same position as the terminal Ts7.

Furthermore, while the terminal Tml and the terminal Ts1 connected to the line for supplying the power supply voltage Vcc2 are arranged in the same position, the terminal Tm9 and the terminal Ts9 connected to the line for supplying the ground voltage GND are arranged in the same position.

Still further, the terminal Ts5 and the terminal Tm5 connected to the runaway monitor circuit 930 are arranged in the same position. Then, while the power supply voltage Vcc2 is supplied to the terminal Ts5 connected to the slave, the ground voltage GND is supplied to the terminal Tm5 connected to the master.

By the use of the cable 411 as configured above, it is possible to connect the connector 850m with the main body 500m and connect the connector 850s with the main body 500s, and vice versa. As described above, it is possible to arbitrarily select a master or a slave only by changing the connection targets of the connectors 850m and 850s.

Also, in the case of the present embodiment, by assigning opposite polarities to the terminal Ts5 and the terminal Tm5 which are connected to the runaway monitor circuit 930, the state of the runaway monitor circuit 930 is determined in order that the runaway monitor circuit 930 of the slave serves to turn off the power supply circuit 900 of the slave. As described above, the power supply to the main body 500s of the slave can be turned off only by connecting the cable 411.

Incidentally, the present invention is not limited to the above embodiments, and a variety of variations and modifications may be effected without departing from the spirit and scope thereof, as described in the following exemplary modifications.

(1) The pulse signal “a” for calculating the sliding speed of the sliding operation piece 40 is same as the pulse signal A for determining the change of the sliding direction of the sliding operation piece 40 in the case of the embodiment 1 (refer to FIG. 23).

However, the pulse signal for calculating the sliding speed of the sliding operation piece 40 can be different than the pulse signal A or the pulse signal B for determining the change of the sliding direction of the sliding operation piece 40.

For example, this is implemented as follows. The signals A and B of FIG. 23 are detected for the purpose of determining the change of the sliding direction of the sliding operation piece 40 (refer to FIG. 20). This is done as described above. In addition to this, another phototransistor is provided for detecting the reflected light from the reflecting pattern of the sliding operation piece 40 and outputting a pulse signal (referred to as a “pulse signal C”) corresponding to the reflected light. It is therefore possible to obtain the sliding speed of the sliding operation piece 40 by detecting the frequency of this pulse signal C or a quantity derived from the frequency.

Namely, the pulse signal C output from the phototransistor provided anew is an independent signal dedicated to the detection of the sliding speed of the sliding operation piece 40. On the other hand, the pulse signals A and B from the phototransistors 34 and 35 can be said dedicated signals for detecting the change of the sliding direction of the sliding operation piece 40.

Accordingly, it is possible to improve the accuracy of detecting the pulse signal C higher than the accuracy of detecting the pulse signals A and B and vice versa. For example, while the phototransistors 34 and 35 are used to the reflected light from the reflecting pattern 43 of the sliding operation piece 40, the phototransistor provided anew is used to another reflecting pattern provided on the same sliding operation piece 40. The interval between adjacent light reflecting regions (adjacent light absorbing regions) of this another reflecting pattern is determined to differ from the interval between adjacent light reflecting regions 45 (adjacent light absorbing regions 44) of the reflecting pattern 43. From the reflecting patterns having different intervals between adjacent light reflecting regions (adjacent light absorbing regions), pulse signals are output at different frequencies. The flexibility of designing the automatic musical instrument is improved in this manner.

(2) The guides 31 and 32 are formed as a pair of triangular prisms (refer to FIG. 7) in the case of the embodiment 1. However, the present invention is not limited thereto. For example, the guides 531 and 532 can be used as in the embodiment 2. Conversely, the guides 31 and 32 can be used to implement the embodiment 2. Also, guides may be designed in order that the sliding operation piece 40 is guided along a straight line.

(3) The embodiment 1 can be implemented with optical fibers, tubes or the like serving to lead infrared light from the inner surface of the sliding saddle member 33 of FIG. 8 to the light receiving surfaces of the phototransistors 34 and 35 in the same manner as the embodiment 2. (4) The phototransistor 34 is located L/4 apart from the phototransistor 35 in the case of FIG. 18 of the embodiment 1 in order that the phase difference between the pulse signal A and the pulse signal B 90 degrees or −90 degrees. However, this spacing is not limited thereto. For example, 5L/4 or any other spacing can be used. This is applicable to the optical fibers 89 and 92 of the embodiment 2.

(5) The configuration of the slave main body 500s is the same as the configuration of the master main body 500m in the case of the embodiment 4. However, if the main body 500s is designed to be used only as a slave, only the detection unit 30 and the vibrato switch 12e are provided in the main body 500s while the high speed processor 200 and the like can be dispensed with. This is because as explained in the embodiment 4 all the information processing is performed by the high speed processor 200 in the master side. Also, the power supply voltage is supplied to the slave from the master so that a power supply unit is not necessary and can be dispensed with in the slave side. From the above, it is possible to reduce the cost and the power consumption of the slave main body 500s.

(6) Only a single melody is controlled by the sliding operation (the sliding speed and the sliding direction) by the operator in the case of the above examples. However, the musical note data corresponding to a plurality melodies may be stored in the external ROM 300 in order to enable the operator to take control of the plurality of melodies by sliding operation.

In this case, the operator can add variegated expression to the plurality of melodies of the music which is automatically performed by the automatic musical instrument, and therefore can furthermore enjoy individual automatic performance by the automatic musical instrument.

(7) The sound source data 309 may contain sound source data for outputting musical tones of a plurality of instruments rather than a single instrument.

In the case of the above example, the main body 1 is designed in the form of a violin so that musical tones of a violin may be stored. Alternatively, the sound source data may contain data for outputting musical tones of a variety of instruments such as a piano, a guitar, a trumpet and so forth. By this modification, the operator can furthermore enjoy the automatic performance by the automatic musical instrument. Incidentally, the sound source data to be stored is not limited to musical instrument sound.

(8) In the case of the above example, the sliding operation piece 40 is provided with the reflecting pattern 43 comprising the light absorbing region 44 and the light reflecting region 45 in order to detect the reflected light by the reflection type optical sensor unit (the phototransistors 34 and 35 the light emitting diode 36). However, the optical sensor unit is not limited thereto but can be formed as a transmission type. That is, the sliding operation piece 40 is provided with a pattern comprising light transmissive regions and light blocking regions which are alternately arranged. Then, a transmission type optical sensor unit is used to detect transmitted light.

(9) It is possible to furthermore display, in the operation guide screen of FIG. 14, FIG. 58, FIG. 61 and FIG. 62, marks, symbols and the like which may be contained in a musical score. Alternatively, it is possible to display easily viewable patterns to represent marks, symbols and the like which may be contained in a musical score. For example, a variety of indications can be displayed such as dynamic marks, temporal notations, the lines on a staff and so forth.

(10) When the sliding saddle members 33 and 533 comes into direct contact with the reflecting pattern 43 of FIG. 6, some flaw may be formed on the reflecting pattern 43 and may result in trouble. In order to avoid such trouble, the surface of the reflecting pattern 43 may be protected with a smooth cover (capable of transmitting infrared light). Also, the reflecting pattern 43 may be formed in a longitudinal groove which is formed in the bottom surface 41 of the sliding operation piece 40. Both the above measures can be used in combination.

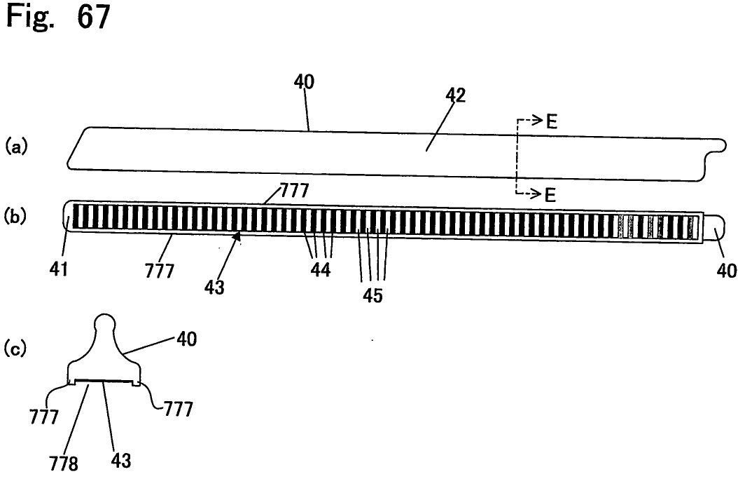

FIG. 67(a) is a side view showing another example of the sliding operation piece 40, FIG. 67(b) is a bottom view of this another example of the sliding operation piece 40, and FIG. 67(c) is an E-E cross sectional view of this another example of the sliding operation piece 40. As illustrated in FIG. 67(c), the bottom surface 41 of this sliding operation piece 40 is formed with a groove portion 778 in the longitudinal direction in whose bottom surface the reflecting pattern 43 is formed. In other words, while two spacers 777 are formed in the bottom surface 41 of the sliding operation piece 40, the reflecting pattern 43 is formed between the two spacers 777.

(11) While a monophonic sound is output in response to one trigger in the above example, it is possible to output a multiphonic sound in response to one trigger.

(12) The “With BGM and Guide” mode has been mainly explained in the above example. In the “Solo” mode, only musical tones are output in response to triggers without outputting a BGM and without displaying the operation guide screen. On the other hand, the “With BGM” mode is the same as “With BGM and Guide” except that the operation guide screen is not displayed.

(13) while any appropriate processor can be used as the high speed processor 200 of FIG. 17, it is preferred to use the high speed processor in relation to which the applicant has been filed patent applications. The details of this high speed processor are disclosed, for example, in Jpn. unexamined patent publication No. 10-307790 and U.S. Pat. No. 6,070,205 corresponding thereto. The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

1. An automatic musical instrument for automatically performing music in response to triggers generated by external operation in accordance with music data for automatic performance, comprising:
a main body; and
a sliding operation piece that is operated to slidably move in contact with said main body,
wherein said main body comprises:
a speed measuring unit operable to measure the sliding speed of said sliding operation piece;
a direction detecting unit operable to detect the sliding direction of said sliding operation piece; and
a trigger generating unit operable to generate a trigger for automatic performance in response to detecting change of the sliding direction of said sliding operation piece and the sliding speed of said sliding operation piece exceeding a first predetermined threshold value.

2. The automatic musical instrument as claimed in claim 25 wherein said main body further comprises:
a light emitting unit located in a position, over which said sliding operation piece is passed, and operable to output a light beam;
a first light receiving unit located in a position, over which said sliding operation piece is passed, and operable to receive the light beam as output from said light emitting unit; and
a second light receiving unit located in a position, over which said sliding operation piece is passed, and operable to receive the light beam as output from said light emitting unit,
wherein said sliding operation piece is formed with a light intensity modifying portion which is operable to modify the intensity of the light beam to be received by said light receiving units,
said first light receiving unit and said second light receiving unit being arranged along the sliding direction of said sliding operation piece,
wherein said speed measuring unit performs measurement of the sliding speed on the basis of the electronic signal that is output from at least one of said first light receiving unit and said second light receiving unit in accordance with the intensity of the light beam as modified by said light intensity modifying portion, and said direction detecting unit performs detection of the sliding direction on the basis of the electronic signals that are output from said first light receiving unit and said second light receiving unit in accordance with the intensity of the light beam as modified by said light intensity modifying portion.

3. The automatic musical instrument as claimed in claim 25 wherein the music as automatically performed includes two or more melodies while at least one of the melodies is controlled in response to triggers generated by said trigger generating unit.

4. The automatic musical instrument as claimed in claim 25 wherein said main body further comprises:
an image generation unit operable to generate an image signal indicative of the current state of the automatic performance and an operation guide, and provide the image signal to a television monitor which is separately provided from said main body,
wherein the current state of automatic performance is indicated by the movement or color variation of an object, and the operation guide is indicated by the movement and color variation of an object.

5. The automatic musical instrument as claimed in claim 25 wherein said main body further comprises a sound output channel control unit operable to set the sound output channel for sound output to be started in response to a new trigger to a channel differing from the sound output channel for sound output started in response to the previous trigger.

6. The automatic musical instrument as claimed in claim 25 wherein said main body further comprises a medium accepting unit operable to accept a medium in which are stored music data for automatic performance and image data for image generation.

7. The automatic musical instrument as claimed in claim 2 wherein said main body further comprises:
a contact portion whose cross section has a highest portion in a center position of said contact portion and downwardly extending therefrom toward the opposite ends thereof; and
two guide elements located in upright positions distant a predetermined interval from each other with said contact portion inbetween,
wherein said light emitting unit, said first light receiving unit and said second light receiving unit are provided in the vicinity and inner side of a surface of said contact portion to be in contact with said sliding operation piece.

8. The automatic musical instrument as claimed in claim 7 wherein said main body further comprises a first optical fiber with an one end located in the inner side of the surface of said contact portion and the other end located in the light receiving side of said first light receiving unit, and a second optical fiber with an one end located in the inner side of the surface of said contact portion and the other end located in the light receiving side of said second light receiving unit.

9. The automatic musical instrument as claimed in claim 7 wherein said sliding operation piece is formed with two spacers, on the bottom surface thereof, extending in parallel with each other in the longitudinal direction of said sliding operation piece,
and wherein said light intensity modifying portion is formed on the bottom surface of said sliding operation piece and located between said two spacers.

10. The automatic musical instrument as claimed in claim 2 wherein said main body further comprises a connector to be connected with a cable including a first signal line for transmitting the electronic signal from the first light receiving unit of another automatic musical instrument and a second signal line for transmitting the electronic signal from the second light receiving unit of said another automatic musical instrument.

11. The automatic musical instrument as claimed in claim 10 wherein said main body further comprises a power voltage supplying unit operable to supply a power supply voltage to said main body and also to supply said main body of said another automatic musical instrument through the cable which further comprises a power supply line for supplying the power supply voltage.

12. The automatic musical instrument as claimed in claim 1,
wherein said main body comprises:
a sound terminating unit operable to invoke a termination process of the sound output started in response to a latest trigger when the sliding speed of said sliding operation piece falls below a second predetermined threshold value, and invoke, when a trigger is generated anew, a termination process of the sound output started in response to a previous trigger.

13. (canceled)

14. An automatic musical instrument for automatically performing music in response to triggers generated by external operation in accordance with music data for automatic performance, comprising:
a main body; and
a sliding operation piece that is operated to slidably move in contact with said main body,
wherein said main body comprises:
a trigger generating unit operable to generate a trigger for automatic performance in response to the operation of said sliding operation piece; and
a sound output channel control unit operable to set the sound output channel for sound output to be started in response to a new trigger to a channel differing from the sound output channel for sound output started in response to the previous trigger.

15. The automatic music performing method as claimed in claim 27, further comprising:
a step of invoking a termination process of the sound output started in response to a latest trigger when the sliding speed of said sliding operation piece falls below a second predetermined threshold value; and
a step of invoking, when a trigger is generated anew, a termination process of the sound output started in response to a previous trigger.

16. An automatic music performing method of automatically performing music in response to triggers generated by external operation, comprising:
a step of generating a trigger for automatic performance in response to the sliding operation of the sliding operation piece that is slidably moved in contact with said main body; and
a step of displaying an image indicative of the current state of automatic performance and an image indicative of an operation guide on a television monitor which is separately provided from said main body.

17. An automatic music performing method of automatically performing music in response to triggers generated by external operation, comprising:
a step of generating a trigger for automatic performance in response to the sliding operation of the sliding operation piece that is slidably moved in contact with said main body; and
a step of setting the sound output channel for sound output to be started in response to a new trigger to a channel differing from the sound output channel for sound output started in response to the previous trigger.

18. (canceled)

19. (canceled)

20. (canceled)

21. An automatic musical instrument for automatically performing music comprising:
a first member formed with a periodic pattern configured to modify the intensities of light rays reflected from said periodic pattern;
a second member that is moved in the vicinity of said first member relative to said first member by external operation and is provided with an optical device capable of directing light rays to said periodic pattern in two positions apart from each other by a distance differing from any integer multiple of the half period of said periodic pattern along the direction of the relative movement of said second member; and
a signal processing circuit that receives the light rays reflected from said periodic pattern, detects the intensities of the light rays, determines the direction of relative movement of said second member relative to said first member on the basis of the differential phase between the intensities of the light rays, generates a trigger when the direction of relative movement of said second member is changed, and outputs an audio signal in response to said trigger in accordance with music data for automatic performance.

22. (canceled)

23. (canceled)

24. (canceled)

25. The automatic musical instrument as claimed in claim 1 wherein said main body further comprises:
a sound terminating unit operable to invoke a termination process of the sound output started in response to a latest trigger when the sliding speed of said sliding operation piece falls below a second predetermined threshold value, and invoke, when a trigger is generated anew, a termination process of the sound output started in response to a previous trigger; and
a sound volume controlling unit operable to control the sound volume of the music as automatically performed in accordance with the sliding speed of said sliding operation piece.

26. The automatic musical instrument as claimed in claim 14 wherein said main body further comprises an image generation unit operable to generate an image signal indicative of the current state of the automatic performance and an operation guide, and provide the image signal to a television monitor which is separately provided from said main body.

27. An automatic music performing method of automatically performing music in response to triggers generated by external operation, comprising:
a step of measuring the sliding speed of a sliding operation piece that is slidably moved in contact with said main body;
a step of detecting the sliding direction of said sliding operation piece;
a step of generating a trigger for automatic performance in response to detecting change of the sliding direction of said sliding operation piece and the sliding speed of said sliding operation piece exceeding a first predetermined threshold value.
